(19) United States
(12) Patent Application Publication
(10) Pub. No.: US 2025/0249660 A1
(43) Pub. Date: Aug. 7, 2025

(54) AEROGEL MOUNTING AND ENCAPSULATION TECHNOLOGY, MANUFACTURING METHODS, INSULATING GLASS UNITS AND RELATED SUBASSEMBLIES

(71) Applicant: Cardinal CG Company, Eden Prairie, MN (US)

(72) Inventors: Megan E. Rose, Verona, WI (US); Kari B. Myli, Sauk City, WI (US); Kellen C. Kitzman, Verona, WI (US)

(21) Appl. No.: 19/041,346

(22) Filed: Jan. 30, 2025

Related U.S. Application Data
(60) Provisional application No. 63/548,618, filed on Feb. 1, 2024.

(51) Int. Cl. B32B 17/06; B32B 7/14

(52) U.S. Cl. CPC B32B 17/066; B32B 7/14; B32B 2255/205; B32B 2266/057; B32B 2266/126; B32B 2307/304; B32B 2307/71; B32B 2307/728; B32B 2307/73

(57) ABSTRACT

Glass articles are provided that include a glass sheet with an aerogel sheet in a mounted position alongside the glass sheet. The aerogel sheet is retained in the mounted position by an encapsulation material. The encapsulation material can include an organic material, such as a material comprising polyethylene terephthalate glycol. Methods of making glass articles are provided. Also provided are IG units that include encapsulated aerogel sheets, as well as related subassemblies, and methods of manufacturing such IG units and subassemblies.

### FIELD OF THE INVENTION

The present invention relates to mounting an aerogel sheet on a glass sheet. The present invention also relates to mounting materials that are compatible with an aerogel sheet. Additionally, the present invention relates to glass articles that include an aerogel sheet mounted on a glass sheet, methods of manufacturing such articles, and methods of manufacturing related subassemblies.

### BACKGROUND OF THE INVENTION

Aerogel is a known insulation material. There has been an interest in using aerogel in window applications to improve the insulation property of windows. For example, it is desirable to provide an aerogel sheet in a mounted configuration alongside a glass sheet. However, this has been difficult to accomplish because aerogel sheets are particularly fragile. Traditional mounting methods may introduce stress to aerogel sheets and cause them to crack and/or degrade. Likewise, certain materials crack and/or degrade aerogel sheets upon contact.

It would be desirable to provide glass articles that include a glass sheet with an intact aerogel sheet mounted thereon by an encapsulation material that does not crack or degrade the aerogel sheet. It would also be desirable to provide encapsulation materials that can contact and preferably bond to an aerogel sheet without cracking or degrading it. Further, it would be desirable to provide encapsulation materials that do not degrade other components of the glass article, such as components within a between-pane space of an insulating glazing unit. Still further, it would be desirable to provide methods of depositing encapsulation materials onto an aerogel sheet without cracking or degrading it. It would also be desirable to provide multiple-pane insulating glazing units, each comprising one or more encapsulated aerogel sheets, as well as certain related subassemblies. Further yet, it would be desirable to provide manufacturing methods for such insulating glazing units and methods for making related subassemblies.

### BRIEF DESCRIPTION OF THE DRAWINGS

FIG. 1 is a schematic, partially broken-away, cross-sectional side view of an aerogel sheet provided on a glass sheet and showing the position of a nozzle relative to the aerogel sheet during deposition of an encapsulation material onto a second face of the aerogel sheet according to an embodiment.

FIG. 2 is a schematic, partially broken-away, cross-sectional side view of an aerogel sheet provided on a glass sheet and showing the position of a nozzle relative to the aerogel sheet during deposition of an encapsulation material in contact with an edge of the aerogel sheet according to an embodiment.

FIG. 3 is a schematic, partially broken-away, cross-sectional side view of an aerogel sheet provided on a glass sheet and showing an encapsulation material defining a wall that encapsulates an edge of the aerogel sheet according to an embodiment.

FIG. 4 is a schematic, partially broken-away, cross-sectional side view of an aerogel sheet provided on a glass sheet and showing an encapsulation material defining a wall that is spaced from an edge of the aerogel sheet according to an embodiment.

FIG. 5 is a schematic, partially broken-away, cross-sectional side view of an aerogel sheet provided on a glass sheet and showing an encapsulation material defining a wall and a bridge that encapsulate an edge of the aerogel sheet according to an embodiment.

FIG. 6 is a schematic, partially broken-away, cross-sectional side view of an aerogel sheet provided on a glass sheet and showing an encapsulation material defining a wall and a bridge that encapsulate an edge of the aerogel sheet according to another embodiment.

FIG. 7 is a schematic, partially broken-away, cross-sectional side view of an aerogel sheet provided on a glass sheet and showing an encapsulation material defining a wall and a bridge that encapsulate an edge of the aerogel sheet according to still another embodiment.

FIG. 8 is a schematic, partially broken-away, cross-sectional side view of an aerogel sheet provided on a glass sheet and showing an encapsulation material defining a wall (that is spaced from an edge of the aerogel sheet) and a bridge that encapsulate the edge of an aerogel sheet according to yet another embodiment.

FIG. 9 is a schematic, partially broken-away, cross-sectional side view of an aerogel sheet provided on a glass sheet and showing an encapsulation material defining a wall (that is spaced from an edge of the aerogel sheet) and a bridge that encapsulate the edge of an aerogel sheet according to still another embodiment.

FIG. 10 is a schematic, partially broken-away, cross-sectional side view of an aerogel sheet provided on a glass sheet and showing an encapsulation material defining a wall (that is spaced from an edge of the aerogel sheet) and a bridge that encapsulate an edge of the aerogel sheet according to yet another embodiment.

FIG. 11 is a schematic, partially broken-away, cross-sectional side view of an aerogel sheet provided on a glass sheet and showing an encapsulation material defining a bead that encapsulates an edge of the aerogel sheet according to an embodiment.

FIG. 12 is a schematic, partially broken-away, cross-sectional side view of an aerogel sheet provided on a glass sheet and showing an encapsulation material defining a bead that encapsulates an edge of the aerogel sheet according to another embodiment.

FIG. 13 is a schematic, partially broken-away, cross-sectional side view of an aerogel sheet provided on a glass sheet and showing an encapsulation material defining a bead that contacts a wall of a spacer and encapsulates an edge of the aerogel sheet according to an embodiment.

FIG. 14 is a schematic, partially broken-away, cross-sectional side view of an aerogel sheet provided on a glass sheet and showing an encapsulation material defining a bead that contacts a wall of a spacer and encapsulates an edge of the aerogel sheet according to another embodiment.

FIG. 15 is a schematic top view of an aerogel sheet provided on a glass sheet and showing an encapsulation material defining a wall that encapsulates an edge of the aerogel sheet along an entire outer perimeter of the edge according to an embodiment.

FIG. 16 is a schematic top view of an aerogel sheet provided on a glass sheet and showing an encapsulation material defining a wall that surrounds an edge of the aerogel sheet along an entire outer perimeter of the edge according to an embodiment.

FIG. 17 is a schematic top view of an aerogel sheet provided on a glass sheet and showing an encapsulation material defining a wall that encapsulates an edge of the aerogel sheet along a portion of an outer perimeter of the edge according to an embodiment.

FIG. 18 is a schematic top view of an aerogel sheet provided on a glass sheet and showing an encapsulation material defining a wall that surrounds an edge of the aerogel sheet along a portion of an outer perimeter of the edge according to an embodiment.

FIG. 19 is a schematic top view of an aerogel sheet provided on a glass sheet and showing an encapsulation material defining a wall and a bridge that encapsulate an edge of the aerogel sheet along an entire outer perimeter of the edge according to an embodiment.

FIG. 20 is a schematic top view of an aerogel sheet provided on a glass sheet and showing an encapsulation material defining a wall and a bridge that encapsulates an edge of the aerogel sheet along an entire outer perimeter of the edge according to another embodiment.

FIG. 21 is a schematic top view of an aerogel sheet provided on a glass sheet and showing an encapsulation material defining a wall and a bridge that encapsulate an edge of the aerogel sheet along an entire outer perimeter of the edge according to still another embodiment.

FIG. 22 is a schematic top view of an aerogel sheet provided on a glass sheet and showing an encapsulation material defining a wall and a bridge that encapsulate an edge of the aerogel sheet along a portion of an outer perimeter of the edge according to yet another embodiment.

FIG. 23 is a schematic top view of an aerogel sheet provided on a glass sheet and showing an encapsulation material defining a wall and a bridge that encapsulate an edge of the aerogel sheet along an entire outer perimeter of the edge according to still another embodiment.

FIG. 24 is a schematic top view of an aerogel sheet provided on a glass sheet and showing an encapsulation material defining a wall and a bridge that encapsulate an edge of the aerogel sheet along a portion of an outer perimeter of the edge according to yet another embodiment.

FIG. 25 is a schematic top view of an aerogel sheet provided on a glass sheet and showing an encapsulation material defining a wall and a bridge that encapsulate an edge of the aerogel sheet along a portion of an outer perimeter of the edge according to still another embodiment.

FIG. 26 is a schematic top view of an aerogel sheet provided on a glass sheet and showing an encapsulation material defining a wall and a bridge that encapsulate an edge of the aerogel sheet along a portion of an outer perimeter of the edge according to yet another embodiment.

FIG. 27 is a schematic top view of an aerogel sheet provided on a glass sheet and showing an encapsulation material defining a wall and a bridge that encapsulate an edge of the aerogel sheet along a portion of an outer perimeter of the edge according to still another embodiment.

FIG. 28 is a schematic top view of an aerogel sheet provided on a glass sheet and showing an encapsulation material defining a wall and a bridge that encapsulate an edge of the aerogel sheet along a portion of an outer perimeter of the edge according to yet another embodiment.

FIG. 29 is a schematic top view of an aerogel sheet provided on a glass sheet and showing an encapsulation material defining a bead that encapsulates an edge of the aerogel sheet along an entire outer perimeter of the edge according to an embodiment.

FIG. 30 is a schematic top view of an aerogel sheet provided on a glass sheet and showing an encapsulation material defining a bead that encapsulates an edge of the aerogel sheet along a portion of an outer perimeter of the edge according to an embodiment.

FIG. 31 is a schematic top view of an aerogel sheet provided on a glass sheet and showing an encapsulation material defining a bead that encapsulates an edge of the aerogel sheet along an entire outer perimeter of the edge according to an embodiment.

FIG. 32 is a schematic top view of an aerogel sheet provided on a glass sheet and showing an encapsulation material defining a bead that encapsulates an edge of the aerogel sheet along a portion of an outer perimeter of the edge according to an embodiment.

FIG. 33 is a schematic top view of an aerogel sheet provided on a glass sheet and showing an encapsulation material defining bead that encapsulates an edge of the aerogel sheet along a portion of an outer perimeter of the edge according to another embodiment.

FIG. 34 is a schematic top view of an aerogel sheet provided on a glass sheet and showing an encapsulation material defining a bead that encapsulates an edge of the aerogel sheet along a portion of an outer perimeter of the edge according to still another embodiment.

FIG. 35 is a schematic top view of an aerogel sheet provided on a glass sheet and showing an encapsulation material defining a bead that encapsulates an edge of the aerogel sheet along a portion of an outer perimeter of the edge according to yet another embodiment.

FIG. 36 is a schematic top view of an aerogel sheet provided on a glass sheet and showing an encapsulation material defining a bead that encapsulates an edge of the aerogel sheet along a portion of an outer perimeter of the edge according to still another embodiment.

FIG. 37 is a schematic top view of an aerogel sheet and a spacer provided on a glass sheet and showing an encapsulation material defining a bead that contacts a wall of a spacer and encapsulates an edge of the aerogel sheet along an entire outer perimeter of the edge according to an embodiment.

FIG. 38 is a schematic top view of an aerogel sheet and a spacer provided on a glass sheet and showing an encapsulation material defining a bead that contacts a wall of a spacer and encapsulates an edge of the aerogel sheet along a portion of an outer perimeter of the edge according to another embodiment.

FIG. 39 is a schematic top view of an aerogel sheet and a spacer provided on a glass sheet and showing an encapsulation material defining a bead that contacts a wall of a spacer and encapsulates an edge of the aerogel sheet along a portion of an outer perimeter of the edge according to another embodiment.

FIG. 40 is a schematic, partially broken away, cross-sectional view of a double-pane insulating glazing unit that includes an aerogel sheet provided on a glass sheet and showing an encapsulation material defining a wall and a bridge that encapsulate an edge of the aerogel sheet according to another embodiment.

FIG. 41 is a schematic, partially broken away, cross-sectional view of a double-pane insulating glazing unit that includes an aerogel sheet provided on a glass sheet and showing an encapsulation material defining a wall that encapsulates a portion of an edge of the aerogel sheet according to another embodiment.

FIG. 42 is a schematic, partially broken away, cross-sectional view of a double-pane insulating glazing unit that includes an aerogel sheet provided on a glass sheet and showing an encapsulation material defining a wall that encapsulates a portion of an edge of the aerogel sheet according to another embodiment.

FIG. 43 is a schematic, partially broken away, cross-sectional view of a double-pane insulating glazing unit that includes an aerogel sheet provided on a glass sheet and showing an encapsulation material defining a bead that contacts a wall of a spacer and encapsulates an edge of the aerogel sheet according to another embodiment.

FIG. 44 is a schematic, partially broken away, cross-sectional view of a double-pane insulating glazing unit that includes an aerogel sheet provided on a glass sheet and showing an encapsulation material defining a bead that contacts a wall of a spacer and encapsulates an edge of the aerogel sheet according to another embodiment.

FIG. 45 is a schematic, partially broken away, cross-sectional view of a triple-pane insulating glazing unit that includes an aerogel sheet provided on a glass sheet and showing an encapsulation material defining a wall and a bridge that encapsulate an edge of the aerogel sheet according to an embodiment.

FIG. 46 is a schematic, partially broken away, cross-sectional view of a triple-pane insulating glazing unit that includes an aerogel sheet provided on a glass sheet and showing an encapsulation material defining a wall that encapsulates a portion of an edge of the aerogel sheet according to an embodiment.

FIG. 47 is a schematic, partially broken away, cross-sectional view of a monolithic unit that includes an aerogel sheet provided between two glass sheets and showing an encapsulation material defining a wall that encapsulates an edge of the aerogel sheet according to an embodiment.

FIG. 48 is a schematic, partially broken-away, cross-sectional side view of an aerogel sheet provided on a glass sheet and showing the position of a dual-nozzle dispenser relative to the aerogel sheet during deposition of an encapsulation material and a second material according to an embodiment.

FIG. 49 is a schematic, partially broken-away, cross-sectional side view of an aerogel sheet provided on a glass sheet and showing an encapsulation material and a second material according to an embodiment.

FIG. 50 is a schematic, broken-away, cross-sectional side view of a method for producing a glass-aerogel-spacer subassembly according to an embodiment.

FIG. 51 is a schematic, broken-away, cross-sectional side view of the glass-aerogel-spacer subassembly produced by the method of FIG. 50 according to an embodiment.

FIG. 52 is a schematic, broken-away, cross-sectional side view of a method for coupling a second glass pane together with the glass-aerogel-spacer subassembly of FIG. 51 according to an embodiment.

FIG. 53 is a schematic, broken-away, cross-sectional side view of an IG unit subassembly resulting from the method of FIG. 52 according to an embodiment.

FIG. 54 is a schematic, partially broken away, cross-sectional view of a double-pane insulating glazing unit that includes an aerogel sheet provided on a glass sheet as well as an encapsulation material and a second material according to an embodiment.

FIG. 55 is a schematic, partially broken away, cross-sectional view of a double-pane insulating glazing unit that includes an aerogel sheet provided on a glass sheet as well as an encapsulation material according to another embodiment.

FIG. 56 is a schematic, partially broken-away, cross-sectional side view of a method of performing a needling operation to create a plurality of gas-passage openings in an encapsulation material according to an embodiment.

FIG. 57 is a schematic, partially broken-away, cross-sectional side view of an aerogel sheet provided on a glass sheet and showing an encapsulation material having a plurality of gas-passage openings according to an embodiment.

FIG. 58 is a schematic, partially broken-away, cross-sectional side view of an aerogel sheet provided on a glass sheet and showing an encapsulation material and a second material according to another embodiment.

FIG. 59 is a schematic, partially broken-away, cross-sectional side view of an aerogel sheet provided on a glass sheet and showing an encapsulation material and a second material according to still another embodiment.

### SUMMARY OF THE INVENTION

Some embodiments include an article comprising a glass sheet and an aerogel sheet. The aerogel sheet comprises a first face, a second face, and an edge forming an outer perimeter of the aerogel sheet. The aerogel sheet is provided in a mounted position alongside the glass sheet with the first face of the aerogel sheet facing toward the glass sheet and the second face of the aerogel sheet facing away from the glass sheet. Additionally, a material comprising polyethylene terephthalate glycol (“PETG”) retains the aerogel sheet in the mounted position.

The aerogel sheet is preferably intact and devoid of degradation visible to the naked eye. In some cases, an entirety of the first face of the aerogel sheet is in contact with the glass sheet. Also, in some cases, the aerogel sheet comprises silica aerogel, such as silica aerogel synthesized from methyl silicate 51.

The material comprising PETG can comprise extruded PETG. The material comprising PETG can also be in contact with (and preferably bonded to) the aerogel sheet. Also, in some cases, the material comprising PETG encapsulates the edge of the aerogel sheet along at least a portion (or perhaps along an entirety) of the outer perimeter.

Also, in some cases, the material comprising PETG defines a wall that is bonded to the glass sheet. In certain cases, the glass sheet has opposed first and second surfaces and an edge forming an outer perimeter of the glass sheet, and the wall is bonded to the second surface of the glass sheet. The wall can also be spaced apart inwardly from the edge of the glass sheet. In some cases, the aerogel sheet has a rectangular profile and the wall surrounds the outer perimeter of the aerogel sheet.

Further, in some cases, the material comprising PETG further defines a bridge. The bridge can extend from the wall inwardly so as to engage (and preferably bond to) a portion of the second face of the aerogel sheet. In other cases, the material comprising PETG defines a bead that is bonded to the glass sheet. The bead can also be bonded to a portion of the second face of the aerogel sheet and/or to an edge of the aerogel sheet.

Other embodiments include another article comprising a glass sheet and an aerogel sheet. The aerogel sheet comprises a first face, a second face, and an edge forming an outer perimeter of the aerogel sheet. A part of or an entirety of first face of the aerogel sheet is in contact with the glass sheet. Also, an encapsulation material is bonded to the glass sheet and encapsulates the edge of the aerogel sheet along at least a portion (or perhaps along an entirety) of the outer perimeter. The aerogel sheet can comprise silica aerogel, such as silica aerogel synthesized from methyl silicate 51.

In some cases, the encapsulation material consists essentially of organic material that is chemically and physically compatible with the aerogel sheet. The organic material can also be in contact with the aerogel sheet. In certain cases, the aerogel sheet is a hydrophilic silica aerogel sheet, and the organic material is chemically compatible with hydroxyl functional groups of the hydrophilic silica aerogel sheet. In other cases, the aerogel sheet is a hydrophobic silica aerogel sheet, and the organic material is chemically compatible with methyl functional groups of the hydrophobic silica aerogel sheet. Also, in some cases, the organic material is physically compatible with pores of the aerogel sheet. The organic material can also comprise PETG, such as extruded PETG.

Also, in some cases, the encapsulation material defines a wall, and the glass sheet has opposed first and second surfaces and an edge forming an outer perimeter of the glass sheet, the wall being bonded to the second surface of the glass sheet and spaced apart inwardly from the edge of the glass sheet. In certain cases, aerogel sheet has a rectangular profile, and the wall surrounds the outer perimeter of the aerogel sheet. The glass article can also include a bridge that extends from the wall inwardly so as to engage (and preferably bond to) a portion of the second face of the aerogel sheet. In some cases, the bridge consists essentially of an organic material that that is chemically and physically compatible with the aerogel sheet. In certain cases, the organic material comprises PETG, such as extruded PETG.

Other embodiments provide a multiple-pane insulating glazing unit comprising first and second panes, a spacer, a spacer sealant, an aerogel sheet and an organic material. The spacer maintains the first and second panes in a spaced-apart configuration such that a between-pane space is located between the first and second panes. The aerogel sheet is located in the between-pane space and retained in a mounted position alongside the first pane by the organic material. In particular, the organic material encapsulates the edge of the aerogel sheet along at least a portion of (and in some cases an entirety of) the outer perimeter.

The aerogel sheet comprises a first face, a second face and an edge forming an outer perimeter of the aerogel sheet. The aerogel sheet is preferably devoid of degradation visible to the naked eye. In some cases, an entirety of the first face of the aerogel sheet is in contact with the first pane. Also, in some cases, a gas gap exists between the second face of the aerogel sheet and the second pane. The aerogel sheet can also comprise silica aerogel, such as silica aerogel synthesized from methyl silicate 51.

The organic material can be bonded to the first glass pane. Additionally, the organic material can be in contact with (and preferably bonded to) a portion of the aerogel sheet. The organic material can also be spaced apart from a spacer sealant, which can optionally comprise polyisobutylene. Also, the organic material preferably does not outgas or release moisture to the between-pane space in an amount that corrodes a spacer sealant or low-emissivity coating (when provided). Further, the organic material preferably does not degrade upon exposure to ultraviolet radiation within the between-pane space.

Additionally, the organic material is preferably physically compatible with pores of the aerogel sheet. The organic material is also preferably chemically compatible with the aerogel sheet. In some cases, the aerogel sheet is a hydrophilic silica aerogel sheet, and the organic material is chemically compatible with hydroxyl functional groups of the hydrophilic silica aerogel sheet. In other cases, the aerogel sheet is a hydrophobic silica aerogel sheet, and the organic material is chemically compatible with methyl functional groups of the hydrophobic silica aerogel sheet. Further, the organic material is preferably chemically compatible with the spacer sealant, which can optionally comprise polyisobutylene. In some cases, the organic material comprises PETG, such as extruded PETG.

In some cases, the organic material defines a wall that is bonded to the first pane such that the wall is not bonded to the second pane but rather is spaced apart from the second pane. Also, in some cases, the first pane has opposed first and second surfaces and an edge forming an outer perimeter, and the wall is bonded to the second surface of the first pane and spaced apart inwardly from the edge. The wall can also be in contact with (and preferably bonded to) the aerogel sheet. In certain cases, the aerogel sheet has a rectangular profile, and the wall surrounds the outer perimeter of the aerogel sheet. Additionally, in some cases, the organic material further defines a bridge that extends from the wall inwardly so as to engage (and preferably bond to) a portion of the second face of the aerogel sheet.

The organic material can also define a bead. The bead can engage (and preferably bond to) a wall of the spacer and also a portion of the second face of the aerogel sheet. In certain cases, the bead engages (and preferably bonds to) a wall of the spacer, a portion of the first pane and a portion of the second face of the aerogel sheet.

Another embodiment includes a multiple-pane insulating glazing unit comprising first and second panes, a spacer, a spacer sealant, an aerogel sheet and an encapsulation material. The spacer maintains the first and second panes in a spaced-apart configuration such that a between-pane space is located between the first and second panes. The aerogel sheet is located in the between-pane space and retained in a mounted position alongside the first pane by the encapsulation material bonded to the second pane. In some cases, the encapsulation material is bonded to the second pane but not to the first pane.

The aerogel sheet comprises a first face, a second face and an edge forming an outer perimeter of the aerogel sheet. The aerogel sheet is preferably devoid of degradation visible to the naked eye. In some cases, an entirety of the first face of the aerogel sheet is in contact with the first pane. Also, in some cases, a gas gap exists between the second face of the aerogel sheet and the second pane. The aerogel sheet can also comprise silica aerogel, such as silica aerogel synthesized from methyl silicate 51.

The encapsulation material can be in contact with the aerogel sheet. For example, the encapsulation material can be in contact with at least a portion (or an entirety) of the edge of the aerogel sheet. In some cases, the encapsulation material is in contact with at least a portion (or an entirety) of the edge and at least portion of the second face of the aerogel sheet. Also, in some cases, the encapsulation material is spaced apart from the spacer sealant, which can optionally comprise polyisobutylene. The encapsulation material can also comprise organic material in some cases. For example, the organic material can comprise PETG, such as extruded PETG.

Other embodiments provide a method of making an article. The method comprises positioning an aerogel sheet on a glass sheet (the aerogel sheet comprising a first face, a second face, and an edge forming an outer perimeter of the aerogel sheet) and applying a material comprising PETG to encapsulate the edge along at least a portion (and in some cases an entirety) of the outer perimeter of the aerogel sheet.

In some cases, the step of applying the material comprising PETG encapsulates the edge along an entirety of the outer perimeter of the aerogel sheet. The step of applying the material comprising PETG preferably places the aerogel sheet in contact the material comprising PETG glycol without any resulting degradation or cracking of the aerogel sheet. In certain cases, the step of applying the material comprising PETG includes applying the PETG in a heated state such that it becomes compatible with the thermal expansion coefficient of the aerogel sheet before contacting the aerogel sheet. For example, in some cases, the step of applying the PETG in a heated state includes dispensing heated PETG from a nozzle such that it has a temperature within a range of from 120° C. to 195° C., such as from 150° C. to 194° C., upon contacting the aerogel sheet.

Also, in some cases, the step of applying the PETG in a heated state includes dispensing heated PETG from a nozzle while maintaining a gap distance between the nozzle and the second face of the aerogel sheet, such that the heated PETG dispensed from the nozzle cools while moving between the nozzle and the second face of the aerogel sheet. The gap distance can be maintained so as to allow the heated PETG to begin curing before coming into contact with the second face of the aerogel sheet. In certain cases, the heated PETG, upon leaving the nozzle, is at a temperature in a range of from 185° C. to 250° C., such as from 200° C. to 250° C., or perhaps optimally 245-255° C., and the gap distance is in a range of from 1 mm to 4 mm. In additional or alternative cases, the heated PETG, upon contacting the second face of the aerogel sheet, is at a temperature in a range of from 120° C. to 195° C., such as from 150° C. to 194° C.

The step of applying the material comprising PETG can include applying the material to form a wall on a surface of the glass sheet such that the wall abuts the edge of the aerogel sheet along at least a portion (and in some cases an entirety) of the outer perimeter. In some cases, the step of applying the material bonds the wall to the surface of the glass sheet. The step of applying the material comprising PETG can also include forming a bridge that extends from the wall inwardly so as to engage (and preferably bond to) a portion of the second face of the aerogel sheet.

In some cases, the step of applying the material comprising PETG includes dispensing heated PETG from a nozzle such that it has a temperature within a range of from 120° C. to 195° C., such as from 150° C. to 194° C. upon contacting the aerogel sheet. Also, in some cases, the step includes dispensing heated PETG from a nozzle while maintaining a gap distance between the nozzle and the second face of the aerogel sheet, such that the PETG dispensed from the nozzle cools while moving between the nozzle and the second face of the aerogel sheet. The gap distance can be maintained so as to allow the heated PETG to begin curing before coming into contact with the second face of the aerogel sheet. In certain cases, the heated PETG, upon leaving the nozzle, is at a temperature in a range of from 185° C. to 250° C., such as from 200° C. to 250° C., or perhaps optimally 245-255° C., and the gap distance is in a range of from 1 mm to 4 mm. In additional or alternative cases, the heated PETG, upon contacting the second face of the aerogel sheet, is at a temperature in a range of from 120° C. to 195° C., such as from 150° C. to 194° C.

Other methods of making an article are provided according to some embodiments. Another method includes positioning an aerogel sheet on a glass sheet (the aerogel sheet comprising a first face, a second face, and an edge forming an outer perimeter of the aerogel sheet) and dispensing heated organic material to encapsulate the edge along at least a portion of the outer perimeter of the aerogel sheet, wherein the dispensing involves dispensing the heated organic material from a nozzle while maintaining a gap distance between the nozzle and the aerogel sheet, such that the heated organic material cools while moving between the nozzle and the aerogel sheet. The gap distance can be maintained so as to allow the heated organic material to begin curing before contacting the aerogel sheet. Preferably, the heated organic material, upon contacting the aerogel sheet, is in a partially cured state such that it bonds to the aerogel sheet without any resulting degradation or cracking of the aerogel sheet.

The step of positioning the aerogel sheet on the glass sheet can also include positioning an entirety of the first face of the aerogel sheet on the glass sheet. Some of the heated organic material can contact the second face of the aerogel sheet that faces away from the glass sheet. The aerogel sheet can also comprise silica aerogel, such as silica aerogel synthesized from methyl silicate 51.

In certain cases, the heated organic material comprises heated PETG. The heated PETG, upon contacting aerogel sheet, can be at a temperature in a range of from 120° C. to 195° C., such as from 150° C. to 194° C. Also, the heated PETG, upon leaving the nozzle, can be at a temperature in a range of from 185° C. to 250° C., such as from 200° C. to 250° C., or perhaps optimally 245-255° C., and the gap distance can be in a range of from 1 mm to 4 mm.

Another method of making an article includes positioning an aerogel sheet on a glass sheet (the aerogel sheet comprising a first face, a second face, and an edge forming an outer perimeter of the aerogel sheet) and dispensing heated organic material to encapsulate the edge along at least a portion of the outer perimeter of the aerogel sheet, wherein the dispensing involves dispensing the heated organic material from a nozzle such that the heated organic material becomes compatible with a thermal expansion coefficient of the aerogel sheet upon contacting the aerogel sheet. Preferably, the heated organic material, upon contacting the aerogel sheet, is in a partially cured state and/or has a temperature such that it bonds to the aerogel sheet without any resulting cracking of the aerogel sheet. In certain cases, the heated organic material comprises heated PETG. The heated PETG, upon contacting aerogel sheet, can be at a temperature in a range of from 120° C. to 195° C., such as from 150° C. to 194° C.

The step of positioning the aerogel sheet on the glass sheet can also include positioning an entirety of the first face of the aerogel sheet on the glass sheet. Some of the heated organic material can contact the second face of the aerogel sheet that faces away from the glass sheet. The aerogel sheet can also comprise silica aerogel, such as silica aerogel synthesized from methyl silicate 51.

In another embodiment of a method of making an article, the method includes positioning an aerogel sheet on a glass sheet (the aerogel sheet comprising a first face, a second face, and an edge forming an outer perimeter of the aerogel sheet), forming a wall on the glass sheet such that the wall is positioned to abut the edge of the aerogel sheet along at least a portion of the outer perimeter, and depositing a bridge on the wall, the bridge comprising organic material and extending from the wall inwardly so as to engage a portion of the second face of the aerogel sheet. The step of positioning the aerogel sheet on the glass sheet can also include positioning an entirety of the first face of the aerogel sheet on the glass sheet. The aerogel sheet can also comprise silica aerogel, such as silica aerogel synthesized from methyl silicate 51.

In some cases, the step of forming the wall on the glass sheet encapsulates the edge along an entirety of the outer perimeter of the aerogel sheet. Also, in certain cases, the step of forming the wall on the glass sheet is performed before the step of positioning the aerogel sheet in contact with the glass sheet. The step of forming the wall can also include bonding preformed material to the glass sheet to form the wall. In other cases, this step includes depositing organic material on the glass sheet to form the wall. The organic material deposited to form the wall and the organic material deposited to form the bridge can be the same organic material, such as PETG.

The step of depositing the bridge can include dispensing the organic material in a heated state from a nozzle such that the heated organic material becomes compatible with a thermal expansion coefficient of the aerogel sheet upon contacting the second face of the aerogel sheet. Preferably, the heated organic material, upon contacting the aerogel sheet, is in a partially cured state and/or has a temperature such that it that bonds to the aerogel sheet without any resulting cracking of the aerogel sheet.

In certain cases, the heated organic material comprises heated PETG. The heated PETG, upon contacting the second face of the aerogel sheet, can be at a temperature in a range of from 120° C. to 195° C., such as from 150° C. to 194° C. In some cases, the dispensing involves dispensing the heated PETG from a nozzle while maintaining a gap distance between the nozzle and the aerogel sheet, such that the heated organic material cools while moving between the nozzle and the aerogel sheet. In certain cases, the gap distance is in a range of from 1 mm to 4 mm.

In certain embodiments, the invention provides a multiple-pane insulating glazing unit comprising first and second panes, a spacer, spacer sealant, an aerogel sheet, a first material, and a second material. In the present embodiments, the spacer maintains the first and second panes in a spaced-apart configuration, such that a between-pane space is located between the first and second panes. The aerogel sheet is located in the between-pane space and retained in a mounted position alongside the first pane. The aerogel sheet comprises a first face, a second face and an edge forming an outer perimeter of the aerogel sheet. In the present embodiments, the first material encapsulates the edge of the aerogel sheet along at least a portion of the outer perimeter, and the second material adheres to the first pane, while the first and second materials adhere together.

In other embodiments, the invention provides a multiple-pane insulating glazing unit comprising first and second panes, a spacer, spacer sealant, an aerogel sheet, and an encapsulation material. The spacer maintains the first and second panes in a spaced-apart configuration, such that a between-pane space is located between the first and second panes. A first deposit of the spacer sealant is located between the spacer and the first pane, and a second deposit of the spacer sealant is located between the spacer and the second pane. In the present embodiments, the aerogel sheet is located in the between-pane space and retained in a mounted position alongside the first pane. The aerogel sheet comprises a first face, a second face and an edge forming an outer perimeter of the aerogel sheet. The encapsulation material encapsulates the edge of the aerogel sheet along at least a portion of the outer perimeter. In the present embodiments, the encapsulation material adheres to the first deposit of the spacer sealant.

Certain embodiments of the invention provide a method of making an article. In the present embodiments, the method comprises providing an aerogel sheet on a first glass sheet. The aerogel sheet comprises a first face, a second face and an edge forming an outer perimeter of the aerogel sheet. The method also comprises applying an encapsulation material to encapsulate the edge along at least a portion of the outer perimeter of the aerogel sheet. Further, the method comprises adhering a spacer onto the first glass sheet, the spacer having opposed first and second sides respectively bearing first and second deposits of spacer sealant, such that adhering the spacer onto the first glass sheet comprises pressing the first deposit of spacer sealant against the first glass sheet. This creates a glass-aerogel-spacer subassembly. Thereafter, the method includes performing a coupling operation comprising assembling together a second glass pane and the glass-aerogel-spacer subassembly, such that the aerogel sheet, encapsulation material, and spacer are located between the first and second glass sheets.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

As used herein, the term “aerogel” refers to a material obtained by combining either a nonfluid colloidal network or a polymer network with a liquid so as to form a gel, and then removing the liquid from the gel and replacing the liquid with a gas or vacuum. In the present embodiments, the aerogel is provided in the form of an aerogel sheet. This is in contrast to aerogel in flowable granular or otherwise particulate form. The aerogel sheet is preferably self-supporting, i.e., once fully synthesized and formed, the sheet can retain sheet form without being adhered to glass or another support.

In the present specification, anywhere the terms “comprising” or “comprises” are used, those terms have their ordinary, open-ended meaning. In addition, the disclosure at each such location is to be understood to also disclose that it may, as an alternative, “consist essentially of” or “consist of.”

Some embodiments provide encapsulation materials that can be placed into contact with an aerogel sheet without cracking or degrading it. Aerogel sheets are fragile, and they tend to crack and/or degrade when exposed to a wide variety of materials. Also, many materials do not bond to a face of an aerogel sheet, or they delaminate from the aerogel face after a period of time. As a result, it can be difficult to find a material that can be provided in contact with an aerogel sheet and used as an encapsulation material that mounts the aerogel sheet in place alongside a glass sheet. Applicant has evaluated many materials as candidates for use as an encapsulation material that can be provided in direct contact with a silica aerogel sheet. During this evaluation, Applicant eliminated numerous materials as candidates for use as an encapsulation material for a variety of reasons.

First, Applicant found that many materials were not chemically compatible with a silica aerogel sheet. A material is chemically compatible with a silica aerogel sheet if it does not chemically react with functional groups on the silica aerogel sheet. Applicant observed that many materials chemically react with functional groups on a silica aerogel sheet. In some cases, the chemical reaction is immediate, and the materials degrade the silica aerogel sheet at the moment of contact. In other cases, the chemical reaction takes place over time. For example, the materials may not degrade the silica aerogel sheet upon contact yet may cause degradation over time. Following are materials Applicant found to be chemically incompatible with a silica aerogel sheet: polyvinyl chloride (PVC) glue, polyvinyl acetate (PVA) glue, Cyan acrylic EM-2000 glue, Cyan acrylic EM-150 glue, Cyan acrylic EM-02 glue, Elmers's cement, loctite cement, 3M epoxy adhesive DP 190, 3M epoxy adhesive DP 125, HB Fuller-hot melt silicone adhesive, Dowsil 3-0117 silicone sealant, Momentive RTV 5240 silicone sealant, Rust-Oleum gloss clear-UV resistant, Ram-Tack spray adhesive, 3M photo mount, AC50 spray adhesive, Krylon high strength spray adhesive, thermoplastic hot glue hotmelt, polyisobutylene (butyl string-PIV grey rope, polyisobutylene (butyl string-PIV black rope), polyisobutylene (butyl string-PIV black tape), polyisobutylene 30, VHB tape, scotch double sided tape, polyvinyl acetate (PVA) filament, polylactic acid (PLA) filament and carbon fiber-nylon (NylonX) filament.

Second, Applicant found that many materials were not physically compatible with a silica aerogel sheet. A material is physically compatible with the aerogel sheet if it bonds to the aerogel sheet without becoming absorbed by pores of the aerogel sheet. It has been observed that when a material becomes absorbed by the pores, either immediately or over a period of time, the pores collapse, thereby resulting in a degraded aerogel sheet. Following are materials Applicant found to be physically incompatible with a silica aerogel sheet: Cyan acrylic EM-02 glue, loctite cement, polyvinyl butyral (PVB) laminate, HB Fuller 4SG, Dowsil 3-0117 silicone sealant, Momentive RTV 5240 silicone sealant, Rust-Oleum gloss clear-UV resistant, Ram-Tack spray adhesive, 3M photo mount, AC50 spray adhesive, Krylon high strength spray adhesive, polyisobutylene (butyl string-PIB grey rope), polyisobutylene (butyl string-PIB black rope), polyisobutylene (butyl string-PIB black tape), Scotch double sided tape, PhotoBond acrylic adhesive, polyvinyl acetate (PVA) filament and carbon fiber-nylon (NylonX) filament.

Third, Applicant found that many materials do not bond to an aerogel sheet without the use of compression. Many materials require compression to form a bond with an aerogel sheet, but compression is undesirable as it poses a cracking risk to the aerogel sheet. Following are materials Applicant found to be unsuitable because they require the use of compression: mounting tape, SentryGlas Plus (SGP) laminate, polyvinyl butyral (PVB) laminate, HB Fuller 4SG, rubber foam, polyisobutylene (butyl string-PIB) grey rope, polyisobutylene (butyl string-PIB black rope), polyisobutylene (butyl string-PIB black tape), polyisobutylene 30 and VHB tape.

Fourth, Applicant found that many materials cannot form a bond to an aerogel sheet without being heated. Unfortunately, some of these materials crack the aerogel sheet when cooling, and therefore not compatible with a thermal expansion coefficient of the aerogel sheet. Following are materials Applicant found to be incompatible with a thermal expansion coefficient of a silica aerogel sheet when applied in a heated state: ATSP oligomeric resin in N-methylpyrolidone solvent, SentryGlas Plus (SGP) laminate and polyvinyl butyral (PVB) laminate.

Fifth, Applicant found that several materials cannot be used as an encapsulation material that is exposed to a between-pane space of an insulating glazing unit. First, Applicant found that many materials cannot be used inside a between-pane space of an insulating glazing unit because they outgas. Outgassing is undesirable for many reasons, one of which is that it causes variations in pressures within the between-pane space of an insulating glazing unit. Pressure variations can cause plastic deformation to the insulating glazing unit, which in turn can cause sealants to leak. Following are materials Applicant found to be unsuitable due to outgassing: mounting tape, antistatic polyurethane foam, super soft polyurethane foam, rubber foam, Photobond acrylic adhesive, closed cell high temperature weather resistant-silicone foam-food grade, closed cell high temperature silicone rubber, antistatic polyurethane foam and HD36-HQ-open cell foam.

Sixth, Applicant found that many materials cannot be used inside an insulating glazing unit because they degrade upon exposure to ultraviolet radiation (e.g., UVA or UVB light). Insulating glazing units are used in window applications and are consistently exposed to sunlight. To be suitable for use as an encapsulation material, a material must not degrade upon exposure to ultraviolet radiation inside the between-pane space. Following are materials Applicant found to degrade upon exposure to ultraviolet radiation inside a between-pane space: antistatic polyurethane foam, super soft polyurethane foam, rigid closed cell foam and poly-foam.

Even though most standard materials were eliminated as candidates for use as an encapsulation material, Applicant surprisingly discovered that polyethylene terephthalate glycol (“PETG”) can be an excellent encapsulation material. PETG is a plastic material that can be heated so it can be deposited on another material in a desired shape. In more detail, it is a thermoplastic. PETG is commonly provided in the form of a filament, which is then heated by an extruder and printed directly onto another material.

Applicant found PETG to be chemically compatible with an aerogel sheet. Again, a material is chemically compatible with an aerogel sheet if it does not chemically react with functional groups on the aerogel sheet. In particular, PETG is chemically compatible with a silica aerogel sheet because it does not react with silane functional groups on the silica aerogel sheet. For example, PETG is chemically compatible with a hydrophilic silica aerogel sheet because it does not react with hydroxyl functional groups on the hydrophilic silica aerogel sheet. Also, PETG is chemically compatible with a hydrophobic silica aerogel sheet because it does not react with methyl functional groups on the hydrophobic silica aerogel sheet.

Applicant also found PETG to be physically compatible with an aerogel sheet. When PETG is heated, it bonds to the aerogel sheet. At the same time, it remains viscous enough that it does not get pulled into the aerogel pores. Further, Applicant found that PETG can be heated so it bonds to the aerogel sheet without the use of compression. PETG also does not delaminate from the aerogel sheet after cooling.

In addition, Applicant found PETG to be compatible for use inside an insulating glazing unit. For example, PETG meets outgassing standards of ASTM E595-15: Standard Test Method for Total Mass Loss and Collected Volatile Condensable Materials from Outgassing in a Vacuum Environment, the contents of which are incorporated herein by reference. Thus, it does not outgas substantially. PETG can also be provided inside an insulating glazing unit that meets fogging resistance standards of ASTM E2189: Standard Test Method for Testing Resistance to Fogging in Insulating Glass Units, the contents of which are incorporated herein by reference.

PETG also does not introduce too much moisture to a between-pane space of an insulating glazing unit. For example, PETG can be provided inside an insulating glazing unit that meets the standards of E546-14: Standard Test Method for Frost/Dew Point of Sealed Insulating Glazing Units in the Vertical Position and E2188-19: Standard Test Method for Insulating Glass Unit Performance, the contents of both which are incorporated herein by reference. Also, PETG does not introduce moisture to the between-pane space in an amount that corrodes a low-emissivity coating exposed to the between-pane space. Further, PETG does not introduce moisture in an amount that substantially extends the period of time to desiccate a between-pane space with an aerogel sheet therein. Thus, PETG does not introduce substantial moisture into an IG unit when provided in the between-pane space of the IG unit.

Further, PETG does not degrade upon exposure to ultraviolet radiation inside a between-pane space of an insulating glazing unit. PETG does not degrade upon exposure to ultraviolet light provided as described in E2188-19: Standard Test Method for Insulating Glass Unit Performance and E2189: Standard Test Method for Testing Resistance to Fogging in Insulating Glass Units, the contents of both which are incorporated herein by reference.

PETG generally needs to be deposited in a heated form to bond with an aerogel sheet. PETG is commonly used in 3D printing and is traditionally deposited directly onto a printing bed to form a first layer. In fact, it is commonly recommended that a nozzle be spaced only 0.1 mm from the printing bed and that the PETG be extruded from a nozzle at temperature of greater than 220° C. However, when PETG is deposited using these traditional parameters, it causes the aerogel sheet to crack upon contact.

Applicant surprisingly discovered that heated PETG can actually be deposited in a manner that makes it compatible with the thermal expansion coefficient of the aerogel sheet and does not cause cracking. Applicant discovered that by depositing heated PETG onto an aerogel sheet so it has a temperature in the range of from 120° C. to 195° C., such as from 123° C. to 194° C., when contacting the aerogel sheet, it can be compatible with the thermal expansion coefficient of the aerogel sheet while also bonding to the sheet. Thus, Applicant discovered that a temperature in the range of from 120° C. to 195° C., such as from 123° C. to 194° C., can be a “sweet spot” that allows the heated PETG to bond to the aerogel sheet without cracking it. If the temperature is lower than 123° C., or even lower than 120° C., when contacting the aerogel sheet, the PETG may not adhere well to the aerogel sheet. If the temperature is higher than 194° C., or even higher than 195° C., when contacting the aerogel sheet, the PETG may be too hot to cool and cure as needed before reaching the aerogel sheet and may cause cracking. Applicant obtained particularly desirable results when the PETG contacts the aerogel sheet while having a temperature within the range of 150° C. to 194° C., such as 175° C. to 194° C.

Applicant also discovered that by depositing heated PETG onto an aerogel sheet from a nozzle that is spaced from the aerogel sheet by a gap distance, the PETG can become compatible with the thermal expansion coefficient of the aerogel sheet while also bonding to the sheet. Applicant believes that by maintaining a gap distance, the heated PETG begins cooling and curing before contacting the aerogel sheet. This can prevent the heated PETG from cracking the aerogel sheet as it continues to cool and cure. At the same time, the heated PETG still forms a bond with the aerogel sheet. The PETG therefore becomes thermally compatible with the aerogel sheet before contacting it.

The gap distance can be a distance that allows the PETG to cool such that it contacts the aerogel sheet at a temperature in the range of from 120° C. to 195° C., such as from 123° C. to 194° C., or from 150° C. to 194° C. In some cases, the gap distance is in a range from 1 mm to 10 mm. As one example, the PETG can be deposited from a 0.4 mm nozzle at a nozzle temperature (i.e., the temperature of the PETG when in the nozzle, just prior to being extruded out of the nozzle) in the range of from 185° C. to 250° C. while being spaced from the aerogel sheet by a gap distance in the range of from 1 mm to 4 mm. In one specific example, the PETG can be deposited from a 0.4 mm nozzle at a nozzle temperature in the range of from 200° C. to 250° C. while being spaced from the aerogel sheet by a gap distance in the range of from 2 mm to 4 mm. In other embodiments, the PETG can be deposited from a nozzle having an orifice size of from 5 mm to 10 mm (such as 6 mm, 8 mm, or 10 mm) at a nozzle temperature in the range of from 185° C. to 250° C. while being spaced from the aerogel sheet by a gap distance in a range of from greater than 4 mm to 6 mm, such as from 4.2 mm to 5.6 mm. In one embodiment, the PETG can be deposited from a 6 mm nozzle at a nozzle temperature in the range of from 200° C. to 250° C. while being spaced from the aerogel sheet by a gap distance in the range of from 4.2 mm to 5.6 mm. In these and other embodiments, a nozzle temperature of 245-255° C., such as 250° C., may be preferred.

More generally, the invention provides a group of embodiments wherein a method of making an article comprises dispensing heated organic material to encapsulate the edge of an aerogel sheet along at least a portion of an outer perimeter of the aerogel sheet. In the present embodiment group, the dispensing involves dispensing the heated organic material from a nozzle while maintaining a gap distance between the nozzle and the aerogel sheet, such that the heated organic material cools while moving between the nozzle and the aerogel sheet.

In the present embodiment group, the gap distance preferably is maintained so as to allow the heated organic material to begin curing before contacting the aerogel sheet. Furthermore, the heated organic material, upon contacting the aerogel sheet, preferably is in a partially cured state such that it bonds to the aerogel sheet without any resulting cracking (and preferably without other degradation) of the aerogel sheet.

In some of the present embodiments, the gap distance is in a range of from 1 mm to 6 mm. In some cases, the gap distance is in a range of from greater than 4 mm to 6 mm, such as from 4.2 mm to 5.6 mm. Additionally or alternatively, the heated organic material, upon leaving the nozzle, can optionally be at a temperature in a range of from 185° C. to 250° C., or perhaps from 245° C. to 255° C., such as 250° C. Furthermore, the heated organic material, upon contacting the aerogel sheet, preferably is at a temperature in a range of from 120° C. to 195° C., such as from 123° C. to 194° C., or from 150° C. to 194° C. In the present embodiment group, the extrusion nozzle preferably has an orifice size in a range of from 0.4 mm to 10 mm. In certain embodiments, the orifice size is in a range of from 5 mm to 10 mm.

In the present embodiment group, the organic material preferably comprises polyethylene terephthalate glycol. It is to be appreciated, however, that the present method of using a gap distance to provide for reduced contact temperature also be used for extruding other organic materials. For example, other organic extrusion materials that may satisfy the performance criteria taught herein can also be used.

Furthermore, while the present embodiment group uses a gap distance between a dispensing nozzle and the aerogel sheet, other encapsulation embodiments of the present disclosure may involve dispensing encapsulation material without using such a gap distance (e.g., having the dispensing nozzle contact the aerogel sheet when dispensing), or they may involve using gap distances that are smaller or larger than the example ranges noted above. Similarly, it may be desirable to use nozzle and contact temperatures different from those mentioned above. For example, depending on the encapsulation material used and the aerogel material used, it may be desirable to take different approaches on the presence or absence of a gap distance, and it may be desirable to vary the nozzle and contact temperatures accordingly.

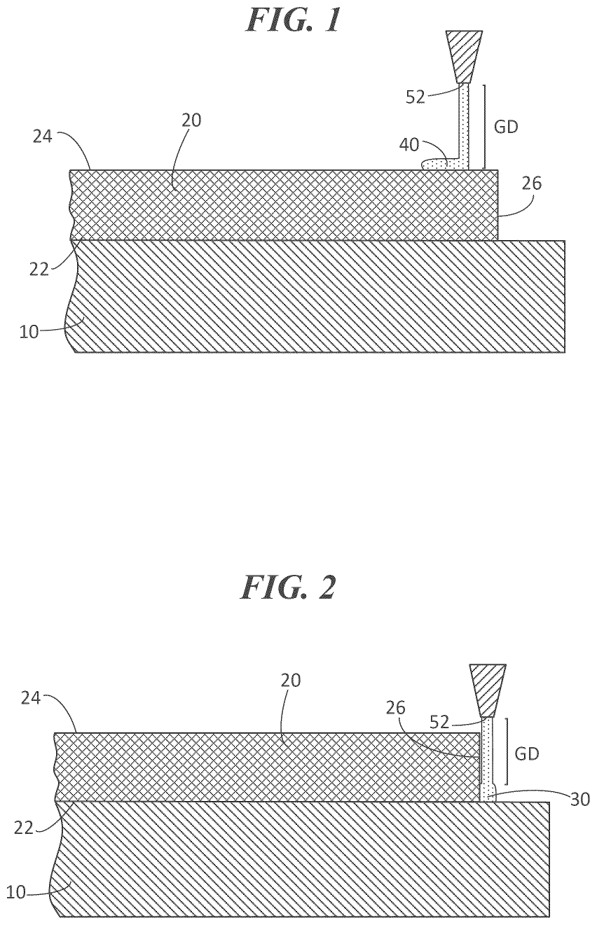

FIGS. 1-2 are schematic illustrations showing potential nozzle positioning relative to an aerogel sheet 20 using a gap distance GD. The aerogel sheet 20 generally includes a first face 22, a second face 24 and an edge 26. The aerogel sheet 20 is provided on a glass sheet 10. A nozzle 52 is shown depositing a flow of heated PETG onto a face and/or edge of the aerogel sheet 20. The nozzle 52 can be part of an extrusion apparatus comprising an extruder that heats a PETG filament or bead.

In FIG. 1, a nozzle 52 deposits heated PETG onto a second face 24 of the aerogel sheet 20. The nozzle 52 can be moved in any desired fashion and in any desired direction relative to the second face 24. As the nozzle 52 moves, a gap distance GD is maintained between the nozzle 52 and the second face 24. At the same time, heated PETG moves from the nozzle 52 towards the second face 24 and begins cooling and curing. Once the PETG flow reaches the second face 24, it contacts and preferably bonds to the aerogel sheet 20 without degrading it.

In FIG. 2, a nozzle 52 deposits heated PETG in contact with a contact point along an edge 26 of the aerogel sheet 20. The nozzle 52 here can move in any desired fashion and in any desired direction to deposit heated PETG along the edge 26. Here too, as the nozzle 52 moves, a gap distance GD preferably is maintained between the nozzle 52 and the contact point. Skilled artisans will understand that the nozzle 52 can generally move in any direction and in any desired fashion, preferably while maintaining a gap distance GD between the nozzle 52 and the contact point. Regardless of where the heated PETG is deposited onto the aerogel sheet, the gap distance GD preferably is maintained as the nozzle 52 moves and/or changes positions. As will be appreciated from the figures and teachings of the present disclosure, the gap distance GD is the distance from the nozzle to the point where the dispensed encapsulation material contacts the aerogel sheet. While the encapsulation material can optionally be dispensed (e.g., printed or extruded) in a downward vertical direction in any embodiment of the present disclosure (optionally in combination with the glass sheet being in a horizontal position during dispensing), it is also possible to dispense the material horizontally or at various angles.

Certain embodiments provide a glass article that includes a glass sheet 10 and an aerogel sheet 20. The aerogel sheet 20 is retained in a mounted position alongside the glass sheet 10 by an encapsulation material. If desired, there can also be other means for retaining the aerogel sheet in the mounted position, such as optional bonding (e.g., from van der Waals forces) between the aerogel sheet and the glass sheet. In any embodiment of the present disclosure, an attachment technique and the resulting aerogel sheet attachment in accordance with U.S. patent application No. 63/736,285 or 63/736,304, each entitled “Aerogel Attachment Technology,” the salient teachings of which are incorporated herein by reference, can optionally be provided in combination with any encapsulation technology of the present disclosure. The aerogel sheet 20 is preferably an intact sheet that does not have degradation or cracking visible to the naked eye. In some cases, the encapsulation material (which may also be referred to herein as the “first material”) comprises an organic material. In certain cases, the organic material comprises PETG. In specific cases, the organic material comprises extruded PETG. For any embodiment of the present disclosure, while it is preferred that the encapsulation material comprise polyethylene terephthalate glycol, it is to be appreciated that other materials that may satisfy the performance criteria taught herein can also be used.

Preferably, the encapsulation material is chemically compatible with the aerogel sheet 20. In some embodiments, the encapsulation material is chemically compatible with a silica aerogel sheet. In other words, the encapsulation material does not chemically react with silane functional groups on a silica aerogel sheet. In some embodiments, the encapsulation material is chemically compatible with a silica aerogel sheet synthesized from methyl silicate (MS-51). In other embodiments, the encapsulation material is chemically compatible with a silica aerogel sheet synthesized from tetramethyl orthosilicate (TMOS).

In certain embodiments, the encapsulation material is a material that is chemically compatible with a hydrophilic silica aerogel sheet. Here, the encapsulation material does not chemically react with hydroxyl functional groups on the hydrophilic silica aerogel sheet. In some cases, the hydrophilic silica aerogel sheet is synthesized from methyl silicate (MS-51). For example, the hydrophilic silica aerogel sheet can optionally be synthesized from MS-51 as precursor, methanol as solvent and 0.5% ammonium hydroxide solution as catalyst. Suitable hydrophilic silica aerogel sheets are described in U.S. Patent Application Publication Nos. US20230286810, US20230286812, US US20230286813, and U.S. patent application Ser. No. 18/492,927, each entitled “Silica Wet Gel and Aerogel Materials,” the teachings of each which are incorporated herein by reference.

In other embodiments, the encapsulation material is chemically compatible with a hydrophobic silica aerogel sheet. Here, the encapsulation material does not chemically react with methyl functional groups on the hydrophobic silica aerogel sheet. In some cases, the hydrophobic silica aerogel sheet is synthesized from MS-51 and methyltrimethoxysilane (MTMS). For example, the hydrophobic silica aerogel sheet can optionally be synthesized from MS-51, MTMS, methanol and ammonia hydroxide. In other cases, the hydrophobic silica aerogel sheet is synthesized from tetramethyl orthosilicate (TMOS) and MTMS. In such cases, the hydrophobic silica aerogel sheet can optionally be synthesized from TMOS, MTMS, methanol and ammonia hydroxide. Suitable hydrophobic silica-based aerogel sheets are described in U.S. patent application No. 63/497,250, entitled “Hydrophobic Silica Wet Gel and Aerogel,” the teachings of which are incorporated herein by reference.

In addition, the encapsulation material preferably is physically compatible with the aerogel sheet 20. A material is physically compatible with the aerogel sheet if it bonds to the aerogel sheet without becoming absorbed by pores of the aerogel sheet. In some cases, the encapsulation material is physically compatible with a silica aerogel sheet. The silica aerogel sheet can be any silica aerogel sheet described herein. For example, the silica aerogel sheet can optionally be a silica aerogel sheet synthesized from methyl silicate (MS-51).

In some embodiments, the encapsulation material bonds to the aerogel sheet 20 without use of compression. In some cases, the encapsulation material bonds to a silica aerogel sheet without use of compression. Here too, the silica aerogel sheet can be any silica aerogel sheet described herein, for example, a silica aerogel sheet synthesized from methyl silicate 51 (MS-51).

In some of the present methods, the encapsulation material is applied while in a heated state and is compatible with a thermal expansion coefficient of the aerogel sheet 20. In preferred embodiments, the heated encapsulation material bonds to the aerogel sheet 20 without cracking the aerogel sheet. In some cases, the heated encapsulation material bonds to a silica aerogel sheet without cracking it. In such cases, the silica aerogel sheet can be any silica aerogel sheet described herein, for example, a silica aerogel sheet synthesized from methyl silicate 51 (MS-51).

In additional embodiments, the encapsulation material mounts an aerogel sheet 20 on a glass sheet 10 that is provided as part of an insulating glazing unit. In such cases, the encapsulation material will be exposed to a between-pane space of the insulating glazing unit. Some embodiments therefore provide an encapsulation material that is compatible with components exposed to the between-pane space. An encapsulation material is considered compatible with a component if it does not introduce any changes to the between-pane space that cause such component to degrade. Such changes can be immediate changes or changes that take place over a period of time.

In some embodiments, the encapsulation material is a material that does not outgas inside an insulating glazing unit. One way to test materials for outgassing is the ASTM E595-15: Standard Test Method for Total Mass Loss and Collected Volatile Condensable Materials from Outgassing in a Vacuum Environment, the contents of which are incorporated herein by reference. Thus, the encapsulation material can be a material that complies with the standards of ASTM E595-15. Another way to test materials for outgassing inside an insulating glazing unit is the ASTM E2189: Standard Test Method for Testing Resistance to Fogging in Insulating Glass Units, the contents of which are incorporated herein by reference. Other embodiments therefore include an encapsulation material that can be provided in an insulating glazing unit that complies with the standards of ASTM E2189.

In other embodiments, the encapsulation material is a material that does not introduce too much moisture inside an insulating glazing unit in an amount that degrades (e.g., corrodes) components within the between-pane space. In some cases, the encapsulation material can be provided in an insulating glazing unit such that the insulating glazing unit meets standards outlined in E546-14: Standard Test Method for Frost/Dew Point of Sealed Insulating Glazing Units in the Vertical Position, the contents of which are incorporated herein by reference. In additional cases, the encapsulation material can be provided in an insulating glazing unit such that the insulating glazing unit meets standards outlined in E2188-19: Standard Test Method for Insulating Glass Unit Performance, the contents of which are incorporated herein by reference.

In some embodiments, the encapsulation material is a material that does not introduce moisture to the between-pane space in an amount that corrodes an optional low-emissivity coating exposed to the between-pane space. In certain cases, the low-emissivity coating is a coating that includes at least one silver-inclusive film, which contains more than 50% silver by weight (e.g., a metallic silver film). In certain preferred embodiments, the low-emissivity coating includes three or more infrared-reflective films (e.g., silver-containing films). Low-emissivity coatings having three or more infrared-reflective films are described in U.S. patent and application Ser. No. 11/546,152 and U.S. Pat. Nos. 7,572,511 and 7,572,510 and 7,572,509 and Ser. No. 11/545,211 and U.S. Pat. Nos. 7,342,716 and 7,339,728, the teachings of each of which are incorporated herein by reference.

Furthermore, the encapsulation material preferably is a material that does not introduce moisture in an amount that degrades a spacer sealant, such as a silicone sealant and/or a polyisobutylene sealant. Additionally, or alternatively, the encapsulation material can optionally be a material that does not introduce moisture in an amount that substantially extends a period of time required to desiccate a between-pane containing an aerogel sheet 20.

Aerogel sheets are known to introduce some moisture to the between-pane space of an insulating glazing unit. Desiccants can be provided within the between-pane space to absorb this moisture. It typically takes a period of time (e.g., 6 weeks) to desiccate the between-pane space with an aerogel sheet inside. Thus, in certain embodiments, the encapsulation material is a material that does not introduce additional moisture (or introduces substantially no additional moisture) to the between-pane space beyond what is introduced by the aerogel sheet 20.

Further, in some embodiments, the encapsulation material is a material that does not degrade upon exposure to ultraviolet light (e.g., UVA or UVB light) inside an insulating glazing unit. In certain cases, the encapsulation material is a material that does not degrade upon exposure to ultraviolet light provided as described in E2188-19: Standard Test Method for Insulating Glass Unit Performance and E2189: Standard Test Method for Testing Resistance to Fogging in Insulating Glass Units, the contents of both which are incorporated herein by reference.

Certain embodiments provide a glass article that includes a glass sheet 10 and an aerogel sheet 20 retained in a mounted position alongside the glass sheet 10 by an encapsulation material. As noted above, there may also be other means for retaining the aerogel sheet in the mounted position. The glass sheet 10 can have any desired sheet-like configuration. For example, the glass sheet 10 can be a square sheet, a rectangular sheet, a triangular sheet, a hexagonal or octagonal sheet or an arched sheet. In many embodiments, the glass sheet 10 has a rectangular sheet-like configuration.

A variety of known glass types can be used for the glass sheet 10, including soda-lime glass, borosilicate glass or aluminosilicate glass. In some cases, it may be desirable to use “white glass,” a low iron glass, etc. For some applications, it may be desirable to use tinted glass for the glass sheet 10. Moreover, there may be applications where the glass sheet 10 is formed of extremely thin, flexible glass, such as glass sold under the trademark Willow glass by Corning Inc. (Corning, New York, U.S.A.). If desired, the glass sheet 10 may be formed of a chemically strengthened glass, such as glass sold under the trademark Gorilla glass by Corning Inc. In certain embodiments, the glass sheet 10 is part of a window, door, skylight, or other glazing. In alternative embodiments, the glass sheet 10 is replaced with a sheet formed of a polymer, such as polycarbonate, acrylic, or PVC. Various other polymer materials (e.g., transparent polymers) may be used in such alternative embodiments.

Glass sheets of various sizes can be used for the glass sheet 10. Commonly, large-area glass sheets are used. For example, the glass sheet 10 can have a major dimension (e.g., a length or width) of at least about 0.1 meter, preferably at least about 0.5 meter, more preferably at least about 1 meter, perhaps more preferably at least about 1.5 meters (e.g., between about 2 meters and about 4 meters), and in some cases at least about 3 meters. In some embodiments, the glass sheet 10 is a jumbo glass sheet having a length and/or width that is between about 3 meters and about 10 meters, e.g., a glass sheet 10 having a width of about 3.5 meters and a length of about 6.5 meters.

Glass sheets of various thicknesses can be used. In some embodiments, the glass sheet 10 can have a thickness of about 1-8 mm. In some cases, the glass sheet 10 has a thickness of between about 2.3 mm and about 4.8 mm, and perhaps more preferably between about 2.5 mm and about 4.8 mm. In one embodiment, the glass sheet 10 has a thickness of about 3 mm.

A variety of known aerogel types can be used for the aerogel sheet 20. The aerogel sheet 20 can include, for example, any aerogel type described herein. In many cases, the aerogel sheet 20 is a silica aerogel sheet. For example, the aerogel sheet 20 can optionally be a hydrophilic silica aerogel sheet synthesized from methyl silicate (MS-51). In some cases, the aerogel sheet 20 is a hydrophilic silica aerogel synthesized from MS-51 as precursor, methanol as solvent and 0.5% ammonium hydroxide solution as catalyst.

In other cases, the aerogel sheet 20 is a hydrophobic silica aerogel sheet synthesized from MS-51 and methyltrimethoxysilane (MTMS). For example, the aerogel sheet 20 can be a hydrophobic silica aerogel sheet synthesized from MS-51, MTMS, methanol and ammonia hydroxide. In other cases, the aerogel sheet 20 is a hydrophobic silica aerogel sheet synthesized from tetramethyl orthosilicate (TMOS) and MTMS. For example, the aerogel sheet 20 can be a hydrophobic silica aerogel sheet synthesized from TMOS, MTMS, methanol and ammonia hydroxide.

Thus, the encapsulation material and the aerogel material preferably are selected to satisfy the performance criteria taught herein. In certain preferred embodiments, the encapsulation material comprises polyethylene terephthalate glycol and the aerogel comprises silica aerogel. However, any other combinations of encapsulation material and aerogel material that may satisfy the performance criteria taught herein can also be used.

In certain cases, the aerogel sheet 20 can be a sheet having a major dimension (e.g., a length or width) of at least 0.375 meter, for example at least about 0.70 meter, 0.75 meter, 0.80 meter, 0.85 meter, 0.90 meter, 0.95 meter, 1.0 meter, or in some cases at least about 1.125 meters or 1.25 meters. In certain embodiments, the aerogel sheet 20 has a major dimension of between 0.7 meter and 3 meters (e.g., between about 1.5 meters and about 3 meters). The aerogel sheet 20 can also have a thickness in a range of from 1.5 mm to 15 mm, such as greater than 2 mm but less than 8 mm, or from 2 mm to 4 mm (e.g., 3 mm).

The glass sheet 10 includes a first surface 12, an opposed second surface 14, and an edge 16 forming an outer perimeter. Additionally, the aerogel sheet 20 includes a first face 22, an opposed second face 24, and an edge 26 forming an outer perimeter. The glass sheet 10 and the aerogel sheet 20 are shown as having rectangular configurations, but skilled artisans will understand that other configurations can be used.

The aerogel sheet 20 is provided in a mounted position alongside the glass sheet 10 with the first face 22 of the aerogel sheet facing toward the glass sheet 10 and the second face 24 of the aerogel sheet 20 facing away from the glass sheet 10. An encapsulation material retains the aerogel sheet 20 in the mounted position. As noted above, there may also be other means for retaining the aerogel sheet in the mounted position. Preferably, the first face 22 of the aerogel sheet 20 is in contact with the second surface 14 of the glass sheet 10. In preferred embodiments, the entire first face 22 is in contact with the second surface 14.

Applicant has developed a number of advantageous configurations for encapsulation materials that achieve desirable results. In each of these configurations, any component that is in (or that may, over time, come into) direct contact with the aerogel sheet is formed of an encapsulation material that does not degrade the aerogel sheet. Furthermore, while any component that is not in direct contact with the aerogel sheet can be formed of any encapsulation material, such a component can optionally be formed of an encapsulation material that does not degrade the aerogel sheet.

In some configurations, the encapsulation material defines a wall 30 in contact with and preferably bonded (e.g., directly) to a second surface 14 of the glass sheet 10. If desired, there may be no separate adhesive between the wall and the glass sheet 10. The wall 30 can be in contact with the edge 26 of the aerogel sheet 20 or it can be spaced from the edge 26 of the aerogel sheet 20 by a gap G. In some cases, the wall 30 contacts and therefore encapsulates the edge of the aerogel sheet 20. In certain preferred cases, the wall 30 bonds to the edge 26 of the aerogel sheet 20.

In other configurations, the encapsulation material defines a bridge 40 that contacts a second face 24 of the aerogel sheet 20. When provided, the bridge 40 preferably is in contact with and bonded to a wall 30. In addition, the bridge 40 preferably is in contact with and bonded to a second face 24 of the aerogel sheet 20. In embodiments of this nature, the bridge 40, together with the wall 30, encapsulate the edge 26 of the aerogel sheet 20.

The wall 30 and the bridge 40 can be formed of the same material or formed of different materials. When provided, the wall 30 and the bridge 40 can optionally be formed of the same material. In certain cases, the wall 30 and the bridge 40 are formed of an encapsulation material comprising organic material. The organic material can comprise, for example, PETG.

In certain preferred configurations, the encapsulation material defines a bead (or glob) 50. In some cases, the bead 50 is in contact with and bonded (e.g., directly) to a second surface 14 of a glass sheet 10. Additionally or alternatively, the bead 50 can be in contact with and bonded to an edge 26 of an aerogel sheet 20. Furthermore, in one group of embodiments, the bead 50 is also in contact with and preferably bonded to a wall of a spacer. More will be said of this later.

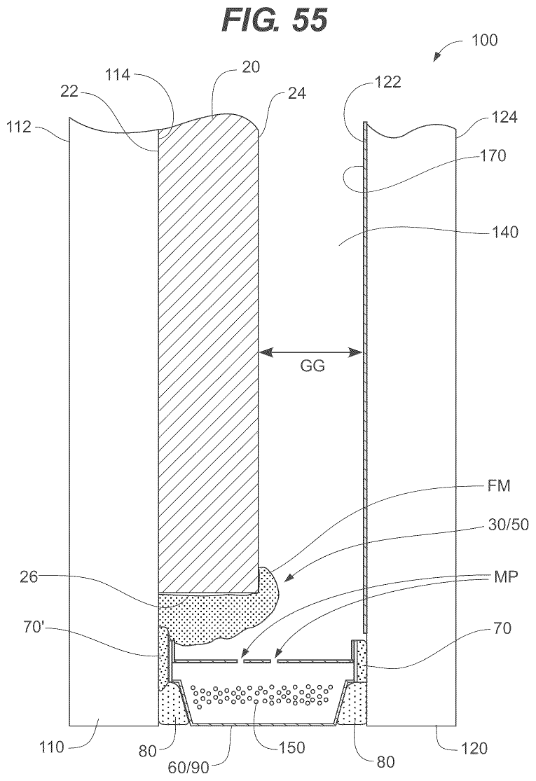

In various embodiments, the bead 50 is in contact with and preferably bonded to each of the edge 26 of the aerogel sheet 20 and a portion of a second face 24 of the aerogel sheet 20. In certain cases, the bead 50 is in contact with and preferably bonded to each of the second surface 14 of the glass sheet 10, the edge 26 of the aerogel sheet 20, and a portion of a second face 24 of the aerogel sheet 20. In some cases, the bead 50 is in contact with and preferably bonded to each of a wall of a spacer 60, the edge 26 of the aerogel sheet 20, and optionally the second face 24 of the aerogel sheet. In certain cases, the bead 50 is in contact with and preferably bonded to each of a wall of a spacer 60, the second surface 14 of the glass sheet 10, the edge 26 of the aerogel sheet 20, and optionally the second face 24 of the aerogel sheet. If desired, the bead 50 can also be in contact with spacer sealant 70 that is located between the spacer and the glass sheet. Reference is made to the non-limiting example of FIG. 55. The bead can optionally be formed of an encapsulation material comprising an organic material. In some cases, the organic material comprises PETG.

The encapsulation material encapsulates an edge 26 of the aerogel sheet 20 along at least a portion of the outer perimeter. In some cases, the encapsulation material encapsulates the edge 26 only along certain segments of the outer perimeter. For example, the encapsulation material may encapsulate the edge 26 only along corners of the outer perimeter. In other cases, the encapsulation material encapsulates the edge 26 along an entirety of the outer perimeter.

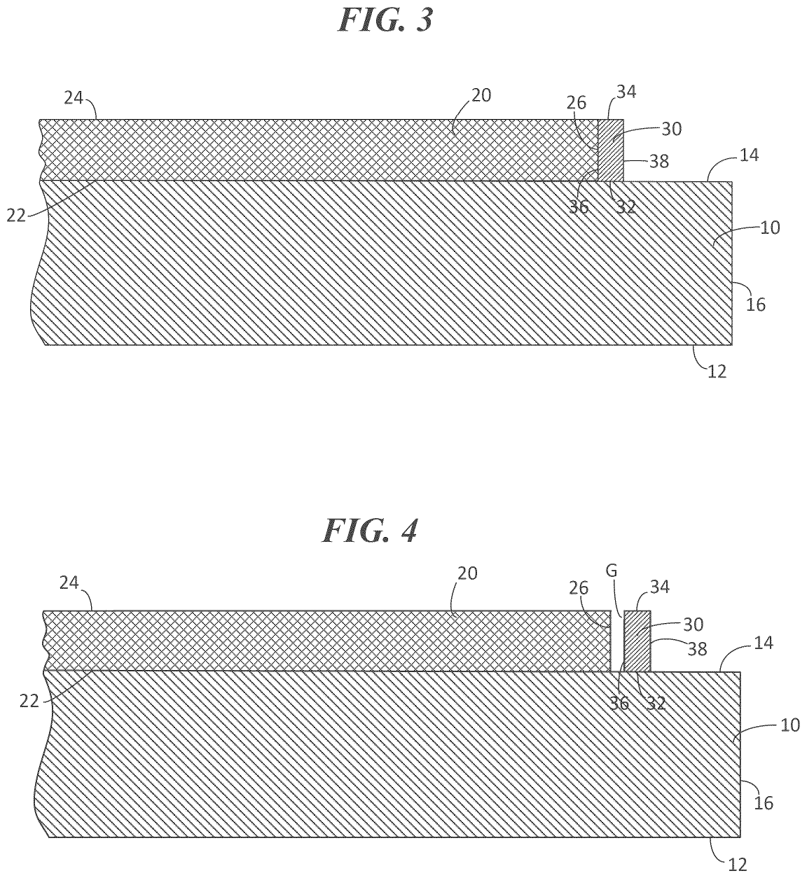

FIGS. 3-14 illustrate different ways an encapsulation material may be configured relative to an edge 26 of an aerogel sheet 20 in mounting the aerogel sheet 20 alongside a glass sheet 10.

FIG. 3 illustrates an encapsulation material defining a wall 30 that encapsulates an edge 26 of an aerogel sheet 20. The wall 30 in this embodiment is provided alone without any other encapsulation structure. The wall 30 includes a bottom surface 32, a top surface 34, an inner side surface 36 and an outer side surface 38. The bottom surface 32 is in contact with and preferably bonded (for example, directly) to the second surface 14 of the glass sheet 10, and the top surface 34 is exposed. Similarly, the inner side surface 36 is in contact with and preferably to bonded to the edge 26, and the outer side surface 38 is exposed. The wall 30 is shown having a rectangular profile with the bottom surface 32, top surface 34, inner side surface 36 and outer side surface 38 being linear. However, the wall 30 need not have a rectangular profile and any of these surfaces can instead be angled or curved. The illustrated wall 30 is spaced inwardly from an edge 16 of the glass sheet 10.

The wall 30 encapsulates the edge 26 of the aerogel sheet 20. The illustrated aerogel sheet 20 has a thickness and the edge 26 has a height that correlates generally to (e.g., substantially matches) the thickness of the illustrated wall 30. In many cases, the edge 26 has a thickness (and therefore a height) of between 1.5 mm and 15 mm, such between 2 mm and 8 mm, or between 2 mm and 4 mm. In certain cases, the edge 26 has a height of 3 mm. The illustrated wall 30 has a height that extends from the bottom surface 32 to the top surface 34. In FIG. 3, the wall 30 has a height that is the substantially the same as the height of the edge 26 of the aerogel sheet 20. For example, if the edge 26 has a height of 3 mm, the wall can also have a height of about 3 mm. However, in other embodiments the wall height is greater than or less than the height of the edge 26. In some cases, the edge 26 has a height of 3 mm and the wall has a height of 4 mm.

The wall 30 of FIG. 3 is in contact with the edge 26 of the aerogel sheet 20 and therefore is formed of an encapsulation material that does not degrade the aerogel sheet 20. In some cases, the wall 30 is formed of any encapsulation material that does not degrade or crack the aerogel sheet 20. For example, the encapsulation material can be a material that is chemically compatible with the aerogel sheet 20. In certain cases, the aerogel sheet 20 is a silica aerogel sheet and the encapsulation material is chemically compatible with silane functional groups on the sheet. Also, the encapsulation material can be a material that is physically compatible with the aerogel sheet 20. Further, the wall 30 can result from depositing a heated encapsulation material that is compatible with a thermal expansion coefficient of the aerogel sheet. In such cases, the heated encapsulation material cools and preferably cures to form a wall without cracking the aerogel sheet.

In some cases, the wall 30 comprises an organic material. The organic material can, for example, comprise PETG. In certain cases, the wall 30 is formed by depositing heated PETG in any manner that makes the heated PETG compatible with the thermal expansion coefficient of the aerogel sheet. In certain examples, the wall 30 is formed by depositing heated PETG such that it contacts the edge 26 at temperature in the range of from 120° C. to 195° C., such as from 123° C. to 194° C. Additionally or alternatively, the wall 30 can be formed by depositing heated PETG from a nozzle that is spaced from the deposition point along the edge 26 by a gap distance. In certain cases, the wall 30 is formed by dispensing heated PETG from a nozzle at a temperature in the range of from 185° C. to 250° C., such as from 200° C. to 250° C., or perhaps optimally 245-255° C., and with the nozzle being spaced from the deposition point along the edge 26 by a gap distance in the range of from 1 mm to 6 mm, such as from 1 mm to 4 mm, or from greater than 4 mm to 6 mm, such as from 4.2 mm to 5.6 mm.

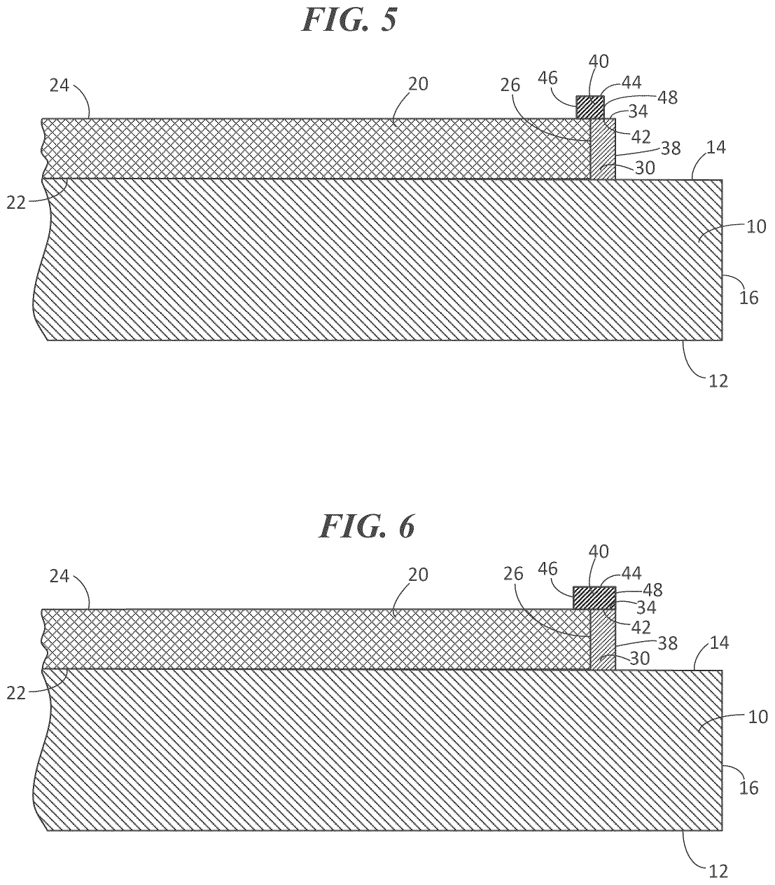

FIG. 4 illustrates an encapsulation material defining a wall 30 that is spaced from an edge 26 of an aerogel sheet 20. The wall 30 of FIG. 4 can have any of the structural features described for the wall 30 of FIG. 3 except that a gap G is present between the edge 26 of the aerogel sheet 20 and the wall 30. In this embodiment, the inner side surface 36 of the wall is not in contact with the edge 26 of the aerogel sheet 20 because the gap G spaces the inner side surface 36 from the edge 26. Thus, the wall 30 abuts, but does not contact (at least not when initially deposited), the edge 26 of the aerogel sheet 20. The wall 30 in this embodiment may function as a support or containment structure that prevents the aerogel sheet 20 from potentially sliding too far along the glass sheet 10.

Since the wall 30 in FIG. 4 is not in contact with the aerogel sheet 20, it can be formed of any suitable material that bonds to the glass sheet 10. In some cases, the wall 30 includes a preformed wall. In other cases, the wall 30 is formed by depositing an organic material to form a wall. In certain cases, the wall 30 is formed by depositing heated PETG to form a wall. Since the wall 30 does not contact the edge 26 (at least not initially), the heated PETG can be deposited in any known fashion to form the wall 30. For example, the wall 30 can be formed by depositing heated PETG from a nozzle at any (or no) gap distance and at any suitable temperature.

FIG. 5 illustrates an encapsulation material defining both a wall 30 and a bridge 40 that encapsulate an edge 26 of an aerogel sheet 20. The wall 30 of FIG. 5 is in contact with the edge 26 of the aerogel sheet 20, like the wall 30 of FIG. 3. Thus, the wall 30 of FIG. 5 can have any features described herein for the wall 30 of FIG. 3.

The optional bridge 40 connects the wall 30 to a portion of the second face 24 of the aerogel sheet 20. The bridge 40 includes a bottom surface 42, a top surface 44, an inner side surface 46 and an outer side surface 48. The bridge 40 is in contact with and preferably bonded to both the wall 30 and the second face 24 of the aerogel sheet 20. For example, the bridge 40 has a bottom surface 42 that is in contact with and preferably bonded to both the top surface 34 of the wall 30 and the second face 24 of the aerogel sheet 20.

In the embodiment of FIG. 5, the bottom surface 42 contacts only a portion of the top surface 34 of the wall 30. For example, the outer side surface 48 of the illustrated bridge 40 is positioned inward of the outer side surface 38 of the wall 30, for example, such that the bottom surface of the bridge contacts only a portion of the top surface 34. The top surface 44, inner side surface 46 and outer side surface 48 of the illustrated bridge are exposed.

The bridge 40 is shown having a defined rectangular profile with the bottom surface 42, top surface 44, inner side surface 46 and outer side surface 48 being straight. However, the bridge 40 need not have a strictly rectangular profile and any of these surfaces can instead be angled or curved.

The illustrated bridge 40 is in contact with the second face 24 of the aerogel sheet 20 and therefore is formed of an encapsulation material that does not degrade or crack the aerogel sheet 20. The bridge 40 can be formed of any encapsulation material described herein that does not degrade or crack the aerogel sheet 20. For example, the encapsulation material can be a material that is chemically compatible with the aerogel sheet 20. In certain cases, the aerogel sheet 20 is a silica aerogel sheet and the encapsulation material is chemically compatible with silane functional groups on the sheet. Preferably, the encapsulation material is also physically compatible with the aerogel sheet 20. Further, the bridge 40 can result from dispensing a heated encapsulation material that is compatible with a thermal expansion coefficient of the aerogel sheet. In such cases, the heated encapsulation material preferably cools and cures to form a bridge without cracking the aerogel sheet.

In some cases, the bridge 40 comprises an organic material, such as PETG. In certain cases, the bridge 40 is formed by depositing heated PETG in any manner that makes the heated PETG compatible with the thermal expansion coefficient of the aerogel sheet 20. In some examples, the bridge 40 is formed by depositing heated PETG such that it contacts the second face 24 at temperature in the range of from 120° C. to 195° C., such as from 123° C. to 194° C. Additionally or alternatively, the bridge 40 can optionally be formed by depositing heated PETG from a nozzle that is spaced from the second face 24 by a gap distance. In certain cases, the bridge 40 is formed by dispensing heated PETG from a nozzle at a nozzle temperature in the range of from 185° C. to 250° C., such as from 200° C. to 250° C., or perhaps optimally 245-255° C., and with the nozzle being spaced from the second face 24 by a gap distance in the range of from 1 mm to 6 mm, such as from 1 mm to 4 mm, or from greater than 4 mm to 6 mm, such as from 4.2 mm to 5.6 mm.

FIG. 6 illustrates an encapsulation material defining both a wall 30 and a bridge 40 that encapsulate an edge 26 of an aerogel sheet 20. The wall 30 of FIG. 6 is in contact with the edge 26 of the aerogel sheet 20, like the wall 30 of FIG. 3 and FIG. 5. Thus, the wall 30 of FIG. 6 can have any of the features described herein for the wall 30 of FIG. 3 or FIG. 5. The bridge 40 of FIG. 6 is in contact with both the wall 30 and the second face 24 of the aerogel sheet 20, similar to the bridge 40 of FIG. 5. However, in FIG. 6, the bottom surface 42 of the bridge 40 contacts an entirety of the top surface 34 of the wall 30. Here, the outer side surface 48 of the bridge 40 is generally flush with the outer side surface 38 of the wall 30. Thus, the bridge 40 of FIG. 6 can have any of the features described herein for the bridge 40 of FIG. 5 with the exception of the bridge 40 contacting the entire top surface 34 of the wall 30.

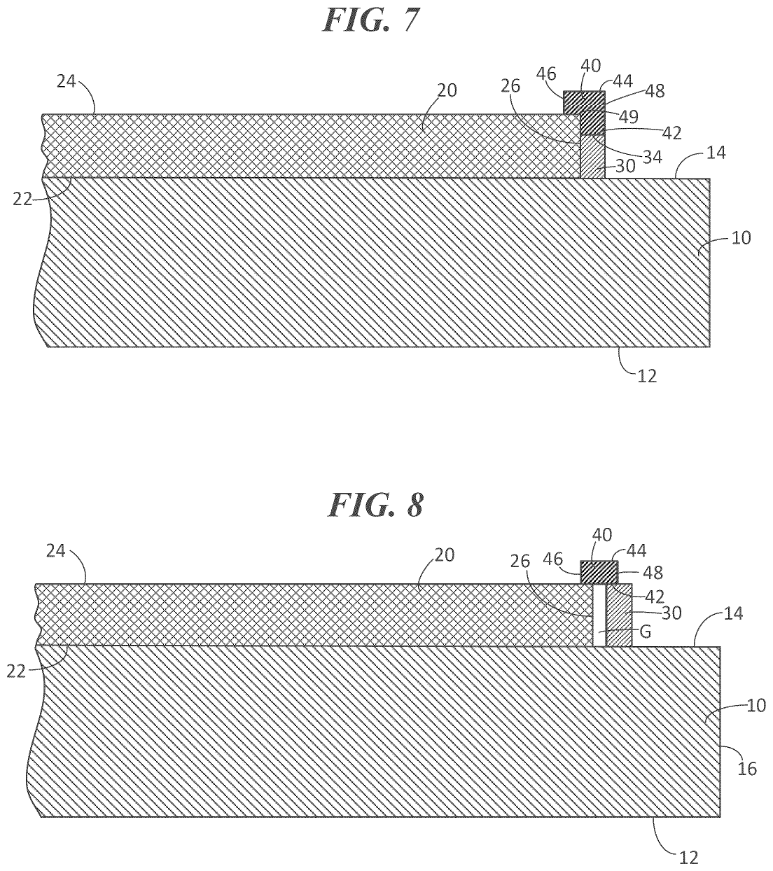

FIG. 7 illustrates an encapsulation material defining both a wall 30 and a bridge 40 that encapsulate an edge 26 of an aerogel sheet 20. The wall 30 of FIG. 7 is in contact with the edge 26 of the aerogel sheet 20, like the wall 30 of FIGS. 3 and 5-6. However, the wall 30 of FIG. 7 has a height that is less than the height of the edge 26 of the aerogel sheet 20. Thus, the illustrated top surface 34 is lower than the second face 24 of the aerogel sheet 20. The wall of FIG. 7 can include any features described herein for the wall 30 of FIGS. 3 and 5-6, except that the wall 30 has a height that is less than the height of the edge 26 of the aerogel sheet 20.

The bridge 40 in the embodiment of FIG. 7 includes an inside corner 49 that contacts both a top surface 24 and an edge 26 of the aerogel sheet 20. The inside corner 49 is formed between the inner side surface 46 and the bottom surface 42 of the bridge 40. The bottom surface 42 of the bridge 40 is shown covering an entire top surface 34 but can instead cover only a portion of the top surface 34. Further, the top surface 44, inner side surface 46 and outer side surface 48 of the bridge 40 are exposed.

The bridge 40 of FIG. 7 contacts both the second face 24 and the edge 26 of the aerogel sheet 20 and therefore is formed of an encapsulation material that does not degrade or crack the aerogel sheet 20. Thus, the bridge 40 can be formed of any encapsulation material described herein that does not degrade or crack the aerogel sheet 20. In preferred cases, the bridge 40 is formed by depositing heated PETG in any manner that makes the heated PETG compatible with the thermal expansion coefficient of the aerogel sheet 20.

FIG. 8 illustrates yet another embodiment of an encapsulation material 10 defining both a wall 30 and a bridge 40 that encapsulate an edge 26 of an aerogel sheet 20. The wall 30 of FIG. 8 is similar to the wall 30 of FIG. 4 in that a gap G is present between the edge 26 of the aerogel sheet 20 and the wall 30. Thus, the wall 30 of FIG. 8 can have any features described herein for the wall 30 of FIG. 4. The bridge 40 of FIG. 8, however, extends over the gap G. Thus, the bridge 40 of FIG. 8 can have any features described herein for the bridge 40 of FIG. 5, but with the bridge 40 extending over the gap G. The bottom surface 42 of the bridge 40 therefore contacts a portion of the top surface 34 of the wall 30, covers the gap G, and also contacts a portion of the second face 24 of the aerogel sheet 20.

FIG. 9 illustrates another embodiment of an encapsulation material defining both a wall 30 and a bridge 40 that encapsulate an edge 26 of an aerogel sheet 20. The wall 30 of FIG. 9 is similar to the wall 30 of FIGS. 4 and 8 in that a gap G is present between the edge 26 of the aerogel sheet 20 and the wall 30. Thus, the wall 30 of FIG. 9 can have any of the features described herein for the wall 30 of FIGS. 4 and 8. Here, the bridge 40 is similar to the bridge 40 of FIG. 6 in that the bottom surface 42 contacts an entirety of the top surface 34 of the wall 30. In addition, this bridge 40 is similar to the bridge 40 of FIG. 8 in that it extends over a gap G between the edge 26 of the aerogel sheet 20 and the wall 30. The bottom surface 42 of this illustrated bridge 40 contacts an entirety of the top surface 34 of the wall 30, covers the gap G, and also contacts a portion of the second face 24 of the aerogel sheet 20. Thus, the bridge 40 is in contact with a portion of the second face 24 of the aerogel sheet 20 and therefore comprises an encapsulation material that does not degrade or crack it. In preferred cases, the bridge 40 is formed by depositing heated PETG in any manner that makes the heated PETG compatible with the thermal expansion coefficient of the aerogel sheet.

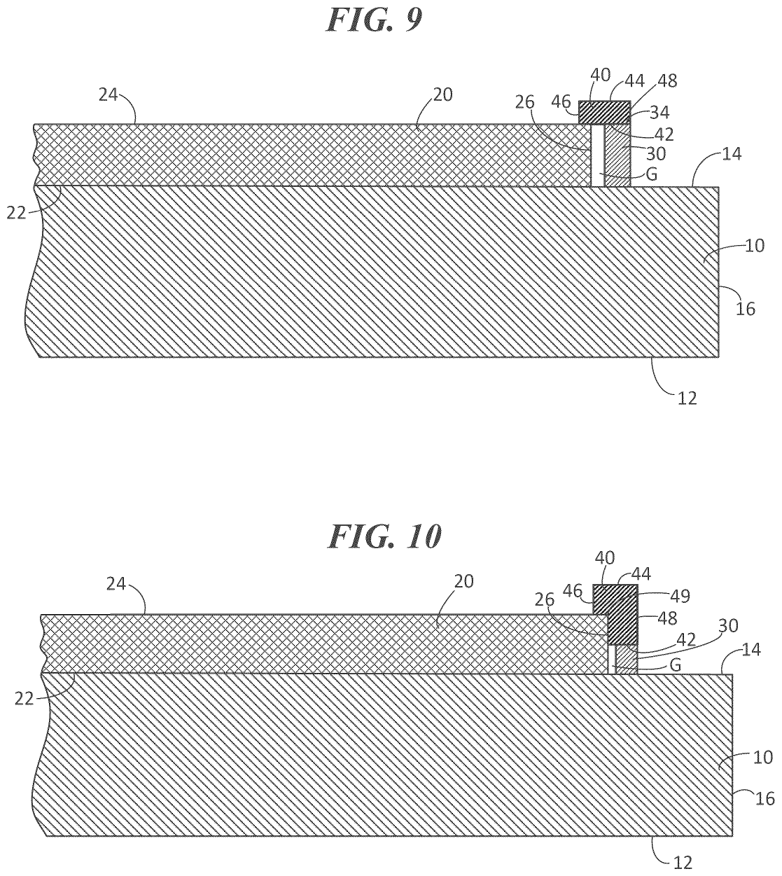

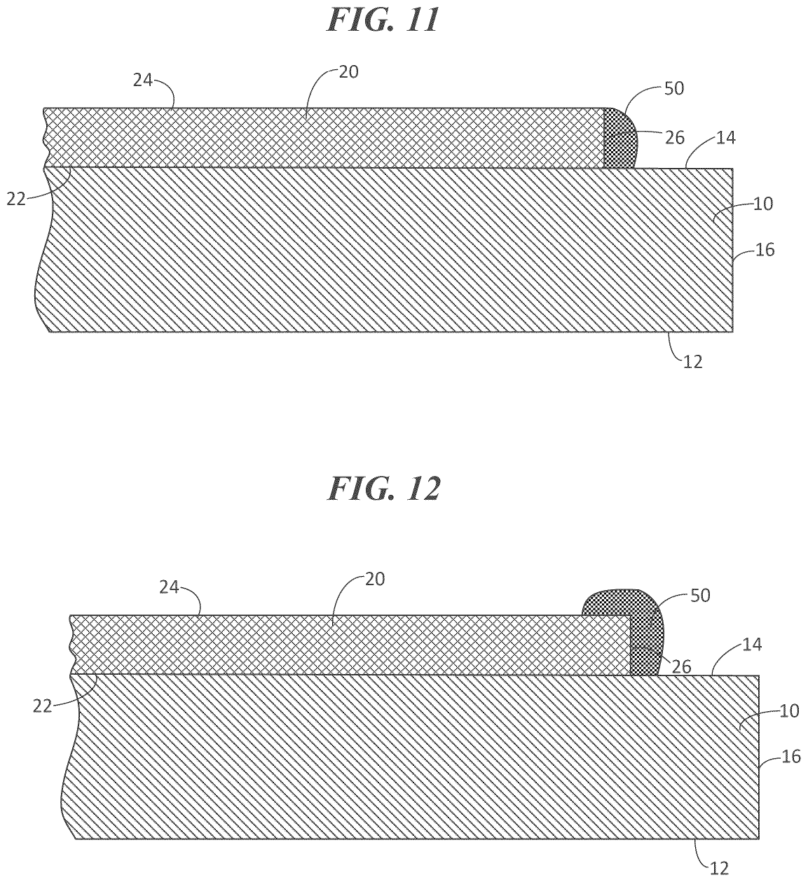

FIG. 10 illustrates another embodiment of an encapsulation material defining both a wall 30 and a bridge 40 that encapsulate an edge 26 of an aerogel sheet 20. Here, the wall 30 is similar to the wall 30 of FIG. 7 in that it has a height that is less than the height of the edge 26 of the aerogel sheet 20, but a gap G is present between the edge 26 of the aerogel sheet 20 and the wall 30. Since a gap G is present and the wall 30 does not contact the aerogel sheet 20, the wall 30 can be formed of any suitable material that bonds to the second surface 14 of the glass sheet 10. In certain cases, the wall 30 is formed by depositing heated PETG in any known fashion to form the wall 30. For example, the wall 30 can be formed by depositing heated PETG from a nozzle at any (or no) gap distance and at any temperature. In FIG. 10, the bridge 40 includes an inside corner 49, similar to the bridge 40 of FIG. 7, except that the bridge 40 of FIG. 10 extends over a gap G. The bridge 40 of FIG. 10 can therefore include any features described herein for the bridge 40 of FIG. 7 but it extends over the gap G. The bottom surface 42 of the bridge 40 is shown covering an entire top surface 34 but can instead cover only a portion of the top surface 34.

FIG. 11 illustrates an embodiment of an encapsulation material defining a bead (or glob) 50 that encapsulates an edge 26 of an aerogel sheet 20. The bead 50 shown in FIG. 11 contacts, and preferably bonds to, the aerogel sheet 20 only at its edge 26, i.e., so as not to contact the second face 24. Since the bead 50 contacts the edge 26 of the aerogel sheet 20, it is formed of an encapsulation material that does not degrade or crack the aerogel sheet 20. In some cases, the bead 50 is formed by depositing heated PETG in any manner that makes the heated PETG compatible with the thermal expansion coefficient of the aerogel sheet.

FIG. 12 illustrates another embodiment of an encapsulation material defining a bead 50 that encapsulates an edge 26 of an aerogel sheet 20. The bead 50 in FIG. 12 contacts, and preferably bonds to, both the edge 26 and second face 24 of the aerogel sheet. Here too, the bead 50 is formed of an encapsulation material that does not degrade or crack the aerogel sheet 20, such as heated PETG deposited in any manner that makes it compatible with the thermal expansion coefficient of the aerogel sheet.

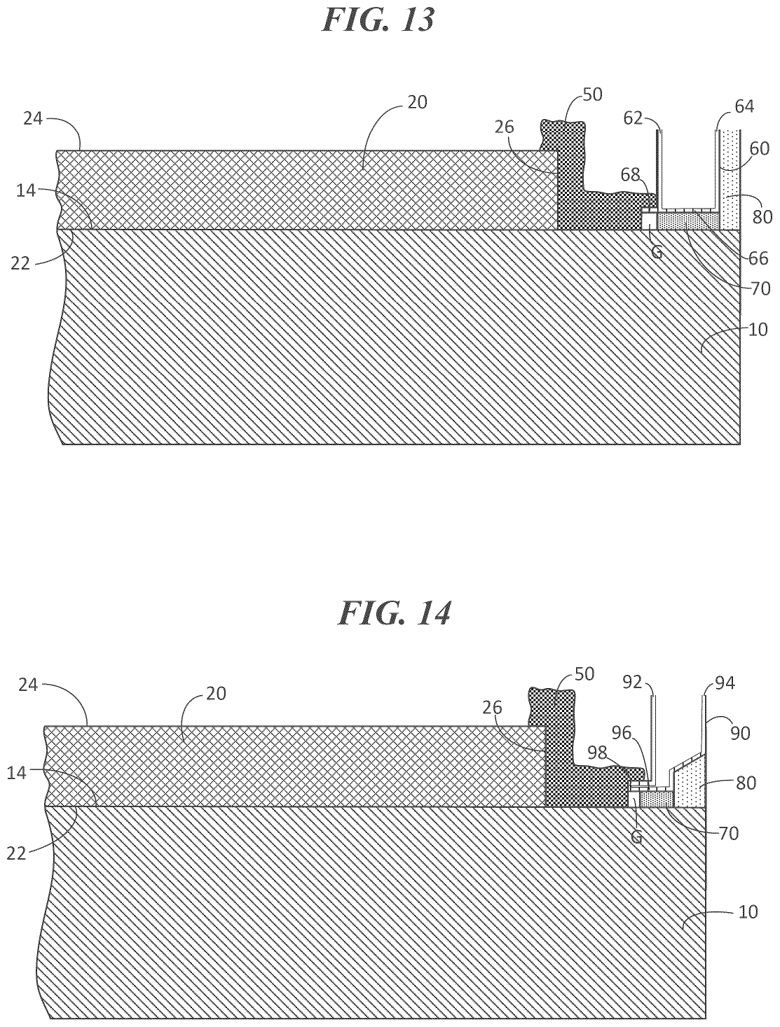

FIG. 13 illustrates an embodiment of an encapsulation material defining a bead (or glob) 50 that contacts a wall of a spacer 60 and encapsulates an edge 26 of an aerogel sheet 20. The spacer 60 includes a plurality of walls. In FIG. 13, the illustrated spacer 60 includes an inner wall 62, an outer wall 64 and two sidewalls 66. One or more deposits (e.g., beads) of spacer sealant are provided along the spacer walls. In some cases, a primary sealant 70 is provided between a sidewall 66 and a second surface 14 of the glass sheet 10 and a secondary sealant 80 is provided along the outer wall 64. Another option is to omit the secondary sealant 80 and provide a single deposit of primary sealant 70 along both sides of the spacer and on the outside wall of the spacer. In some cases, the primary sealant 70 comprises polyisobutylene (“PIB”) and the secondary sealant 80 comprises silicone. Other conventional single seal systems or double seal systems can alternatively be used.

In FIG. 13, the illustrated bead 50 contacts and preferably bonds to a wall of the spacer 60. Here, the illustrated bead 50 does not contact spacer sealant 70. For example, the bead 50 can be provided along a spacer wall such that a gap G separates the bead 50 from any spacer sealant. In other embodiments, the bead 50 also contacts spacer sealant 70 (see the non-limiting example of FIG. 55). In certain cases, the spacer 60 includes an extension (or projection) 68, which for example may be an extension (or projection) of a sidewall 66. The illustrated extension 68 is a portion of the sidewall 66 that extends past the inner wall 62 and towards the aerogel sheet 20. In such cases, the bead 50 contacts and preferably bonds to the extension 68 of the spacer 60. In certain cases, the bead 50 can also contact and preferably bonds to the inner wall 62.

The bead 50 also contacts, and preferably bonds to, the edge 26 and/or the second face 24 of the aerogel sheet. Furthermore, the illustrated bead contacts, and preferably bonds to, the second surface 14 of the glass sheet 10. Thus, the illustrated bead 50 contacts and preferably bonds to the extension 68 of the spacer 60, the second surface 14 of the glass sheet 10, the edge 26 of the aerogel sheet 20 and/or the second face 24 of the aerogel sheet 20. Since the bead 50 contacts the aerogel sheet 20, the bead is formed of an encapsulation material that does not degrade or crack the aerogel sheet 20. In some cases, the bead 50 is formed by depositing heated PETG in any manner that makes the heated PETG compatible with the thermal expansion coefficient of the aerogel sheet.

FIG. 14 illustrates an encapsulation material defining a bead (or glob) 50 that contacts a wall of another type of spacer 90 and encapsulates an edge 26 of an aerogel sheet 20. The spacer 90 in FIG. 14 has a different configuration than the spacer 60 of FIG. 13. In some cases, the spacer 90 is in accordance with any embodiment described in U.S. Pat. No. 8,789,343, entitled “Glazing Unit Spacer Technology,” the entire contents of which are incorporated herein by reference. The spacer 90 generally includes an inner wall 92, an outer wall 94 and sidewalls 96. The sidewall 96 is bent to be shaped as an “ear” having a tip 98. Here too, one or more beads of spacer sealant are provided along the spacer walls. For example, a primary sealant 70 can be provided between a sidewall 96 and a second surface 14 of the glass sheet 10, and a secondary sealant 80 can be provided along one or more walls between the side wall 98 and the outer wall 94. In some cases, the primary sealant 70 comprises polyisobutylene (“PIB”) and the secondary sealant 80 comprises silicone. However, any desired single seal system or double seal system can be used.

With continued reference to FIG. 14, the bead 50 contacts a wall of the spacer 90, and in this figure the bead does not contact spacer sealant. In other embodiments, the bead 50 also contacts spacer sealant 70 (see the non-limiting example of FIG. 55). In some cases, the bead 50 contacts, and preferably bonds to, a side wall 96 and/or tip (or ear) 98 of the spacer. In certain cases, the bead 50 also contacts, and preferably bonds to, the inner wall 92. In FIG. 14, the bead 50 contacts, and preferably bonds, to the tip (or ear) 98, the second surface 14 of the glass sheet 10, the edge 26 of the aerogel sheet 20, and the second face 24 of the aerogel sheet 20. The bead 50 of FIG. 14 can be formed of any suitable encapsulation material.

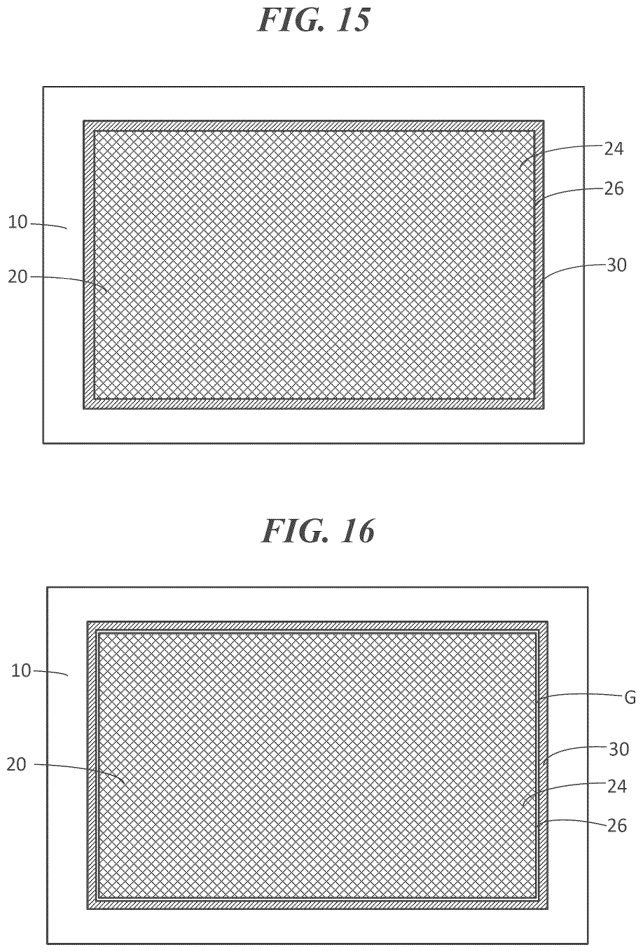

FIGS. 15-39 illustrate different perimeter arrangements of encapsulation material relative to the edge 26 of an aerogel sheet 20. Generally, the encapsulation material abuts and/or contacts the edge 26 along at least a portion of the outer perimeter. In some cases, the encapsulation material abuts and/or contacts the edge 26 along an entirety of the outer perimeter. Various perimeter arrangements will now be described.

FIG. 15 illustrates a wall 30 that encapsulates an edge 26 of an aerogel sheet 20 along an entirety of the aerogel sheet's outer perimeter. The wall 30 is provided alone without any other encapsulation structure. The wall 30 contacts and preferably bonds to the edge 26 along an entirety of the outer perimeter.

FIG. 16 illustrates a wall 30 that surrounds an edge 26 of an aerogel sheet 20 along an entirety of the aerogel sheet's outer perimeter. Here too, the wall 30 is provided alone without any other encapsulation structure. Here, though, the wall 30 is spaced from the edge 26 by a gap G. The wall 30 therefore surrounds and abuts the edge 26 along an entirety of an outer perimeter of the aerogel sheet 20.

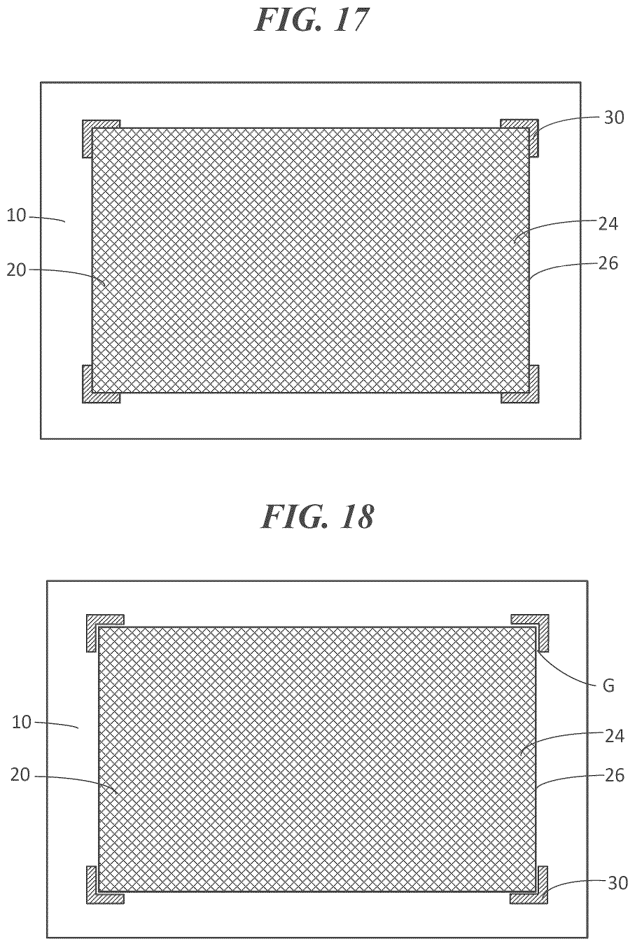

FIG. 17 illustrates a wall 30 that encapsulates an edge 26 of an aerogel sheet 20 along only a portion of the aerogel sheet's outer perimeter. The wall 30 in FIG. 17 is also provided alone without any other encapsulation structure. In this embodiment, the wall 30 contacts and preferably bonds to the edge 26 of the aerogel sheet 20 along only the corners. The remaining edge 26 that is not in contact with the wall 30 is exposed.

FIG. 18 illustrates a wall 30 that surrounds an edge 26 of an aerogel sheet 20 along a portion of the aerogel sheet's outer perimeter. The wall 30 in this embodiment abuts the edge 26 of the aerogel sheet 20 along only the corners. A gap G is present between the edge 26 of the aerogel sheet 20 and the wall 30. The remaining edge 26 that is not abutted by the wall 30 is exposed.

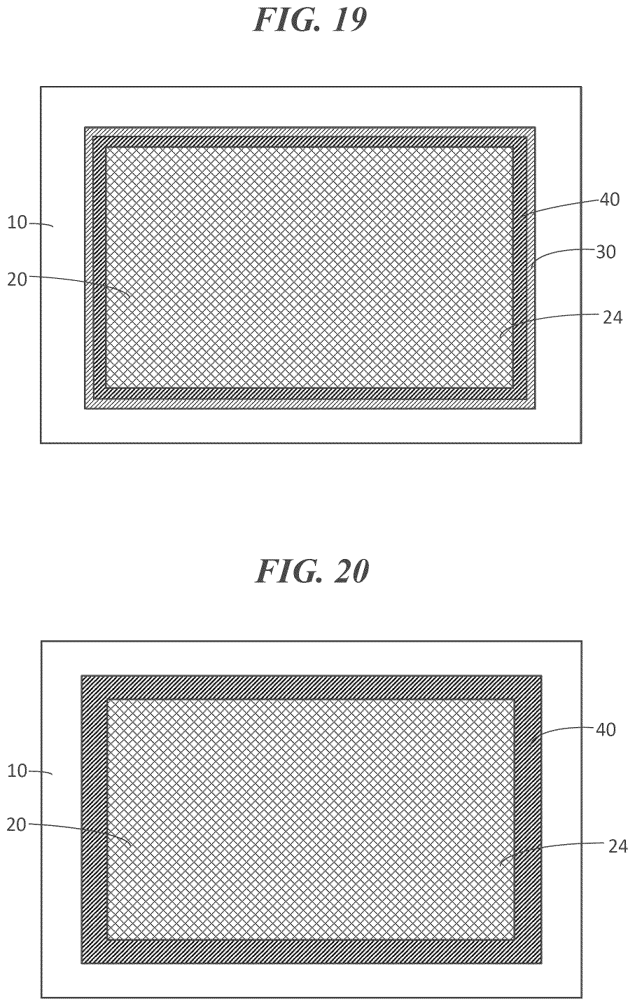

FIG. 19 illustrates a wall 30 and a bridge 40 that encapsulate an edge 26 of an aerogel sheet along an entirety of the aerogel sheet's outer perimeter. The wall 30 surrounds the edge 26 along an entirety of the outer perimeter of the aerogel sheet 20. Since FIG. 19 is a top view that shows a bridge 40 covering the wall 30, it cannot be seen whether the underlying wall 30 contacts the edge 26 or is spaced from the edge 26 by a gap G. Both are options, and FIG. 19 therefore encompasses either embodiment. In some cases, the underlying wall 30 contacts and preferably bonds to the edge 26. In other cases, the underlying wall 30 is spaced by a gap G from the edge 26.

With continued reference to FIG. 19, the bridge 40 contacts and preferably bonds to a portion of the second face 24 of the aerogel sheet 20 along an entirety of an outer perimeter. The bridge 40 bridges the wall 30 to a portion of the second face 24 of the aerogel sheet 20. In FIG. 19, the bridge 40 is shown covering only a portion of the top surface 34 of the wall 30. Thus, the outer side surface 48 of the bridge 40 is positioned inward of the outer side surface 38 of the wall 30.

FIG. 20 illustrates a bridge 40 that encapsulates an edge 26 of an aerogel sheet 20 along an entirety of the aerogel sheet's outer perimeter. The bridge 40 contacts and preferably bonds to a portion of the second face 24 of the aerogel sheet 20 along an entirety of an outer perimeter of the aerogel sheet 20. For example, the bridge 40 bridges an underlying wall (not shown) to a portion of the second face 24 of the aerogel sheet 20 along an entirety of an outer perimeter.

The underlying wall is not visible from this top view of FIG. 20, but it can be in accordance with any wall embodiment described herein. In some cases, the underlying wall surrounds the edge 26 along an entirety of the outer perimeter, and in other cases it surrounds the edge 26 along only a portion of the outer perimeter. Also, in some cases, the underlying wall contacts and preferably bonds to the edge 26, whereas in other cases the wall is spaced by a gap G from the edge 26.

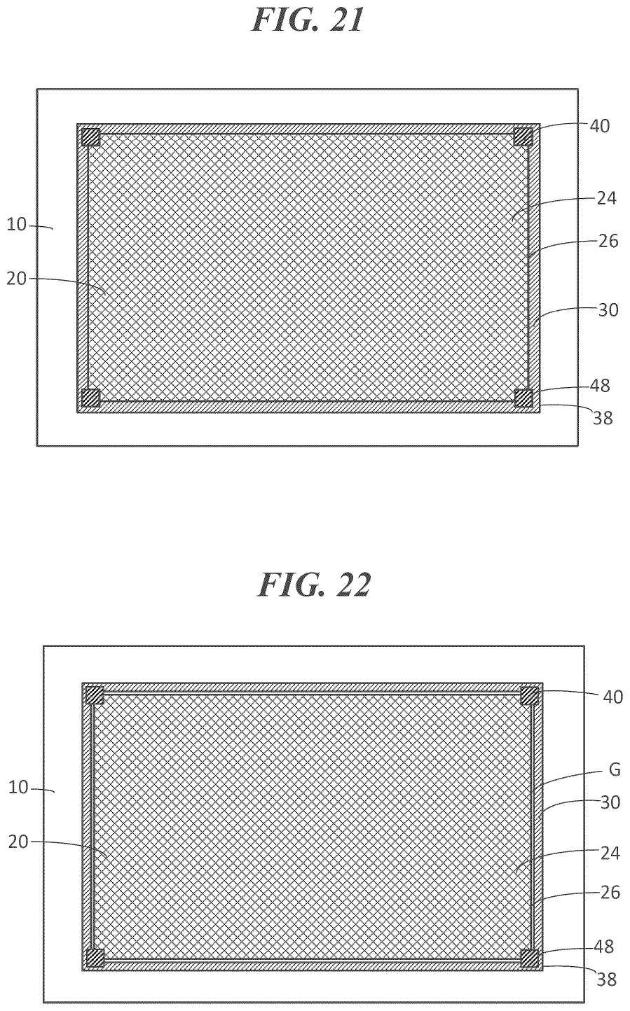

FIG. 21 illustrates a wall 30 and a bridge 40 that encapsulate an edge 26 of an aerogel sheet 20 along an entirety of the aerogel sheet's outer perimeter. The wall 30 contacts and preferably bonds to the edge 26 along an entirety of the outer perimeter of the aerogel sheet 20. The bridge 40, however, is provided along only a portion of the outer perimeter, namely along the corners. The bridge 40 contacts and preferably bonds to the corners of the second face 24 of the aerogel sheet 20. Also, the bridge 40 contacts and preferably bonds to only a portion of the top surface 34 of the wall 30. Thus, the outer side surface 48 of the illustrated bridge 40 is positioned inward of the outer side surface 38 of the wall 30.

FIG. 22 illustrates a wall 30 and a bridge 40 that encapsulate an edge 26 of an aerogel sheet 20 along a portion of the aerogel sheet's outer perimeter. The wall 30 surrounds the edge 26 along an entirety of the outer perimeter of the aerogel sheet 20. A gap G is present between the wall 30 and the edge 26 along the entire outer perimeter. The bridge 40 is provided along only the corners of the outer perimeter. The bridge 40 contacts and preferably bonds to the corners of the second face 24 of the aerogel sheet 20. Here too, the bridge 40 contacts and preferably bonds to only a portion of the top surface 34 of the wall 30, such that the outer side surface 48 of the bridge 40 is positioned inward of the outer side surface 38 of the wall 30. Here, the bridge 40 contacts a portion of the top surface 34, extends over the gap G, and contacts the corners of the second face 24 of the aerogel sheet 20.

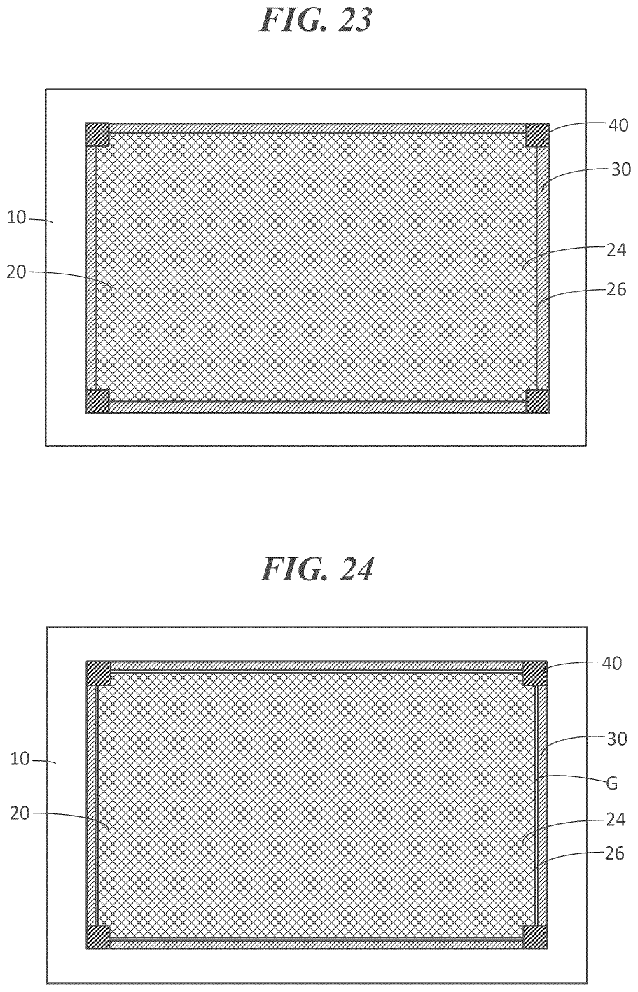

FIG. 23 illustrates a wall 30 and a bridge 40 that encapsulate an edge 26 of an aerogel sheet 20 along an entirety of the aerogel sheet's outer perimeter. The wall 30 contacts and preferably bonds to the edge 26 along an entirety of an outer perimeter, and the bridge 40 contacts and preferably bonds to a portion of the second face 24 at the corners.

FIG. 24 illustrates a wall 30 and a bridge 40 that encapsulate an edge 26 of an aerogel sheet 20 along a portion of the aerogel sheet's outer perimeter. The wall 30 surrounds the edge 26 along an entirety of an outer perimeter of the aerogel sheet 20 and is spaced from the edge 26 by a gap G. The bridge 40 contacts and preferably bonds to a portion of the second face 24 at the corners. The bridge 40 contacts an entirety of the top surface 34 of the wall 30, extends over the gap G and contacts the corners of the second face 24 of the aerogel sheet 20.

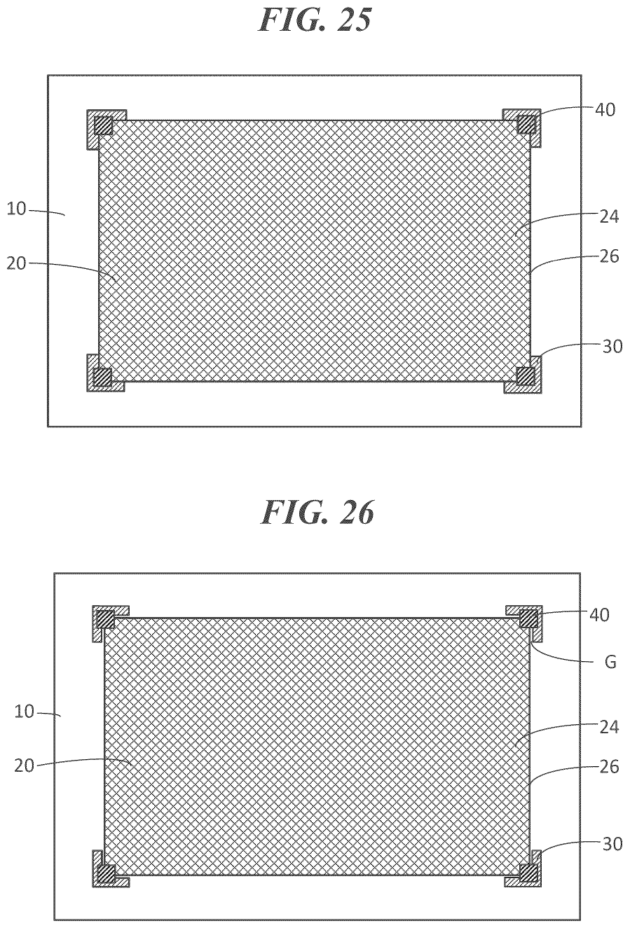

FIG. 25 illustrates a wall 30 and a bridge 40 that encapsulate an edge 26 of an aerogel sheet 20 along a portion of the aerogel sheet's outer perimeter. The wall 30 contacts and preferably bonds to the edge 26 of the aerogel sheet 20 at the corners. The bridge 40 also contacts and preferably bonds to the second face 24 of the aerogel sheet at the corners. Further, the bridge 40 contacts and preferably bonds to corner regions of the top surface 34 of the wall 30.

FIG. 26 illustrates a wall 30 and a bridge 40 that encapsulate an edge 26 of an aerogel sheet 20 along a portion of the aerogel sheet's outer perimeter. The wall 30 abuts the edge 26 along the corners of the outer perimeter of the aerogel sheet 20 and is spaced from the edge 26 by a gap G. The bridge 40 contacts and preferably bonds to the second face 24 of the aerogel sheet at the corners. The bridge 40 also contacts and preferably bonds to corner regions of the top surface 34 of the wall 30.

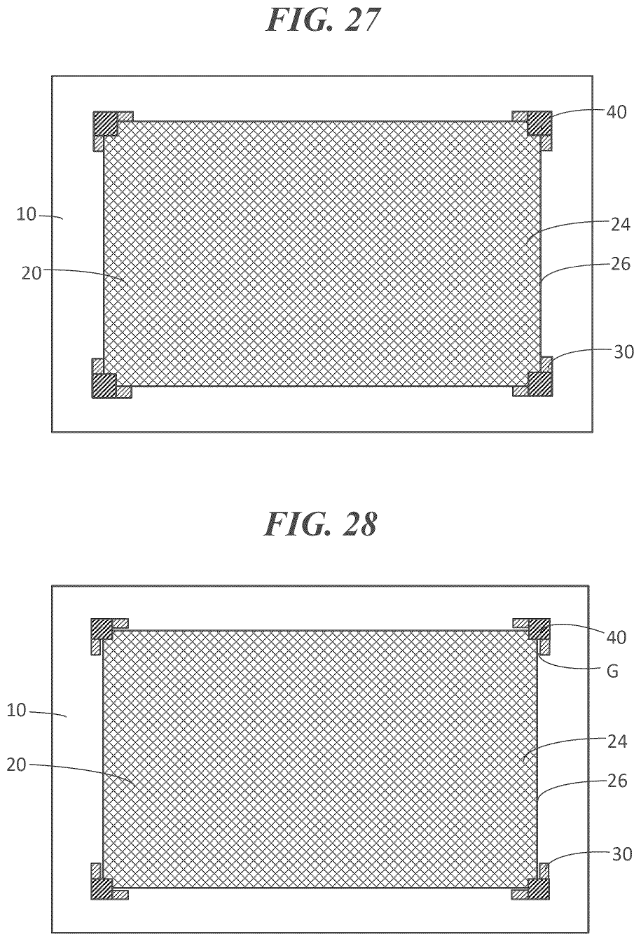

FIG. 27 illustrates a wall 30 and a bridge 40 that encapsulate an edge 26 of an aerogel sheet 20 along a portion of the aerogel sheet's outer perimeter. The wall 30 contacts and preferably bonds to the edge 26 of the aerogel sheet 20 at the corners. Also, the bridge 40 contacts and preferably bonds to the second face 24 of the aerogel sheet 20 at the corners. In addition, the bridge 40 in FIG. 27 contacts corner regions of the top surface 34 of the wall 30.

FIG. 28 illustrates a wall 30 and a bridge 40 that encapsulate an edge 26 of an aerogel sheet 20 along a portion of the aerogel sheet's outer perimeter. The wall 30 abuts the edge 26 of the aerogel sheet 20 along the corners and is spaced from the edge 26 by a gap G. The bridge 40 contacts and preferably bonds to the second face 24 of the aerogel sheet 20 at the corners. In more detail, the bridge 40 shown in FIG. 28 contacts corner regions of the top surface 34 of the wall 30, extends over the gap G, and contacts the corners of the second face 24 of the aerogel sheet 20.

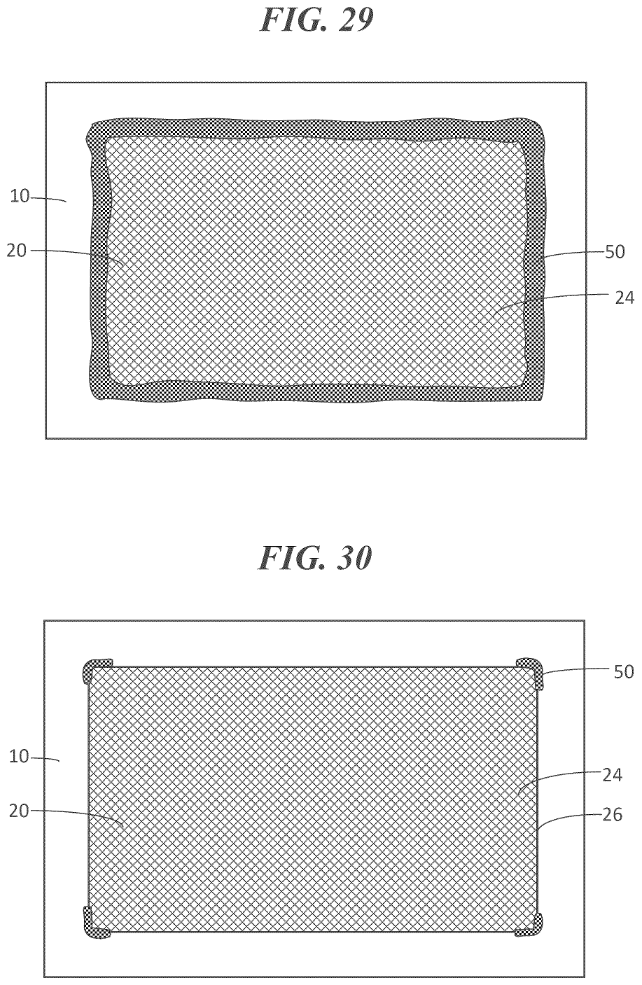

FIG. 29 illustrates a bead or glob 50 that encapsulates an edge 26 of an aerogel sheet 20 along an entirety of the aerogel sheet's outer perimeter. Here, the bead 50 contacts and preferably bonds to both an edge 26 and a portion of the second face 24 of the aerogel sheet 20 along an entire outer perimeter.

FIG. 30 illustrates a bead or glob 50 that encapsulates an edge 26 of an aerogel sheet 20 along a portion of the aerogel sheet's outer perimeter. In particular, the bead 50 encapsulates the edge 26 at each corner of the aerogel sheet 20. The bead shown in FIG. 30 comprises four bead lengths, one bead length at each corner. Each bead length encapsulates the edge 26 and a portion of the second face 24 of the aerogel sheet 20 at a corner.

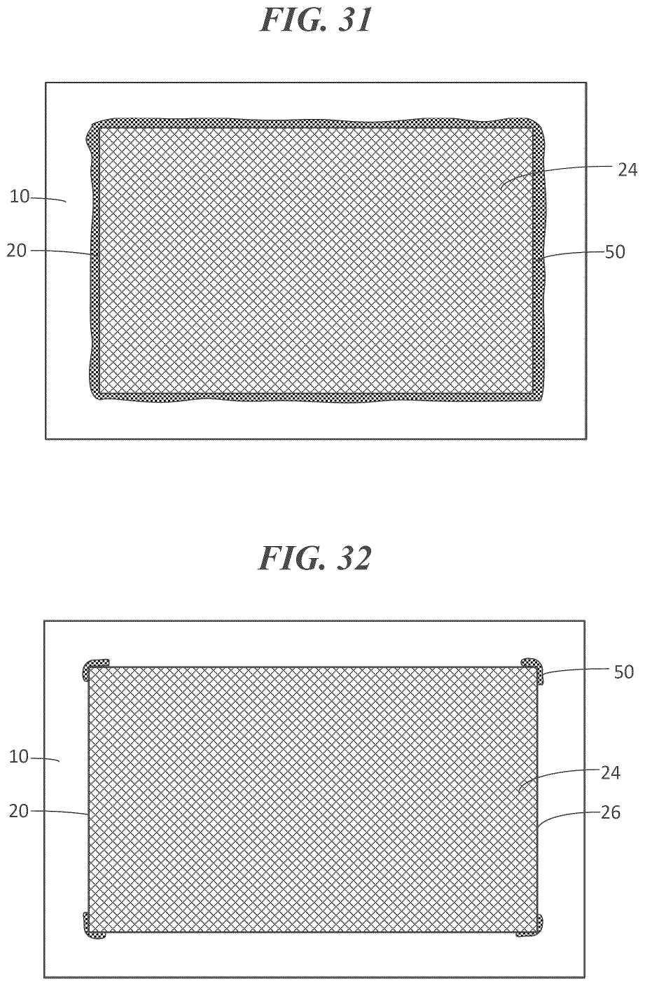

FIG. 31 illustrates a bead or glob 50 that encapsulates an edge 26 of an aerogel sheet 20 along an entirety of the aerogel sheet's outer perimeter. Unlike the bead of FIG. 31, the bead 50 in this embodiment does not contact the second face 24 of the aerogel sheet 20. Instead, this bead 50 contacts and preferably bonds to only the edge 26. Here, an entirety of the second face 24 of the aerogel sheet 20 is exposed.

FIG. 32 illustrates a bead or glob 50 that encapsulates an edge 26 of an aerogel sheet 20 along a portion of the aerogel sheet's outer perimeter. In particular, the bead of FIG. 32 comprises four bead lengths, one bead length provided at each corner. Each bead length 50 contacts and preferably bonds to the edge 26 at each corner. Also, at each corner, the bead length 50 does not contact the second face 24 of the aerogel sheet 20, which face 24 is entirely exposed.

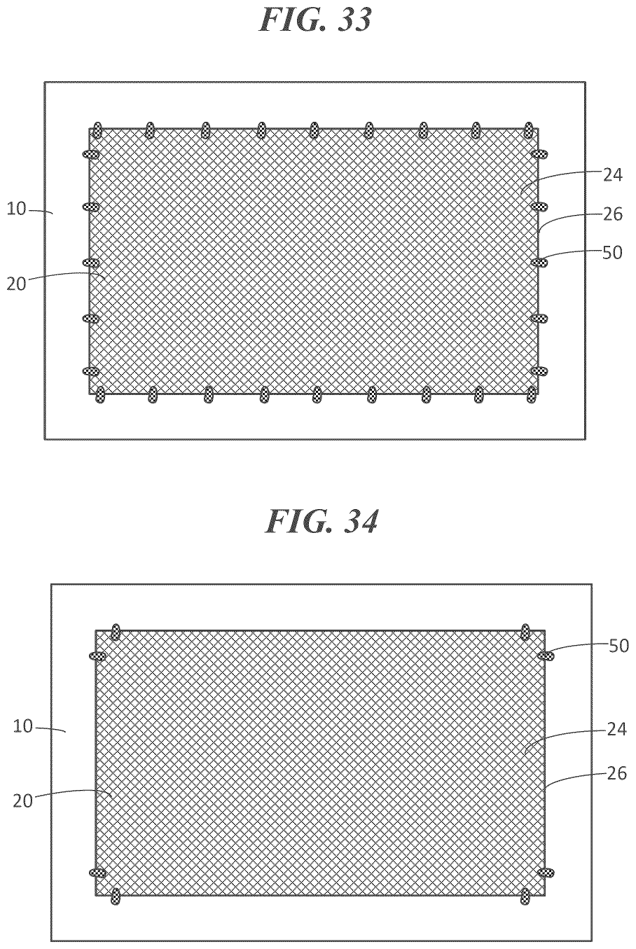

FIG. 33 illustrates a bead or glob 50 that encapsulates an edge 26 of an aerogel sheet 20 along a portion of the aerogel sheet's outer perimeter. The bead 50 of FIG. 33 comprises a plurality of bead lengths that are spaced around the outer perimeter. The plurality of bead lengths 50 are spaced apart such that portions of the edge 26 between the bead lengths are exposed. Each bead length contacts and preferably bonds to both the edge 26 and the second face 24 of the aerogel sheet 20 at different spaced-apart positions along the outer perimeter.

FIG. 34 illustrates a bead 50 that encapsulates an edge 26 of an aerogel sheet 20 along a portion of the aerogel sheet's outer perimeter. The bead 50 in this embodiment includes a pair of bead lengths adjacent each corner. Here, each pair of bead lengths contacts and preferably bonds to both the edge 26 and the second face 24 of the aerogel sheet 20.

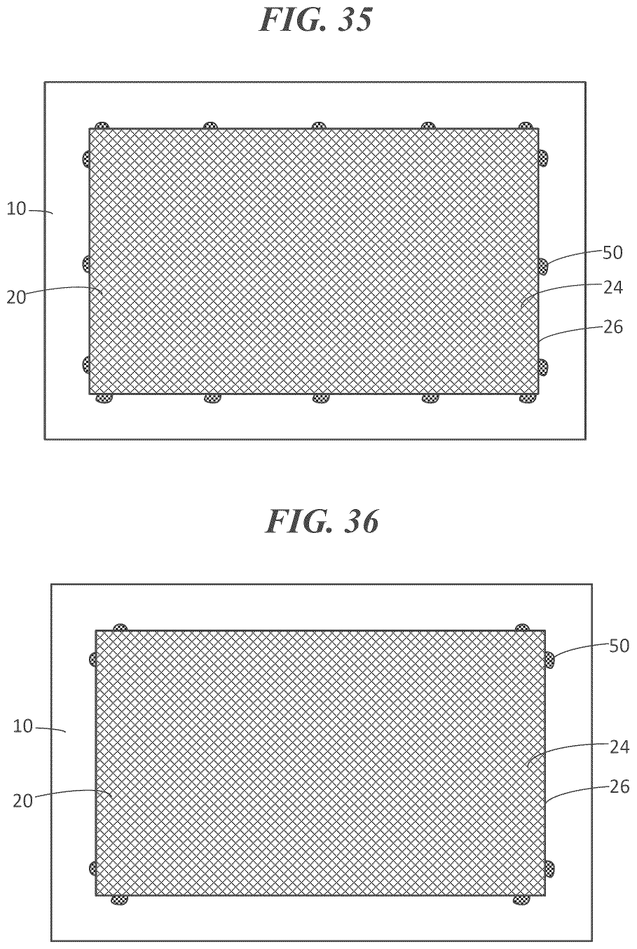

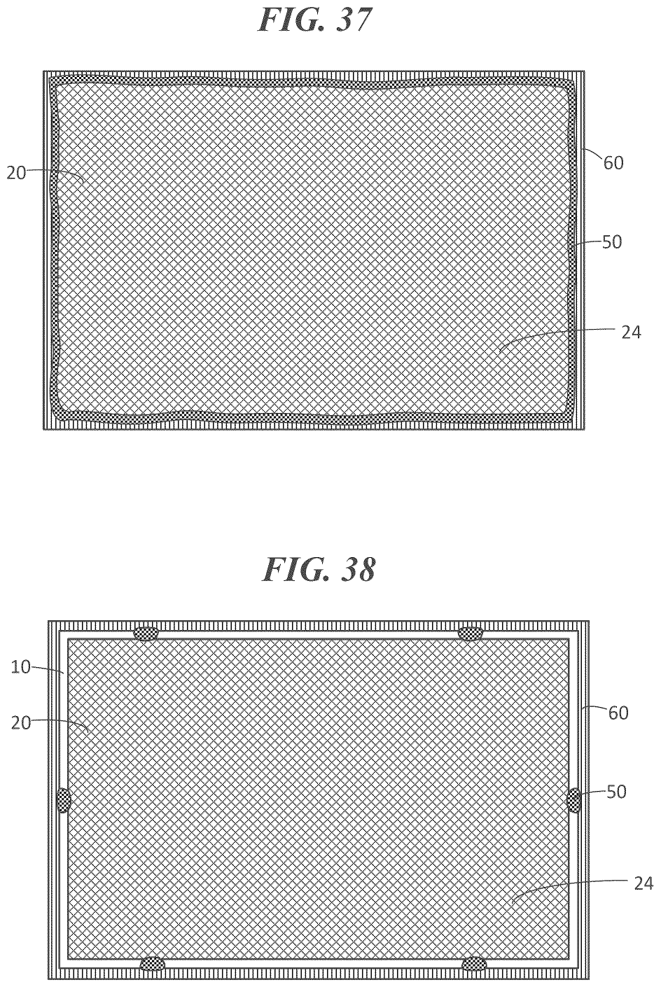

FIG. 35 illustrates a bead or glob 50 that encapsulates an edge 26 of an aerogel sheet 20 along a portion of the aerogel sheet's outer perimeter. Similar to the bead 50 of FIG. 33, the bead of FIG. 37 comprises a plurality of bead lengths that are spaced around the outer perimeter. Unlike the bead 50 of FIG. 33, the bead lengths do not contact the second face 24 of the aerogel sheet 20.

FIG. 36 illustrates a bead or glob 50 that encapsulates an edge 26 of an aerogel sheet 20 along a portion of the aerogel sheet's outer perimeter. The bead 50 of FIG. 36 includes a pair of bead lengths adjacent each corner. The bead lengths in this embodiment do not contact the second face 24 of the aerogel sheet 20.

FIG. 37 illustrates a bead or glob 50 that encapsulates an edge 26 of an aerogel sheet 20 along an entirety of the aerogel sheet's outer perimeter. In this embodiment, a spacer 60 is also positioned on the glass sheet 10 and surrounds the edge 26 of the aerogel sheet 20 along its outer perimeter. The bead 50 contacts and preferably bonds to a wall of the spacer 60, the edge 26 of the aerogel sheet 20, and the second face 24 of the aerogel sheet 20. Here, the bead 50 extends along an entire outer perimeter of the aerogel sheet 20.

FIG. 38 illustrates a bead or glob 50 that encapsulates an edge 26 of an aerogel sheet 20 along a portion of the aerogel sheet's outer perimeter. Here too, a spacer 60 is also positioned on the glass sheet 10 and surrounds the edge 26 of the aerogel sheet 20 along its outer perimeter.

The bead 50 contacts and preferably bonds to a wall of the spacer 60, while also contacting and preferably bonding to both the edge 26 and the second face 24 of the aerogel sheet 20 along a portion of the outer perimeter. In particular, the bead 50 comprises a plurality of bead lengths that are spaced around the entire outer perimeter of the aerogel sheet 20.

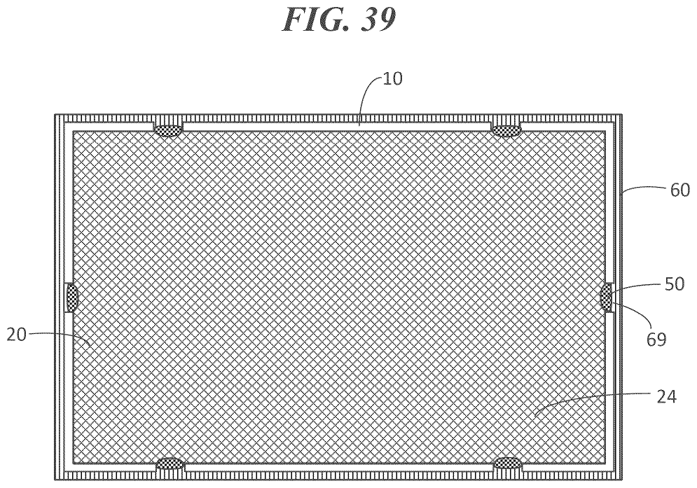

FIG. 39 also illustrates a bead (or glob) 50 that encapsulates an edge 26 of an aerogel sheet 20 along a portion of the aerogel sheet's outer perimeter. The bead in FIG. 39 is similar to the configuration shown in FIG. 38. However, the spacer 60 in this embodiment includes wings 69. In this embodiment, the extension wall 68 does not extend along an entirety of the spacer's outer perimeter. Rather, the extension wall 68 is only provided along select portions of the spacer's inner perimeter so as to form wings 69. The bead 50 includes a plurality of bead lengths provided at the respective wings.

The spacers 60 in FIGS. 37-39 are shown schematically in cross-section to illustrate the placement of the bead 50 around an outer perimeter of an aerogel sheet 20 and along a wall of a spacer 60. The schematic illustration here does not show spacer sealants or other components of an IG unit, again to help illustrate the placement of the bead 50. The spacer(s) 60 in each embodiment can include any desired cross-sectional shape and can in some cases can be in the form of a spacer 90 with ears.

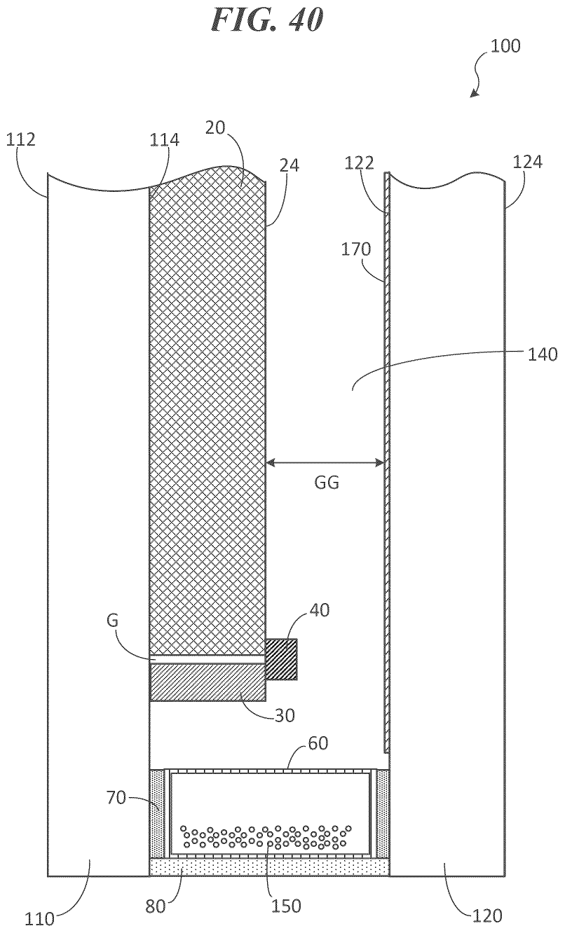

Some embodiments provide an insulating glazing unit. FIGS. 40-44, 54, and 55 illustrate double-pane insulating glazing units 100, according to certain embodiments, each comprising a first glass sheet 110, a second glass sheet 120 and a between-pane space 140. The between-pane space 140 is located between the two glass sheets. The glass sheets 110, 120 can have any of the features described for a glass sheet elsewhere herein. In alternative embodiments, one or both glass sheets 110, 120 are replaced with sheets formed of a polymer, such as polycarbonate, acrylic, or PVC. Various other polymer materials (e.g., transparent polymers) may be used in such alternative embodiments.

The first glass sheet 110 has opposed surfaces 112, 114, which preferably are opposed major surfaces (or “opposed faces”). Similarly, the second glass sheet 120 has opposed surfaces 122, 124, which preferably are opposed major surfaces. In some cases, surfaces 114 and 122 are interior surfaces facing toward the between-pane space 140, while surfaces 112 and 124 are exterior surfaces facing away from the between-pane space.

In some embodiments, the second glass sheet 120 is an outboard pane that defines both a #1 surface (surface 124) and a #2 surface (surface 122), while the first glass sheet 110 is an inboard pane that defines both a #3 surface (surface 114) and a #4 surface (surface 112). Thus, the illustrated IG unit 100 can optionally be mounted in a frame such that surface 124 is a #1 surface, which is (or is configured to be) exposed to an outdoor environment, while surface 112 is a #4 surface, which is (or is configured to be) exposed to an indoor environment (e.g., an environment inside a building).

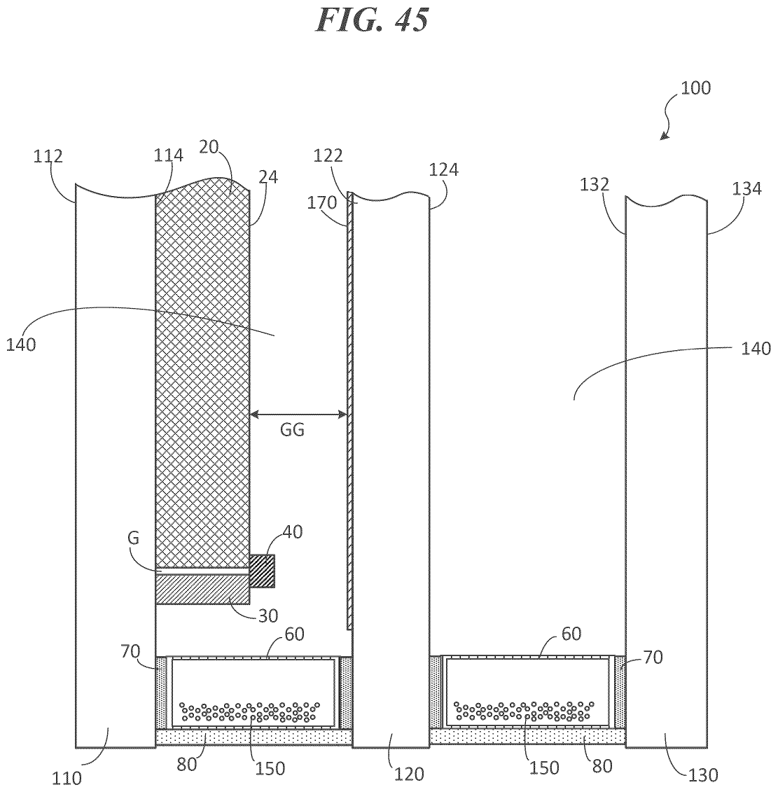

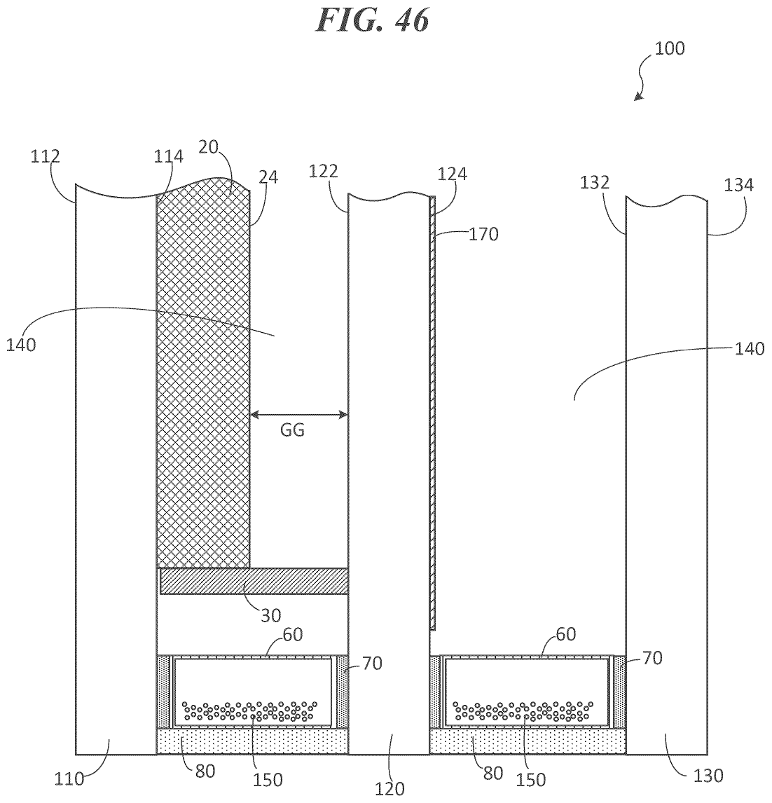

More generally, though, by referring to a pane or glass sheet herein as a “first” pane or “first” glass sheet, this does not require specific orientation, arrangement, or location, such as being the outboard or inboard pane, absent an indication to the contrary. In FIGS. 40-44, 54, and 55, for example, surface 124 is the #1 surface in some embodiments, while in other embodiments surface 112 is the #1 surface. The same is true for triple-pane IG unit embodiments, such as the non-limiting examples of FIGS. 45 and 46.

The insulating glazing unit 100 includes an aerogel sheet 20 provided in a mounted position alongside an interior surface 114 or 122 facing the between-pane space 140. The aerogel sheet 20 is retained in the mounted position by an encapsulation material having any configuration described in the present disclosure. If desired, there can also be other means for retaining the aerogel sheet in the mounted position, as noted above.

In FIGS. 40-44, 54, and 55, the aerogel sheet 20 is provided on surface 114, which can optionally be a #3 surface. However, in other embodiments, the aerogel sheet 20 is provided on surface 122, which can optionally be a #2 surface. Another option is to provide aerogel sheets on both interior pane surfaces (i.e., surfaces 114 and 122) of such an IG unit.

In certain embodiments, the between-pane space 140 contains a gaseous atmosphere, preferably comprising a thermally insulative gas, such as argon, krypton, or both. In some cases, the gaseous atmosphere comprises a mix of argon and air (e.g., 90% argon and 10% air). In other cases, the gaseous atmosphere comprises a mix of krypton and air. In still other cases, the gaseous atmosphere comprises a mix of argon, krypton, and air. In yet other cases, the gaseous atmosphere is just air. Moreover, if desired, the between-pane space 140 (e.g., any gas gap thereof) can be evacuated to a desired vacuum level, such as a moderate vacuum level, to further enhance thermal insulation properties of the IG unit.

In many insulating glazing unit embodiments, a gas gap GG is provided alongside the aerogel sheet 20. In some embodiments of this nature, the gas gap GG has a width in a range of from 9 to 14 mm and it contains a gaseous atmosphere comprising argon, air, or both. In certain preferred embodiments, the between-pane space 140 has a width in a range of from 14 to 21 mm, the gaseous atmosphere comprises argon, and the width of the gas gap GG is from 10.5 to 13.5 mm. Reference is made to U.S. patent application Ser. No. 17/389,603, the teachings of which relating to gas gap and between-pane space configurations and dimensions are hereby incorporated by reference.

The aerogel sheet 20 has a thickness. In some embodiments, the aerogel sheet 20 has a thickness in a range of from 1.5 mm to 15 mm, such as greater than 2 mm but less than 8 mm, or from 2 mm to 4 mm (e.g., 3 mm). It is to be appreciated, however, that other thicknesses can be used.

A ratio of the thickness of the aerogel sheet 20 to the thickness of the between-pane space 140 preferably is between 0.15 and 0.85. In some embodiments, the thickness of the between-pane space 140 is at least 10 mm, optionally together with the thickness of the aerogel sheet 20 being greater than 2 mm but less than 8 mm. In certain preferred embodiments, the aerogel sheet 20 occupies less than 50% of the thickness of the between-pane space 50 (e.g., less than 45%, less than 40%, or even less than 35% of the thickness of the between-pane space 50).

In other embodiments, the aerogel sheet 20 occupies a majority of the thickness of the between-pane space 140. In such instances, the thickness of the aerogel sheet 20 preferably is greater than 8 mm but less than 15 mm (e.g., about 10 mm), while the thickness of the gas gap GG alongside the aerogel sheet 20 is optionally less than 5 mm (e.g., about 3 mm).

A spacer 60/90 is provided between the two glass sheets 110, 120. The spacer 60/90 may be a conventional metal channel spacer, e.g., formed of stainless steel or aluminum. Or it can comprise polymer and metal, or just polymer (e.g., foam). The spacer can alternatively be an integral part of a sash, frame, etc. so as to maintain the insulating glazing unit in the desired configuration. The spacer 60/90 can be any type of spacer described herein, or any other suitable kind of spacer.

The spacer 60/90 can be sealed to the two glass sheets 110, 120 by one or more beads of sealant, as is conventional and well-known to skilled artisans. For example, a primary sealant 70 can be provided on opposite sides of the spacer 60/90, and a secondary sealant 80 can be provided on an outside wall of the spacer 60/90. Another option is to omit the secondary sealant 80 and provide a single deposit of sealant along both sides of the spacer and on the outside wall of the spacer. Various other known sealant arrangements/systems can alternatively be used. In other cases, the spacer may be omitted while one or more beads of sealant (optionally together with a moisture vapor barrier) are provided about the perimeter of the unit so as to encompass the aerogel sheet 20.

The aerogel sheet 20 preferably does not contact the spacer 60/90. For example, the aerogel sheet 20 may be separated (i.e., spaced-apart) from the spacer 60/90 by about 1 mm to about 5 mm (e.g., about 2-4 mm, such as about 3 mm). When provided, sealant 70, 80 between the spacer 60/90 and the two adjacent glass sheets 110, 120 can also be spaced from the aerogel sheet 20.

Certain embodiments provide an insulating glazing unit 100 that includes both an aerogel sheet 20 and a low-emissivity coating 170. In some cases, a low-emissivity coating 170 is provided on an interior surface confronting the interior surface that carries the aerogel sheet 20. FIG. 40 illustrates an embodiment that includes an aerogel sheet 20 on surface 114, which can optionally be a #3 surface, and an optional low-emissivity coating 170 on surface 122, which can optionally be a #2 surface. If desired, the aerogel sheet 20 shown in FIG. 40 can be on surface 122 (optionally over a low-emissivity coating 170) instead of on surface 114. In some cases, an aerogel sheet 20 is provided on surface 122 and an optional low-emissivity or solar control coating is provided on surface 114. In other cases, both a low-emissivity coating and an aerogel sheet are provided on a #2 surface, or on a #3 surface. Another option is to provide aerogel sheets on both interior pane surfaces (i.e., surfaces 114 and 122) of a double-pane IG unit.

When provided, the optional low-emissivity coating 170 preferably includes at least one silver-inclusive film, which desirably contains more than 50% silver by weight (e.g., a metallic silver film). In certain preferred embodiments, the low-emissivity coating 170 includes three or more infrared-reflective films (e.g., silver-containing films). Low-emissivity coatings having three or more infrared-reflective films are described in U.S. Patent and application Ser. Nos. 11/546,152 and 7,572,511 and 7,572,510 and 7,572,509 and 11/545,211 and 7,342,716 and 7,339,728, the teachings of each of which are incorporated herein by reference. In some cases, the low-emissivity coating 170 includes four silver layers. In other cases, the low-emissivity coating can be a “single silver” or “double silver” low-emissivity coating, which are well-known to skilled artisans. Advantageous coatings of this nature are commercially available from, for example, Cardinal CG Company (Eden Prairie, Minnesota, U.S.A.).

The encapsulation material is exposed to the between-pane space 140 of the IG unit. Therefore, the encapsulation material preferably comprises material that is compatible with components of the insulating glazing unit 100. For example, the encapsulation material preferably comprises material that does not outgas. Also, the encapsulation material preferably comprises material that does not introduce moisture to the between-pane space 140 of the insulating glazing unit 100 in an amount that degrades (e.g., corrodes) components with the between-pane space, such as the optional low-emissivity coating 170. Further, the encapsulation material is preferably a material that does not introduce moisture in an amount that degrades a spacer sealant, such as a silicone sealant and/or a polyisobutylene sealant. Still further, the encapsulation material is preferably a material that does not degrade upon exposure to ultraviolet radiation (e.g., UVA or UVB light) when inside the insulating glazing unit 100. The encapsulation material can comprise PETG or any other suitable material, which preferably has the noted compatibility properties. Furthermore, for embodiments that include the second material in the form of a wall, glob or bead 130/150, it too preferably has the noted compatibility properties.

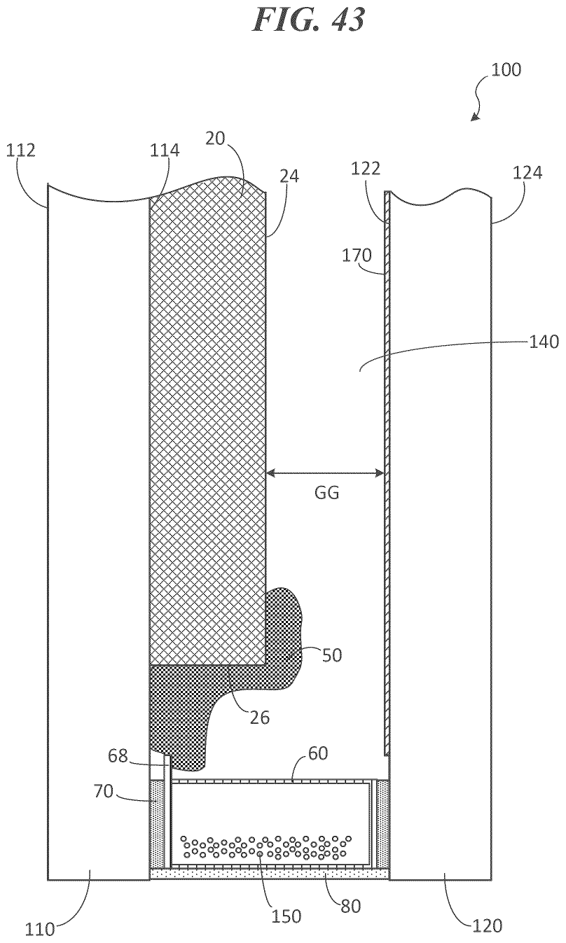

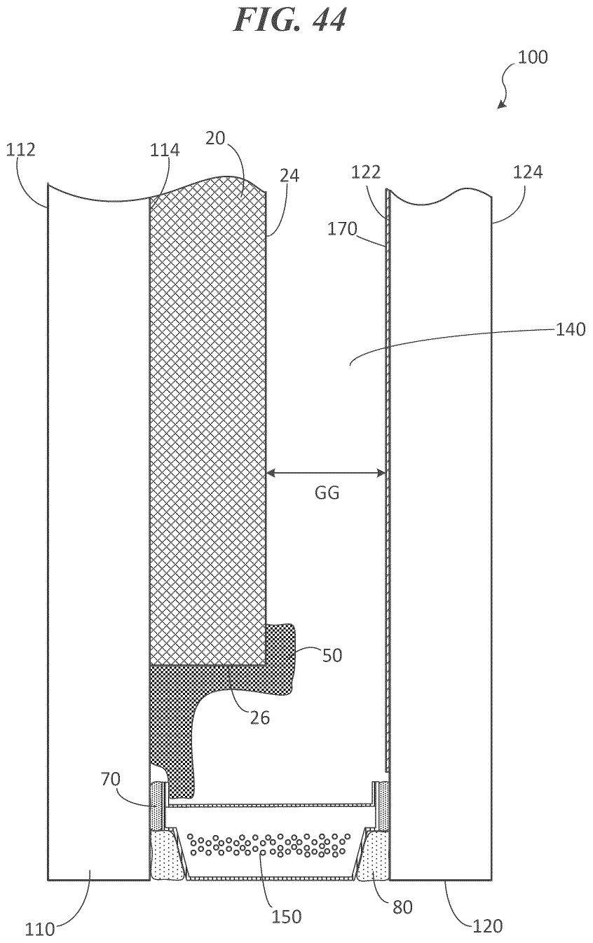

The encapsulation material can include any encapsulation material and configuration described herein. In FIG. 40, the encapsulation material defines a wall 30 and a bridge 40 that retain the aerogel sheet 20 in the mounted position alongside the #3 surface. In FIGS. 43-44, the encapsulation material defines a bead or glob 50 that contacts a wall of a spacer and encapsulates an edge 26 to retain the aerogel sheet 20 in the mounted position. Another non-limiting example is shown in FIG. 55, where the encapsulation material also contacts spacer sealant 70. It is to be appreciated, however, that other configurations can be used for the encapsulation material.

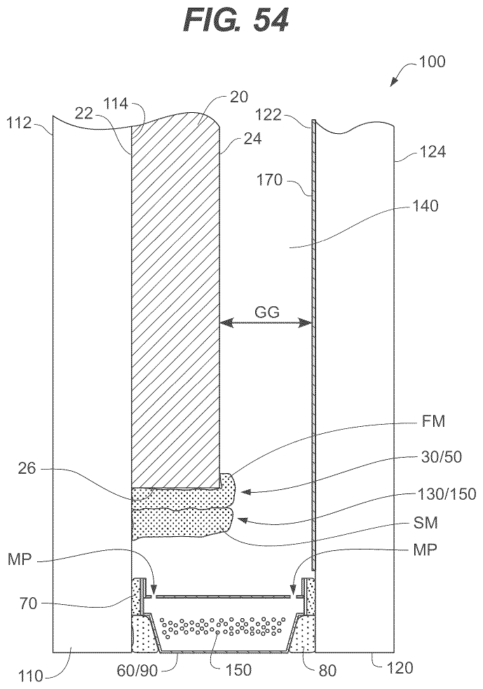

FIG. 54 shows an encapsulation material (or “first material” FM) alongside a second material SM. As will be appreciated from the foregoing teachings of the present disclosure, the encapsulation material can be provided in the form of a wall 30, glob or bead 50. Thus, in FIG. 54, the first material FM is labelled as element 30/50. Similarly, the second material SM can be provided in the form of a wall 130, glob or bead 150. Thus, in FIG. 54, the second material SM is labelled as element 130/150. Here, the illustrated encapsulation material and the second material are adhered together and both are spaced inwardly from the spacer 60/90 and the nearest spacer sealant 70.

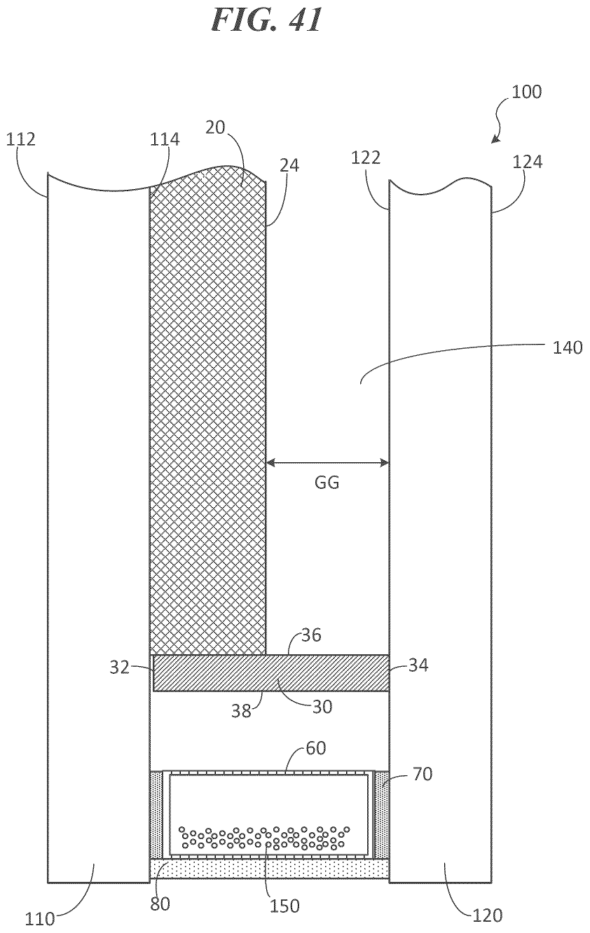

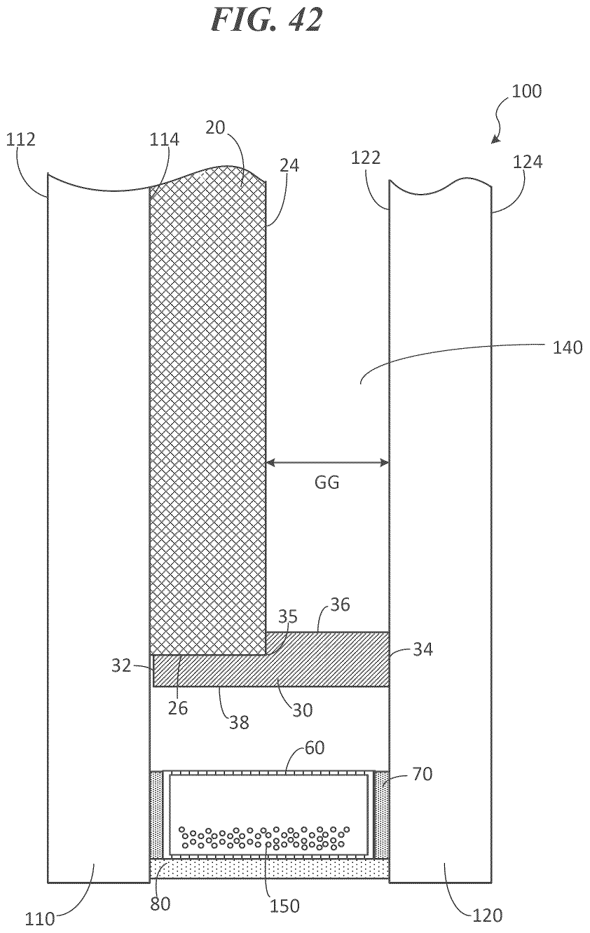

In FIGS. 41-42, the aerogel sheet 20 is carried alongside surface 114, which can optionally be a #3 surface, and the encapsulation material defines a wall 30 that is bonded to a confronting surface 122, which can optionally be a #2 surface. Thus, the wall 30 in these embodiments is formed on surface 122, rather than on surface 114, which carries the illustrated aerogel sheet 20. When the insulating glazing unit 100 is assembled as shown in FIGS. 41-42, the wall 30 is positioned such that it abuts, and is thereby positioned to contain or support, the aerogel sheet 20. The wall 30 is shown extending almost entirely to surface 114, but can alternatively extend entirely to surface 114.

The wall 30 shown in FIG. 41 includes a surface 32 and opposing surface 34. Also, the wall 30 includes an inner side surface 36 facing the aerogel sheet 20 and an outer side surface 38 facing away from the aerogel sheet 20. In this embodiment, the surface 34 is the surface bonded to surface 122 of the second glass sheet 120. The surface 32 abuts (and in some cases contacts) surface 114 of the first glass sheet 110. The inner side surface 36 supports and positions the aerogel sheet 20.

The wall 30 in the embodiment of FIG. 42 includes an inside corner 35 that supports both a top surface 24 and an edge 26 of the aerogel sheet 20. The inside corner 35 is formed between the inner side surface 36 and the surface 32 of the wall 30. The inside corner 35 supports and positions the aerogel sheet 20.

With continued reference to FIGS. 41-42, since the illustrated wall 30 is formed on a glass sheet 120 that does not carry the aerogel sheet 20, it can be formed from any encapsulation material described herein. In some cases, the wall 30 is formed by depositing heated PETG. In such cases, the wall 30 can be formed by depositing heated PETG from a nozzle at any (or no) gap distance and at any suitable temperature. As can be appreciated by referring to FIGS. 41-42, the aerogel sheet 20 can be carried alongside a #3 surface while the encapsulation material defines a wall 30 bonded to a confronting #2 surface, or the aerogel sheet 20 can be carried alongside a #2 surface while the encapsulation material defines a wall 30 bonded to a confronting #3 surface.

Other embodiments provide a triple-pane insulating glazing unit. FIGS. 45-46 illustrate a triple-pane insulating glazing unit 100 according to certain embodiments comprising a first glass sheet 110, a second glass sheet 120 and a third glass sheet 130. A first between-pane space 140 is located between the first glass sheet 110 and the second glass sheet 120, a second between-pane space 140 is located between the second glass sheet 120 and the third glass sheet 130. Furthermore, it is to be appreciated that a third pane can optionally be added to any other IG unit shown or described in this disclosure, such as those shown in any of FIGS. 43, 44, 54, and 55.

The first glass sheet 110 has opposed surfaces 112, 114, which preferably are opposed major surfaces (or “opposed faces”). Similarly, the second glass sheet 120 has opposed surfaces 122, 124 and the third glass sheet 130 has opposed surfaces 132, 134. Here, surfaces 114, 122, 124, 132 are interior surfaces facing a between-pane space, while surfaces 112 and 134 are exterior surfaces facing away from the between-pane spaces.

In some embodiments, the third glass sheet 130 is an outboard pane that defines a #1 surface (i.e., surface 134) and a #2 surface (i.e., surface 132), the second glass sheet 120 is a middle pane that defines a #3 surface (i.e., surface 124) and a #4 surface (i.e., surface 122) while the first glass sheet 110 is an inboard pane that defines a #5 surface (i.e., surface 114) and a #6 surface (i.e., surface 112). The triple-pane insulating glazing unit 100 can optionally be mounted in a frame such that the #1 surface is exposed to an outdoor environment, while the #6 surface is exposed to an indoor environment (e.g., an environment inside a building).

The triple-pane insulating glazing units 100 in FIGS. 45-46 can have any features described herein for the double-pane glazing units. If desired, the aerogel sheet 20, along with the encapsulation material, can be provided on a #2 surface (which may be surface 132), a #3 surface (which may be surface 124), #4 surface (which may be surface 122) and/or a #5 surface (which may be surface 114). Thus, in any triple-pane IG unit of the present disclosure, there can be one or more encapsulated aerogel sheets on any one or more of the interior pane surfaces. In some cases, an optional low-emissivity coating 170 can be provided on a #2, #3, #4 or #5 surface.

The encapsulation material in the triple-pane glazing units can include any material or configuration described herein. In FIG. 45, the encapsulation material defines a wall 30 and a bridge 40 that retain the aerogel sheet 20 in the mounted position alongside surface 114, which can optionally be a #5 surface. In FIG. 46, the aerogel sheet 20 is carried alongside surface 114, which can optionally be a #5 surface, and the encapsulation material defines a wall 30 that is bonded to confronting surface 122, which can optionally be a #4 surface. However, it is to be appreciated that other configurations can be used for the encapsulation material.

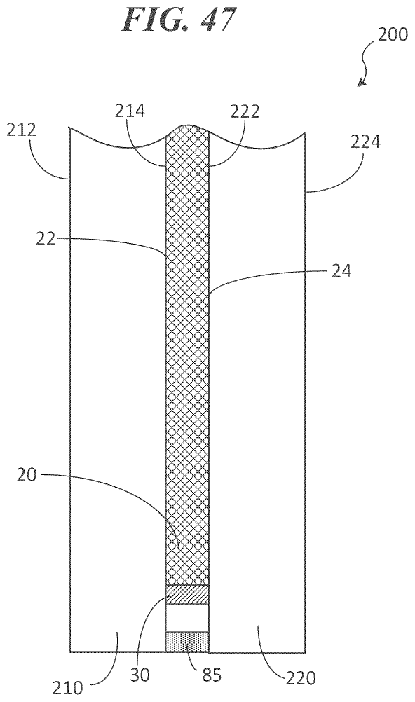

Certain embodiments provide a monolithic unit. FIG. 47 illustrates a monolithic unit 200 comprising a first glass sheet 210, a second glass sheet 220 and an aerogel sheet 20. The first glass sheet 210 comprises a surface 212 and an opposing surface 214. The second glass sheet 220 includes a surface 222 and opposing surface 224. The surface 214 and surface 222 face the aerogel sheet 20. The aerogel sheet 20 is retained in a mounted position between the first glass sheet 210 and second glass sheet 220 by an encapsulation material defining a wall 30. In certain cases, aerogel sheet 20 is in direct contact with both the surface 214 and surface 222. In specific cases, an entirety of the first face 22 of the aerogel sheet is in contact with surface 214 and an entirety of the second face 24 is in contact with surface 222. The wall 30 in this embodiment can be formed on either surface 214 of the first glass sheet 210 or on surface 222 of the second glass sheet 220. A sealant 85 can also be provided to seal the unit 200.

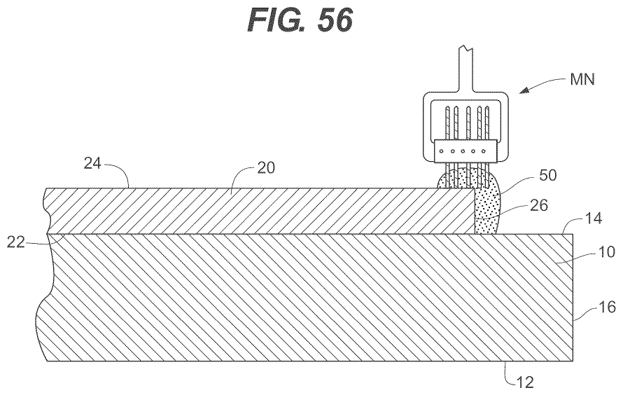

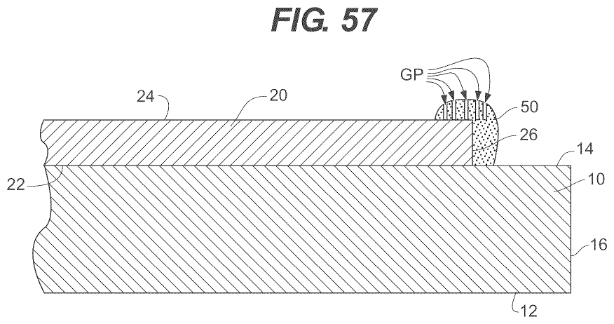

FIGS. 56 and 57 exemplify various embodiments wherein an encapsulation material (or “first material” FM) is applied to encapsulate an edge 26 of an aerogel sheet 20 on a glass sheet. Applicant has discovered that, in some cases, when encapsulation material is deposited on an aerogel sheet 20 (e.g., when such encapsulation material is at an elevated temperature in the ranges noted above for contact temperature), gas may escape from the aerogel sheet and diffuse into the encapsulation material, thereby forming bubbles in the encapsulation material. Applicant has discovered it is possible to reduce the likelihood for visible bubbles to form in this manner if gas-passage openings are formed in the material applied to encapsulate the edge of the aerogel sheet. It is surmised that this allows at least some gas escaping from the aerogel sheet to pass through the gas-passage openings, rather than diffusing into the encapsulation material and forming bubbles therein. This may advantageously eliminate or reduce the occurrence of visible bubbles forming in the encapsulation material.

Thus, in certain method embodiments, the method comprises extruding an encapsulation material to form an extruded deposit, which may be in the form of a glob or bead 50, and the method includes forming a plurality of gas-passage openings GP in the extruded deposit. This can optionally be done in any method embodiment of the present disclosure. In embodiments of this nature, the gas-passage openings GP can be created in any desired manner that forms suitable holes, slits, or other openings sufficient to enable passage of gas that may escape from the aerogel when applying the encapsulation material. In some cases, the gas-passage openings GP are formed in the encapsulation material while it is cooling. When provided, the gas-passage openings GP preferably are formed in the extruded deposit by performing a needling operation in which a plurality of needles penetrates the extruded deposit to form the gas-passage openings. If desired, the gas-passage openings can be formed (e.g., by hand) using one or more needles each having a diameter of from 0.1 mm to 0.4 mm, such as from 0.2 mm to 0.3 mm. In one non-limiting example, one or more needles having a diameter of about 0.25 mm and a length about 40 mm can be used. Suitable acupuncture needles of this nature can be obtained commercially from EACU Medical Instruments Inc. (Maanshan Bond Medical Devices Co., Ltd., Maanshan City, Anhui Province, China). In the non-limiting example of FIG. 56, the needling operation comprises rolling a micro-needle roller MN on the extruded deposit. In this example, the needles of the roller should go deep enough, and preferably are integrated into a gantry system or robot system. In more detail, the needles preferably are long enough to penetrate down to the aerogel to provide optimized gas-passage openings GP, which serve as gas escape pathways, while being at an appropriate angle. The needle length and angle during use preferably are configured not to damage the aerogel sheet. It is to be appreciated that in addition to hand-held needling or roller needling, various other devices and methods can alternatively be used to form gas-passage openings in the extruded deposit.

When gas-passage openings GP are provided, regardless of the method used to form them, damage to the aerogel sheet 20 preferably is avoided. Thus, while the gas-passage openings GP preferably extend entirely through encapsulation material, e.g., to terminate at the aerogel and allow for gas escaping from the aerogel sheet to enter and flow through the gas-passage openings GP, the method used to form these openings preferably does not create holes or other damage in the aerogel sheet.

FIG. 57 is a schematic, non-limiting illustration of an extruded deposit, shown in the form of a bead or glob 50, that includes a plurality of gas-passage openings GP. If desired, gas-passage openings GP can be provided in the encapsulation material of any embodiment of the present disclosure.

In view of the foregoing discussions of different aerogel encapsulation embodiments, it can be appreciated that the present disclosure provides various methods of making an article, wherein the method includes providing an aerogel sheet on a glass sheet. As noted above, the aerogel sheet 20 preferably comprises a first face 22, a second face 24, and an edge 26 forming an outer perimeter of the aerogel sheet. The method includes applying an encapsulation material (or “first material”) to encapsulate the edge 26 along at least a portion of the outer perimeter of the aerogel sheet 20. Various methods of this nature have already been described, e.g., with reference to FIGS. 1-39. Preferably, the glass sheet and the aerogel sheet thereon are maintained in a horizontal position (or a position that is at least generally horizontal, e.g., at least substantially horizontal) when applying the encapsulation material.

As described previously, the application of encapsulation material preferably is carried out while the encapsulation material is at an elevated temperature (i.e., a temperature warmer than room temperature). See the non-limiting preferred ranges discussed above for nozzle temperature and contact temperature, which can optionally be used in any embodiment of the present disclosure.

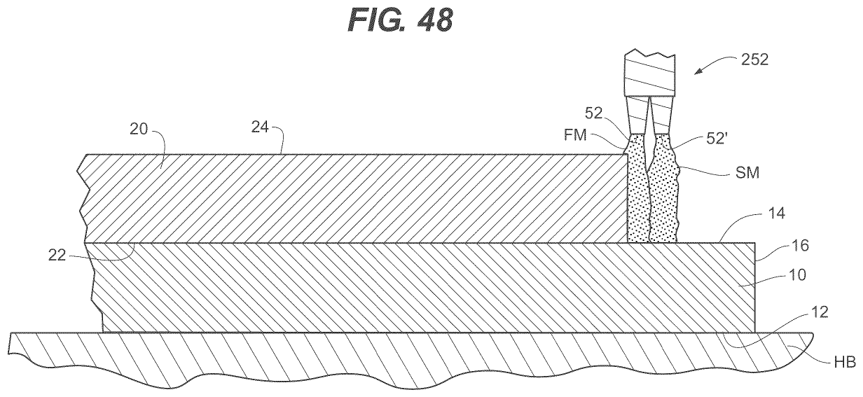

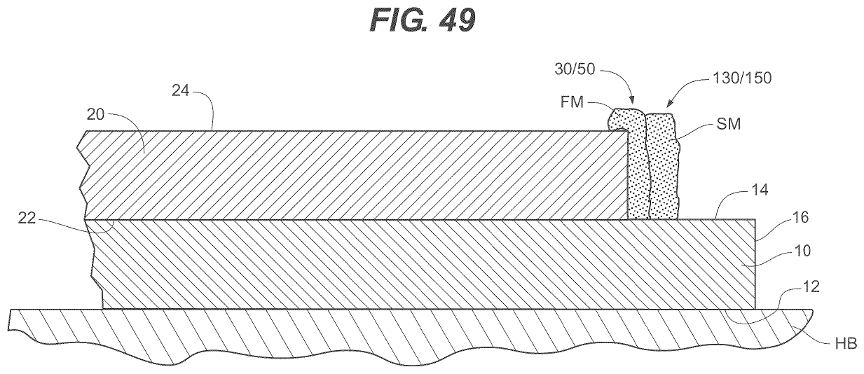

In some cases, the aerogel sheet, the glass sheet, or both are at elevated temperature when the encapsulation material is applied. As just one example, in FIGS. 48 and 49, the glass sheet is shown on an optional heated bed HB when applying the first material. It is to be appreciated, however, that the glass sheet and the aerogel sheet thereon are by no means required to be on a heated bed or otherwise heated or at an elevated temperature prior to, or when, applying the encapsulation material.

In embodiments where there is no second material SM to adhere (or help adhere) the encapsulation material to the underlying glass sheet, a heated bed HB (or another means for heating the glass sheet) can optionally be used during deposition of the encapsulation material. This may enhance adhesion of the encapsulation material to the underlying glass sheet.

In embodiments where a second material SM is provided, it may be preferred not to provide any heated bed HB (or other means for heating the glass sheet). In such embodiments, sufficient adhesion to the underlying glass sheet may be achieved by the adhesion between the encapsulation material and the second material, in combination with the adhesion of the second material to the underlying glass sheet.

Heating the aerogel sheet may be beneficial, e.g., in helping to eliminate or reduce the occurrence of visible bubbles forming in the encapsulation material. In other cases, though, neither the glass sheet nor the aerogel sheet is heated or otherwise at elevated temperature when depositing the encapsulation material. In such cases, it may be desirable to provide gas-passage openings GP in the extruded deposit of the encapsulation material, as noted above. In still other cases, neither aerogel heating nor gas-passage openings are provided. Depending on the application, for example, the encapsulation material may be entirely or substantially outside the vision area. In such cases, even if visible bubbles were to form in the encapsulation material, it may be acceptable.

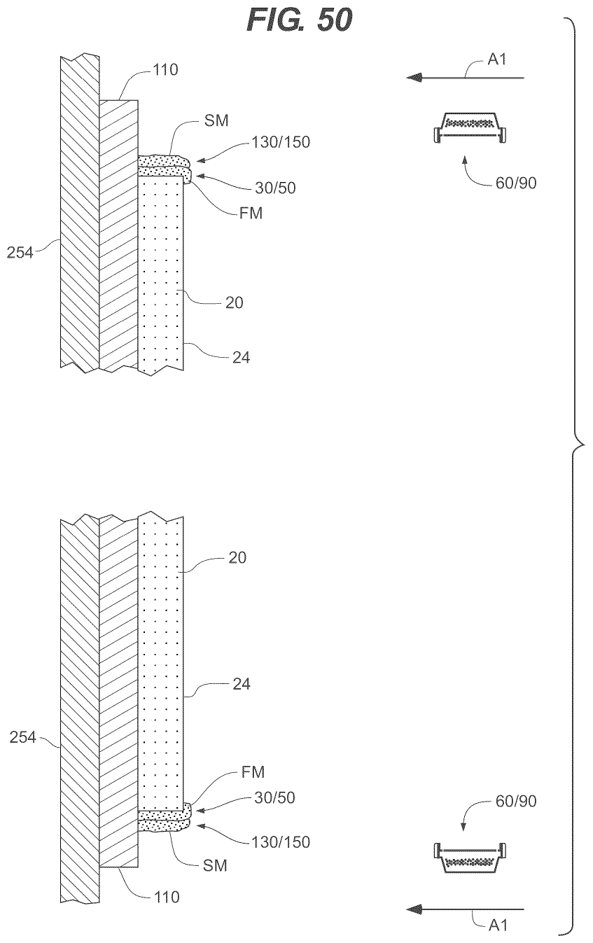

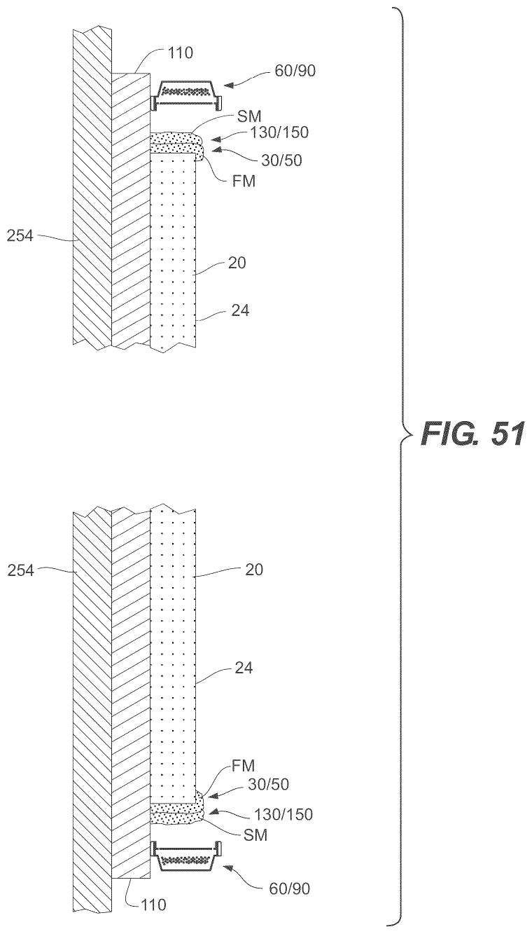

In some embodiments, after applying the encapsulation material, the method further comprises moving the glass sheet 10/110 and the encapsulated aerogel sheet 20 thereon from a horizontal (or generally or substantially horizontal) position to a vertical or vertical-offset position for further processing. This may be done manually (e.g., by one or more workers with glass handling gear lifting the glass sheet 10/110 having the encapsulated aerogel sheet 20 thereon from a horizontal position onto a vertical or vertical-offset glass processing line. Alternatively, various automated glass handling mechanisms can be used to move the glass sheet 10/110 and the encapsulated aerogel sheet 20 thereon from a horizontal position to a vertical or vertical-offset position for further processing. One non-limiting example of a suitable vertical-offset glass processing line is shown in FIGS. 11-14 of U.S. Patent Application Publication No. 2024/0247537, entitled “Aerogel Molding And Handling Technology, Multiple-Pane Insulating Glazing Units Incorporating Aerogel, And IG Unit Manufacturing Methods,” the salient contents of which are incorporated herein by reference. In such a processing line, a spacer 60/90 can be adhered to the glass sheet 10/110 on an automated basis. One example is shown schematically in FIGS. 50 and 51 of the present disclosure. Reference is also made to U.S. Pat. No. 11,536,083, entitled “Automated Spacer Processing Systems And Methods,” the relevant teachings of which are incorporated herein by reference. More generally, it is to be appreciated that, while the glass sheet and the encapsulated aerogel sheet thereon are in the vertical or vertical-offset position, the further processing may comprise coupling the glass sheet 10/110 and the encapsulated aerogel sheet 20 thereon with a second glass sheet 120 such that a spacer 60/90 is adhered between the two glass sheets. Additionally or alternatively, such further processing carried out with the glass sheet 10/110 in a vertical or vertical-offset position can optionally involve the gas filling and pressing equipment disclosed in U.S. Pat. No. 11,168,515, entitled “Multiple-Pane Insulating Glazing Unit Assembly, Gas Filling, And Pressing Machine,” the salient contents of which are incorporated herein by reference.

When provided, a vertical-offset position, orientation or processing line is characterized by an offset from true vertical by less than 10 degrees, such as about 3-7 degrees.

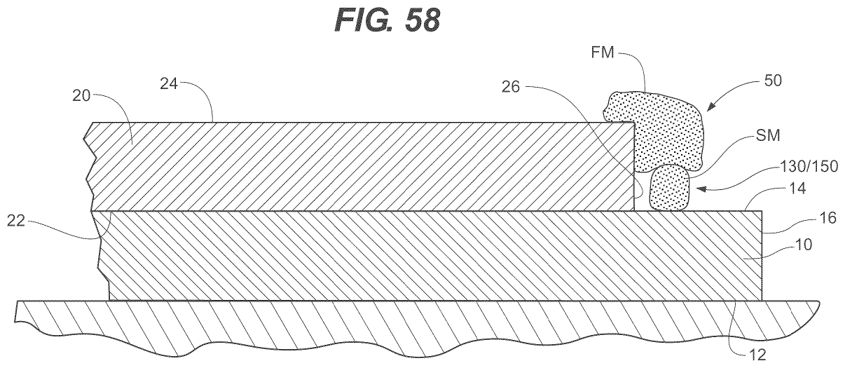

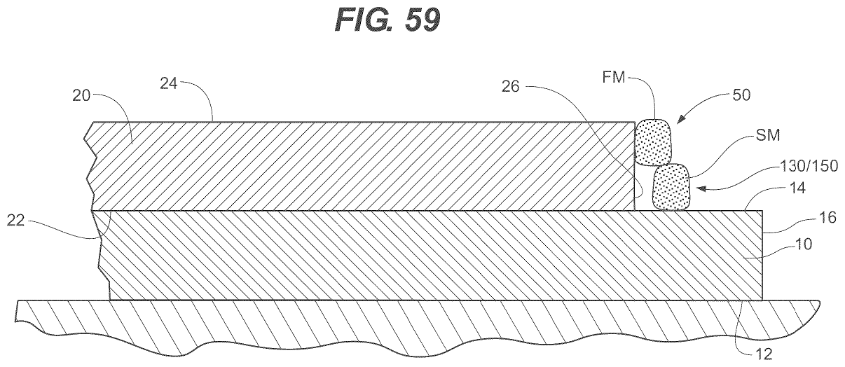

In one group of embodiments, the encapsulation method includes applying a second material SM onto the glass sheet, wherein applying the encapsulation material (or “first material” FM) and applying the second material SM are carried out such that: (i) the encapsulation material adheres to the aerogel sheet, (ii) the second material adheres to the glass sheet, and (iii) the encapsulation material and the second material adhere together. One non-limiting example is shown in FIGS. 48 and 49. When provided, the second material SM preferably does not contact the aerogel sheet 20. Two other examples of different encapsulation configurations are shown in FIGS. 58 and 59.

In the present embodiment group, the second material SM preferably is applied either by extruding it onto the glass sheet or by adhering an adhesive tape onto the glass sheet. In cases where the second material is provided in the form of an adhesive tape, various commercially available acrylic foam tapes can be used, such as tapes sold commercially by 3M Company (St. Paul, Minnesota, USA) under the 3M™ trade name VHB™ tape. In cases where the second material is extruded onto the glass sheet, it preferably comprises polyisobutylene. Suitable PIB materials are available from a variety of commercial suppliers, such as H.B. Fuller Company (St. Paul, Minnesota, USA). One example is the H.B. Fuller Ködispace 4SG sealant. Another option is to use silicone. When provided, the optional second material SM can adhere nicely to both the underlying glass sheet and to encapsulation material, thereby providing enhanced security for retaining the aerogel sheet on the glass sheet.

In some preferred embodiments where the encapsulation material and the second material are both applied by extrusion, the method comprises extruding the encapsulation material while simultaneously extruding the second material. Preferably, this is carried out using a dual-nozzle dispenser 252. Reference is made to FIG. 48, which shows a dual-nozzle dispenser 252 comprising a first nozzle 52 extruding the encapsulation material while a second nozzle 52′ simultaneously extrudes the second material. Here, the two nozzles 52, 52′ are configured (and operated) to simultaneously extrude the encapsulation material and the second material as side-by-side extruded beads, which contact and adhere together. In preferred embodiments of this nature, the extrusion of both materials is completed by moving the dual-nozzle dispenser 252 in a single pass about the outer perimeter of the aerogel sheet. Methods of this nature can provide various advantages, including desirable efficiency.

In embodiments where the encapsulation material and a second material are provided as side-by-side extruded beads, it is not required to simultaneous extrude the two beads using a dual-nozzle dispenser. Another option is to use two separate automated extrusion heads with a gantry system (or two multi-axis robots), each equipped with its own nozzle and sealant supply (e.g., one to extrude PIB, the other to extrude PETG).

FIGS. 58 and 59 show two further embodiments that involve both the encapsulation material (or “first material” FM) and a second material SM. Here, the second material SM adheres to the glass sheet 10, and the encapsulation material is on top of the second material, such that the encapsulation material and the second material adhere together, while the encapsulation material contacts (and preferably bonds to) the aerogel sheet 20. In these figures, the encapsulation material is shown in the form of a glob or bead 50. Encapsulation arrangements of this nature may be produced, for example, by having a leading nozzle extrude the second material SM onto the glass and having a trailing nozzle extrude the encapsulation material over the second material so as to encapsulate the aerogel sheet 20. This could be done using a dual-nozzle dispenser where the leading nozzle is located in front of the trailing nozzle. Another option is to use two separate automated extrusion heads with a gantry system (or two multi-axis robots), each equipped with its own nozzle and sealant supply (e.g., one to extrude PIB, the other to extrude PETG).

With reference to FIG. 58, it can be appreciated that, in some cases, an extrusion nozzle used to deposit the encapsulation material has a larger orifice than does an extrusion nozzle used to deposit the second material. Thus, in some embodiments, a glob or bead 50 of the encapsulation material (or “first material” FM) is larger than a bead or wall 130/150 of the second material. This can advantageously provide that the encapsulation material contacts the aerogel sheet, while the second material does not contact the aerogel sheet. In embodiments of this nature, the two extruded deposits may collectively define a cross-sectional mushroom shape. The shape shown in FIG. 58 is merely one example.

With reference to FIG. 59, it can be appreciated that, in certain cases, two extrusion nozzles used to respectively deposit the encapsulation material and the second material have the same orifice size. During extrusion, however, the nozzle used to extrude the second material can be positioned further from the aerogel sheet than is the nozzle used to deposit the encapsulation material. In such cases, the two beads are deposited with an offset. This is another way to provide that the encapsulation material contacts the aerogel sheet, while the second material does not contact the aerogel sheet. If desired, an offset of this nature can be provided in combination with having the glob or bead of the encapsulation material larger than the bead or wall of the second material.

In some embodiments of the present group, after applying the encapsulation material and the second material, the method further comprises joining the glass sheet and the aerogel sheet thereon to a second glass sheet, such that a spacer is adhered therebetween, to form a multiple-pane insulating glazing unit. In embodiments of this nature, the resulting IG unit 100 preferably includes spacer sealant 70 located between the spacer 60/90 and two glass sheets 10/110,120. Preferably, for any embodiment of the present group, the encapsulation material (or “first material” FM) and the second material SM on the glass sheet are discrete from the spacer sealant 70.

Thus, certain embodiments provide a method of making an article, where the method includes adhering a spacer 60/90 onto a first glass sheet 10/110. Preferably, the spacer 60/90 has opposed first and second sides respectively bearing first and second deposits of spacer sealant 70, such that the spacer is adhered onto the first glass sheet 10/110 by pressing the first deposit of spacer sealant against the first glass sheet, thereby creating a glass-aerogel-spacer subassembly. FIGS. 50 and 51 schematically show moving a spacer 60/90 toward and into engagement with a first glass sheet 10/110, and pressing the first deposit of spacer sealant against the first glass sheet. This creates a glass-aerogel-spacer subassembly (see FIG. 51). As noted above, this can be done on an automated basis, e.g., using equipment and methods disclosed in the above-noted U.S. Patent Application Publication No. 2024/0247537 and U.S. Pat. No. 11,536,083. As another option, one or more workers can manually adhere the spacer 60/90 onto the first glass sheet 10/110 by pressing the first deposit of spacer sealant against the first glass sheet. Reference number 254 preferably is a vertical or vertical offset platen (or “backboard”) along which the glass sheets may be supported and conveyed, as is common in conventional IG unit manufacturing lines.

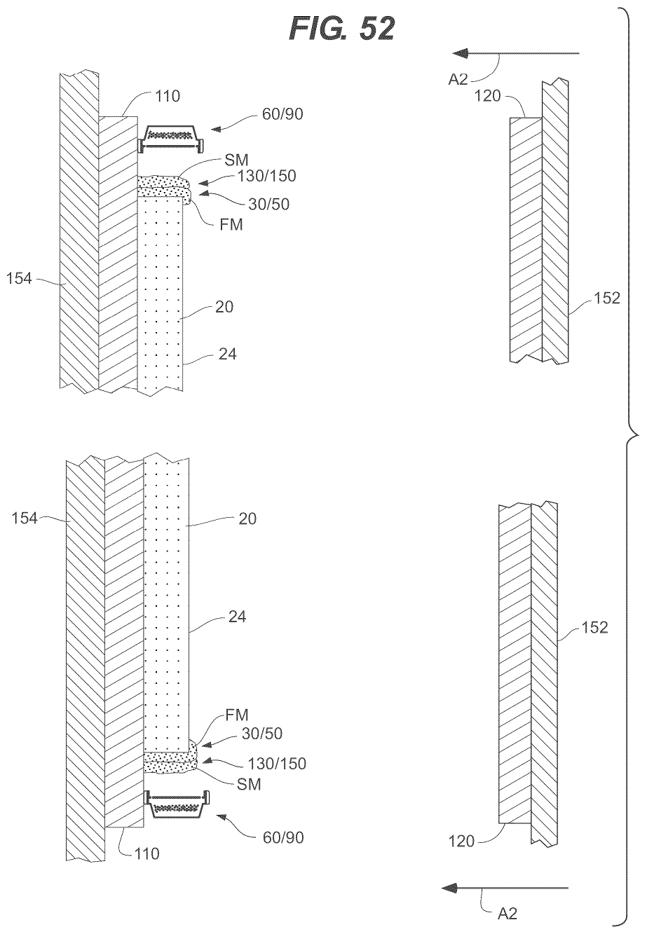

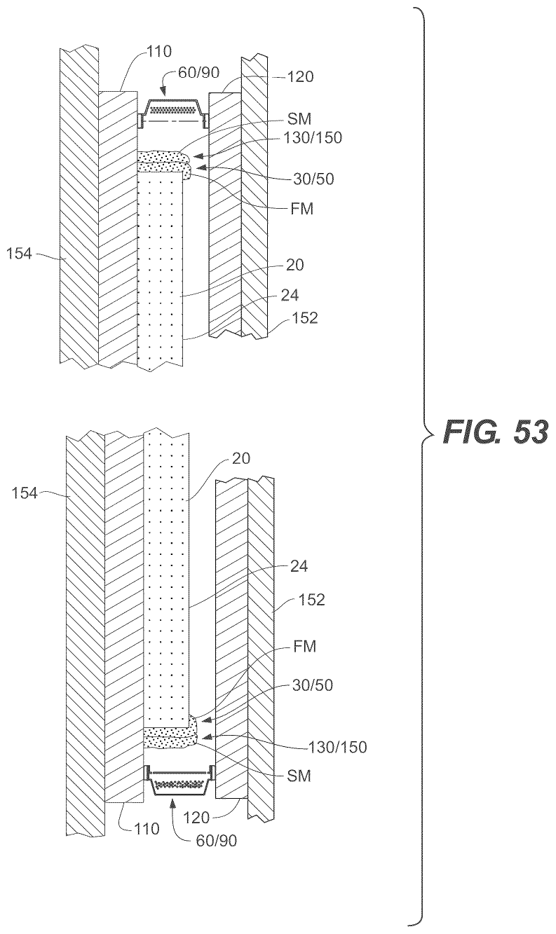

In some embodiments of this nature, the method thereafter comprises performing a coupling operation comprising assembling together a second glass sheet 120 and the glass-aerogel-spacer subassembly. This is schematically shown in FIGS. 52 and 53. In more detail, the coupling operation preferably comprises assembling together the second glass pane 120 and the glass-aerogel-spacer subassembly such that the aerogel sheet 20, encapsulation material FM, and spacer 60/90 are located between the first 10/110 and second 120 glass sheets. In more detail, the coupling operation preferably comprises adhering the second glass sheet 120 onto the spacer 60/90 by pressing the second glass sheet against the second deposit of spacer sealant 70. As one option, the coupling operation may be performed using a machine/method disclosed in the above-noted U.S. Pat. No. 11,168,515. As another option, one or more workers can manually adhere the second glass sheet 120 onto the spacer 60/90 of the glass-aerogel-spacer subassembly by pressing the second glass sheet against the second deposit of spacer sealant 70.

For any embodiment involving a spacer, the spacer 60/90 can have any of various different shapes, types, and configurations. FIG. 21 of the noted U.S. Pat. No. 11,536,083 patent shows several non-limiting examples of spacer types that can be used. In some cases, the spacer comprises or consists of a metal, such as stainless steel or another alloy, aluminum, titanium or another aircraft metal, or some other suitable metal. Reference is made to the first four spacer profiles shown in FIG. 21 of the '083 patent. Alternatively, the spacer can consist of a polymer. Reference is made to the fifth and seventh spacer profiles shown in FIG. 21 of the '083 patent. In other cases, the spacer can comprise both a metal and a polymer. For example, a plastic spacer body can be provided with a metal moisture barrier layer. Reference is made to the sixth spacer profile shown in FIG. 21 of the '083 patent. Another possibility is to use a spacer with two opposed side walls of plastic and two opposed top walls of metal.

As noted above, FIG. 54 shows a multiple-pane insulating glazing unit 100 comprising first 110 and second 120 panes, a spacer 60/90, spacer sealant 70, an aerogel sheet 20, an encapsulation material (or “first material” FM), and a second material SM. The spacer 60/90 maintains the first 110 and second 120 panes in a spaced-apart configuration, such that a between-pane space 140 is located between the first and second panes. The aerogel sheet 20 is located in the between-pane space 140 and retained in a mounted position alongside the first pane 110 (i.e., alongside surface 114). An alternative is to have the aerogel sheet retained in a mounted position alongside the second pane 120 (i.e., alongside surface 122). Still another possibility is to have aerogel sheets mounted alongside both of the surfaces 114 and 122. As described previously, the aerogel sheet 20 comprises a first face 22, a second face 24 and an edge 26 forming an outer perimeter of the aerogel sheet. In the embodiment of FIG. 54, the encapsulation material (or “first material” FM) encapsulates the edge 26 of the aerogel sheet 20 along at least a portion of the outer perimeter, and the second material SM adheres to the first pane, while the encapsulation material and second material adhere together.

In FIG. 54, the encapsulation material (or “first material” FM) and the second material SM are discrete from the spacer sealant 70. In some cases, the first material FM and the second material SM respectively are in the form of an extruded bead of the first material and an extruded bead of the second material. In FIG. 54, for example, the extruded bead of the first material and the extruded bead of the second material are side-by-side extruded beads that extend along the outer perimeter of the aerogel sheet. Here, the spacer sealant 70 is closer to a perimeter edge of the illustrated IG unit than are the side-by-side extruded beads. In some non-limiting examples, the first material FM comprises polyethylene terephthalate glycol, the second material SM comprises polyisobutylene, and the spacer sealant 70 comprises polyisobutylene. It is to be appreciated, however, that any other materials that may be found to satisfy the performance criteria taught herein can be used for the first material FM and/or the second material SM. This is the case for any embodiment of the present disclosure involving the encapsulation material and/or the second material SM.

Furthermore, the embodiment of FIG. 54 is shown also including a secondary sealant 80. When provided (in this embodiment or any other embodiment of the present disclosure), the secondary sealant 80 preferably comprises silicone, although any other known IG unit secondary sealant materials can be used. Similarly, while spacer sealant 70 preferably comprises PIB, other known IG unit primary sealant materials can be used. This is the case for this embodiment and any other embodiment of the present disclosure

Finally, FIG. 55 shows a multiple-pane insulating glazing unit 100 comprising first 110 and second 120 panes, a spacer 60/90, spacer sealant 70, an aerogel sheet, and an encapsulation material (or “first material” FM). The spacer maintains the first 110 and second 120 panes in a spaced-apart configuration, such that a between-pane space 140 is located between the first and second panes. In more detail, a first deposit of the spacer sealant 70 is located between the spacer 60/90 and the first pane 110, and a second deposit of the spacer sealant 70 is located between the spacer and the second pane 120. The illustrated aerogel sheet 20 is located in the between-pane space 140 and retained in a mounted position alongside the first pane 110. An alternative is to have the aerogel sheet retained in a mounted position alongside the second pane 120 (i.e., alongside surface 122). Still another possibility is to have aerogel sheets mounted alongside both of the surfaces 114 and 122. As described previously, the aerogel sheet 20 comprises a first face 22, a second face 24 and an edge 26 forming an outer perimeter of the aerogel sheet. The encapsulation material encapsulates the edge of the aerogel sheet along at least a portion of the outer perimeter. Here, the illustrated encapsulation material FM contacts the first glass sheet 110. Furthermore, in this embodiment, the encapsulation material adheres to the first deposit of the spacer sealant 70. It is also shown adhering to the spacer. In one variant (not shown), the encapsulation material FM adheres to the adjacent spacer sealant 70, but is deposited/configured so as not to contact the spacer. In FIG. 55, the first deposit of the spacer sealant 70 has an enlarged configuration, such that it projects inwardly beyond the spacer 60/90. This is one option for providing that the encapsulation material and the adjacent spacer sealant 70 adhere together.

In FIG. 55, the spacer sealant 70 is closer to a perimeter edge of the IG unit than is the encapsulation material (or “first material” FM). Here, the encapsulation material preferably adheres to the first pane 110, and the spacer sealant 70 does not contact the aerogel sheet 20.

As illustrated, the spacer 60/90 preferably has a hollow interior containing desiccant material 150. In such cases, the spacer 60/90 preferably includes a plurality of openings MP providing gaseous communication between the between-pane space 140 and the hollow spacer interior containing the desiccant material 150. In embodiments where the encapsulation material contacts the spacer 60/90 and/or the spacer sealant 70, the encapsulation material preferably does not block the openings MP.

In FIG. 55, the encapsulation material preferably is in the form of an extruded bead or glob of the encapsulation material. In certain preferred examples, the encapsulation material (or “first material” FM) comprises polyethylene terephthalate glycol, and the spacer sealant 70 comprises polyisobutylene. It is to be appreciated, however, that any other materials that may be found to satisfy the performance criteria taught herein can be used for the encapsulation material and/or spacer sealant 70. Furthermore, the embodiment of FIG. 55 is shown also including a secondary sealant 80. When provided, the secondary sealant 80 preferably comprises silicone, although any other known IG unit secondary sealant materials can be used.

While some preferred embodiments of the invention have been described, it should be understood that various changes, adaptations and modifications may be made therein without departing from the spirit of the invention and the scope of the appended claims.

### EMBODIMENTS

### Group 1

1. An article, comprising:
   a glass sheet;
   an aerogel sheet comprising a first face, a second face, and an edge forming an outer perimeter of the aerogel sheet, wherein the first face of the aerogel sheet is in contact with the glass sheet; and
   an encapsulation material encapsulates the edge of the aerogel sheet along at least a portion of the outer perimeter.
2. The article of claim 1 wherein the aerogel sheet is devoid of degradation visible to the naked eye.
3. The article of claim 1 or 2 wherein the encapsulation material encapsulates the edge of the aerogel sheet along an entirety of the outer perimeter.
4. The article of any one of the preceding claims wherein an entirety of the first face of the aerogel sheet is in contact with the glass sheet.
5. The article of any one of the preceding claims wherein the encapsulation material consists essentially of organic material that is chemically and physically compatible with the aerogel sheet.
6. The article of claim 5 wherein the aerogel sheet is a hydrophilic silica aerogel sheet, and the organic material is chemically compatible with hydroxyl functional groups of the hydrophilic silica aerogel sheet.
7. The article of claim 5 wherein the aerogel sheet is a hydrophobic silica aerogel sheet, and the organic material is chemically compatible with methyl functional groups of the hydrophobic silica aerogel sheet.
8. The article of any one of the preceding claims wherein the organic material is physically compatible with pores of the aerogel sheet.
9. The article of any one of the preceding claims wherein the organic material is in contact with the aerogel sheet.
10. The article of any one of the preceding claims wherein the organic material comprises polyethylene terephthalate glycol.
11. The article of claim 10 wherein the polyethylene terephthalate glycol is extruded polyethylene terephthalate glycol.
12. The article of any one of the preceding claims wherein the aerogel sheet comprises silica aerogel.
13. The article of claim 12 wherein the silica aerogel comprises silica aerogel synthesized from methyl silicate 51.
14. The article of any one of the preceding claims wherein the encapsulation material is bonded to the glass sheet.
15. A multiple-pane insulating glazing unit comprising first and second panes, a spacer, spacer sealant, an aerogel sheet, and an organic material, the spacer maintaining the first and second panes in a spaced-apart configuration such that a between-pane space is located between the first and second panes, the aerogel sheet being located in the between-pane space and retained in a mounted position alongside the first pane, the aerogel sheet comprising a first face, a second face and an edge forming an outer perimeter of the aerogel sheet, such that the organic material encapsulates the edge of the aerogel sheet along at least a portion of the outer perimeter.
16. The multiple-pane insulating glazing unit of claim 15 wherein the aerogel sheet is devoid of degradation visible to the naked eye.
17. The multiple-pane insulating glazing unit of claim 15 or 16 wherein the organic material encapsulates the edge of the aerogel sheet along an entirety of the outer perimeter.
18. The multiple-pane insulating glazing unit of any one of the preceding claims wherein an entirety of the first face of the aerogel sheet is in contact with the first pane.
19. The multiple-pane insulating glazing unit of any one of the preceding claims wherein a gas gap exists between the second face of the aerogel sheet and the second pane.
20. The multiple-pane insulating glazing unit of any one of the preceding claims wherein the organic material is bonded to the first pane.
21. The multiple-pane insulating glazing unit of any one of the preceding claims wherein the organic material is in contact with a portion of the aerogel sheet.
22. The multiple-pane insulating glazing unit of any one of the preceding claims wherein the organic material is bonded to the portion of the aerogel sheet.
23. The multiple-pane insulating glazing unit of any one of the preceding claims wherein the organic material is spaced apart from the spacer sealant.
24. The multiple-pane insulating glazing unit of any one of the preceding claims wherein the spacer sealant comprises polyisobutylene.
25. The multiple-pane insulating glazing unit of any one of the preceding claims wherein the aerogel sheet is a hydrophilic silica aerogel sheet and the organic material is chemically compatible with hydroxyl functional groups of the hydrophilic silica aerogel sheet.
26. The multiple-pane insulating glazing unit of any one of the preceding claims wherein the aerogel sheet is a hydrophobic silica aerogel sheet and the organic material is chemically compatible with methyl functional groups of the hydrophobic silica aerogel sheet.
27. The multiple-pane insulating glazing unit of any one of the preceding claims wherein the organic material is physically compatible with pores of the aerogel sheet.
28. The multiple-pane insulating glazing unit of any one of the preceding claims wherein the organic material is chemically compatible with the spacer sealant.
29. The multiple-pane insulating glazing unit of any one of the preceding claims wherein the spacer sealant comprises polyisobutylene.
30. The multiple-pane insulating glazing unit of any one of the preceding claims wherein the organic material does not outgas.
31. The multiple-pane insulating glazing unit of any one of the preceding claims further comprising a low-emissivity coating, the low-emissivity coating including at least one film comprising silver, wherein the organic material does not release moisture to the between-pane space in an amount that corrodes the low-emissivity coating.
32. The multiple-pane insulating glazing unit of any one of the preceding claims wherein the organic material does not release moisture to the between-pane space in an amount that degrades the spacer sealant.
33. The multiple-pane insulating glazing unit of any one of the preceding claims wherein the spacer sealant comprises polyisobutylene.
34. The multiple-pane insulating glazing unit of any one of the preceding claims wherein the organic material does not degrade upon exposure to ultraviolet radiation within the between-pane space.
35. The multiple-pane insulating glazing unit of any one of the preceding claims wherein the organic material comprises polyethylene terephthalate glycol.
36. The multiple-pane insulating glazing unit of claim 35 wherein the polyethylene terephthalate glycol is extruded polyethylene terephthalate glycol.
37. The multiple-pane insulating glazing unit of any one of the preceding claims wherein the organic material defines a bead.
38. The multiple-pane insulating glazing unit of claim 37 wherein the bead contacts a wall of the spacer and a portion of the second face of the aerogel sheet.
39. The multiple-pane insulating glazing unit of claim 37 or 38 wherein the bead is bonded to the wall of the spacer and the portion of the second face of the aerogel sheet.
40. The multiple-pane insulating glazing unit of any one of the preceding claims wherein the bead engages a wall of the spacer, a portion of the first pane, and a portion of the second face of the aerogel sheet.
41. The multiple-pane insulating glazing unit of any one of the preceding claims wherein the bead is bonded to the wall of the spacer, the portion of the first pane, and the portion of the second face of the aerogel sheet.
42. The multiple-pane insulating glazing unit of any one of the preceding claims wherein the aerogel sheet comprises silica aerogel.
43. The multiple-pane insulating glazing unit of claim 42 wherein the silica aerogel is silica aerogel synthesized from methyl silicate 51.

### Group 2

1. A method of making an article, comprising:
   positioning an aerogel sheet on a glass sheet, the aerogel sheet comprising a first face, a second face, and an edge forming an outer perimeter of the aerogel sheet; and
   applying a material comprising polyethylene terephthalate glycol to encapsulate the edge along at least a portion of the outer perimeter of the aerogel sheet.
2. The method of claim 1 wherein the step of applying the material comprising polyethylene terephthalate glycol encapsulates the edge along an entirety of the outer perimeter of the aerogel sheet.
3. The method of claim 1 or 2 wherein the step of positioning the aerogel sheet on the glass sheet comprises positioning an entirety of the first face of the aerogel sheet on the glass sheet.
4. The method of any one of the preceding claims wherein the step of applying the material comprising polyethylene terephthalate glycol places the aerogel sheet in contact with the material comprising polyethylene terephthalate glycol without any resulting degradation of the aerogel sheet.
5. The method of any one of the preceding claims wherein the step of applying the material comprising polyethylene terephthalate glycol bonds the aerogel sheet to the material comprising polyethylene terephthalate glycol without any resulting degradation of the aerogel sheet.
6. The method of any one of the preceding claims wherein the step of applying the material comprising polyethylene terephthalate glycol bonds the aerogel sheet to the material comprising polyethylene terephthalate glycol without any resulting cracking of the aerogel sheet.
7. The method of any one of the preceding claims wherein the step of applying the material comprising polyethylene terephthalate glycol comprises applying the polyethylene terephthalate glycol in a heated state such that it becomes compatible with the thermal expansion coefficient of the aerogel sheet before contacting the aerogel sheet.
8. The method of any one of the preceding claims wherein the step of applying the material comprising polyethylene terephthalate glycol comprises applying the polyethylene terephthalate glycol in a heated state such that it has a temperature within a range of from 150° C. to 194° C. upon contacting the aerogel sheet.
9. The method of any one of the preceding claims wherein the step of applying the material comprising polyethylene terephthalate glycol includes dispensing heated polyethylene terephthalate glycol from a nozzle such that it has a temperature within the range of from 150° C. to 194° C. upon contacting the aerogel sheet.
10. The method of any one of the preceding claims wherein the step of applying the material comprising polyethylene terephthalate glycol includes dispensing heated polyethylene terephthalate glycol from a nozzle while maintaining a gap distance between the nozzle and the second face of the aerogel sheet, such that the heated polyethylene terephthalate glycol dispensed from the nozzle cools while moving between the nozzle and the second face of the aerogel sheet.
11. The method of claim 10 wherein the gap distance is maintained so as to allow the heated polyethylene terephthalate glycol to begin curing before coming into contact with the second face of the aerogel sheet.
12. The method of claim 10 or 11 wherein the heated polyethylene terephthalate glycol, upon leaving the nozzle, is at a temperature in a range of from 185° C. to 250° C. and the gap distance is in a range of from 1 mm to 4 mm.
13. The method of any one of the preceding claims wherein the gap distance is in a range of from greater than 4 mm to 6 mm.
14. The method of any one of the preceding claims wherein the gap distance is in a range of from 4.2 mm to 5.6 mm.
15. The method of any one of the preceding claims wherein the heated polyethylene terephthalate glycol, upon leaving the nozzle, is at a temperature in a range of from 185° C. to 250° C.
16. The method of any one of the preceding claims wherein the nozzle has an orifice size in a range of from 0.4 mm to 10 mm.
17. The method of claim 16 wherein the orifice size is in a range of from 5 mm to 10 mm.
18. The method of any one of the preceding claims wherein the heated polyethylene terephthalate glycol, upon contacting the second face of the aerogel sheet, is at a temperature in a range of from 150° C. to 194° C.
19. A method of making an article, comprising:
   positioning an aerogel sheet on a glass sheet, the aerogel sheet comprising a first face, a second face, and an edge forming an outer perimeter of the aerogel sheet; and
   dispensing heated organic material to encapsulate the edge along at least a portion of the outer perimeter of the aerogel sheet, wherein the dispensing involves dispensing the heated organic material from a nozzle while maintaining a gap distance between the nozzle and the aerogel sheet, such that the heated organic material cools while moving between the nozzle and the aerogel sheet.
20. The method of claim 19 wherein the gap distance is maintained so as to allow the heated organic material to begin curing before contacting the aerogel sheet.
21. The method of claim 19 or 20 wherein the heated organic material, upon contacting the aerogel sheet, is in a partially cured state such that it bonds to the aerogel sheet without any resulting degradation of the aerogel sheet.
22. The method of any one of the preceding claims wherein the heated organic material, upon contacting the aerogel sheet, is in a partially cured state such that it bonds to the aerogel sheet without any resulting cracking of the aerogel sheet.
23. The method of any one of the preceding claims wherein the gap distance is in a range of from 1 mm to 6 mm.
24. The method of any one of the preceding claims wherein the gap distance is in a range of from greater than 4 mm to 6 mm.
25. The method of any one of the preceding claims wherein the gap distance is in a range of from 4.2 mm to 5.6 mm.
26. The method of any one of the preceding claims wherein the heated organic material, upon leaving the nozzle, is at a temperature in a range of from 185° C. to 250° C.
27. The method of any one of the preceding claims wherein the heated organic material, upon contacting the aerogel sheet, is at a temperature in a range of from 120° C. to 195° C.
28. The method of any one of the preceding claims wherein the heated organic material, upon contacting the aerogel sheet, is at a temperature in a range of from 150° C. to 194° C.
29. The method of any one of the preceding claims wherein the nozzle has an orifice size in a range of from 0.4 mm to 10 mm.
30. The method of any one of the preceding claims wherein the nozzle has an orifice size in a range of from 5 mm to 10 mm.
31. The method of any one of the preceding claims wherein the aerogel sheet comprises silica aerogel.
32. The method of claim 31 wherein the silica aerogel comprises silica aerogel synthesized from methyl silicate 51.
33. The method of any one of the preceding claims wherein the heated organic material comprises heated polyethylene terephthalate glycol.
34. The method of claim 33 wherein the heated polyethylene terephthalate glycol, upon contacting aerogel sheet, is at a temperature in a range of from 150° C. to 194° C.
35. The method of claim 33 or 34 wherein, upon leaving the nozzle, the polyethylene terephthalate glycol is at a temperature in a range of from 185° C. to 250° C. and the gap distance is in a range of from 1 mm to 4 mm.
36. The method of any one of the preceding claims wherein, upon leaving the nozzle, the polyethylene terephthalate glycol is at a temperature in a range of from 185° C. to 250° C. and the gap distance is in a range of greater than 4 mm to 6 mm.
37. The method of any one of the preceding claims wherein the polyethylene terephthalate glycol, upon contacting the aerogel sheet, is at a temperature in a range of from 150° C. to 194° C.
38. The method of any one of the preceding claims wherein the gap distance is in a range of from 4.2 mm to 5.6 mm.
39. The method of any one of the preceding claims wherein the nozzle has an orifice size in a range of from 5 mm to 10 mm.
40. The method of any one of the preceding claims wherein the step of positioning the aerogel sheet on the glass sheet comprises positioning an entirety of the first face of the aerogel sheet on the glass sheet.
41. The method of any one of the preceding claims wherein some of the heated organic material contacts the second face of the aerogel sheet, the first face of the aerogel sheet being in contact with the glass sheet, the second face of the aerogel sheet facing away from the glass sheet.

### Group 3

1. A method of making an article, comprising:
   providing an aerogel sheet on a glass sheet, the aerogel sheet comprising a first face, a second face, and an edge forming an outer perimeter of the aerogel sheet; and
   applying a first material to encapsulate the edge along at least a portion of the outer perimeter of the aerogel sheet.
2. The method of claim 1 wherein the glass sheet and the aerogel sheet thereon are maintained in a horizontal position during said applying the first material to encapsulate the edge.
3. The method of claim 1 or 2 wherein said applying the first material is carried out while the first material is at elevated temperature.
4. The method of any one of the preceding claims wherein said applying the first material is carried out while the glass sheet is at elevated temperature.
5. The method of any one of the preceding claims wherein the glass sheet is on a heated bed during said applying the first material.
6. The method of any one of the preceding claims wherein said applying the first material to encapsulate the edge comprises extruding the first material over the edge.
7. The method of any one of the preceding claims wherein the first material comprises polyethylene terephthalate glycol.
8. The method of any one of the preceding claims wherein said applying the first material to encapsulate the edge comprises extruding the first material to form an extruded deposit, and the method further comprises forming gas-passage openings in the extruded deposit.
9. The method of claim 8 wherein said forming gas-passage openings in the extruded deposit comprises a needling operation in which a plurality of needles penetrates the extruded deposit to form the gas-passage openings.
10. The method of claim 9 wherein the needling operation comprises rolling a micro-needle roller on the extruded deposit.
11. The method of any one of the preceding claims further comprising applying a second material onto the glass sheet, wherein said applying the first material and said applying the second material are carried out such that: (i) the first material adheres to the aerogel sheet, (ii) the second material adheres to the glass sheet, and (iii) the first and second materials adhere together.
12. The method of claim 11 wherein the second material does not contact the aerogel sheet.
13. The method of claim 11 or 12 wherein said applying the second material comprises either extruding the second material onto the glass sheet or adhering an adhesive tape onto the glass sheet.
14. The method of any one of the preceding claims wherein said applying the second material comprises extruding the second material onto the glass sheet, the second material comprising polyisobutylene.
15. The method of any one of the preceding claims wherein said applying the first material comprises extruding the first material, the first material comprising polyethylene terephthalate glycol.
16. The method of any one of the preceding claims wherein said applying the first material and said applying the second material comprise extruding the first material while simultaneously extruding the second material.
17. The method of claim 16 wherein said extruding the first material while simultaneously extruding the second material is carried out using a dual-nozzle dispenser having a first nozzle extruding the first material while a second nozzle simultaneously extrudes the second material.
18. The method of claim 16 or 17 wherein said extruding the first material while simultaneously extruding the second material is completed by moving the dual-nozzle dispenser in a single pass about the outer perimeter of the aerogel sheet.
19. The method of any one of the preceding claims wherein, after said applying the first material and after said applying the second material, the method further comprises joining the glass sheet and the aerogel sheet thereon to a second glass sheet with a spacer adhered therebetween so as to form a multiple-pane insulating glazing unit, such that the multiple-pane insulating glazing unit includes spacer sealant located between the spacer and both said glass sheets, the first and second materials being discrete from the spacer sealant.
20. The method of any one of the preceding claims wherein, after said applying the first material, the method further comprises moving the glass sheet and the aerogel sheet thereon from the horizontal position to a vertical or vertical-offset position and, while the glass sheet and the aerogel sheet thereon are in the vertical or vertical-offset position, joining the glass sheet and the aerogel sheet thereon to a second glass sheet with a spacer adhered therebetween.
21. A method of making an article, comprising:
   providing an aerogel sheet on a glass sheet, the aerogel sheet comprising a first face, a second face, and an edge forming an outer perimeter of the aerogel sheet; and
   extruding: (i) a first material to encapsulate the edge along at least a portion of the outer perimeter of the aerogel sheet, and (ii) a second material onto the glass sheet, such that: (a) the first material adheres to the aerogel sheet, (b) the second material adheres to the glass sheet, and (c) the first and second materials adhere together.
22. The method of claim 21 wherein the second material does not contact the aerogel sheet.
23. The method of claim 21 or 22 wherein said extruding the first material and the second material are carried out simultaneously using a dual-nozzle dispenser having a first nozzle extruding the first material while a second nozzle simultaneously extrudes the second material.
24. The method of claim 23 wherein said extruding the first material while simultaneously extruding the second material is completed by moving the dual-nozzle dispenser in a single pass about the outer perimeter of the aerogel sheet.
25. The method of any one of the preceding claims wherein the first material comprises polyethylene terephthalate glycol.
26. The method of any one of the preceding claims wherein the second material comprises polyisobutylene.
27. The method of any one of the preceding claims wherein the method further comprises adhering a spacer to the glass sheet, the spacer having two opposed sides respectively bearing two deposits of spacer sealant, and wherein said adhering the spacer to the glass sheet comprises pressing a desired one of the two deposits of spacer sealant against the glass sheet, such that the desired one of the two deposits of spacer sealant is adjacent to a perimeter edge of the glass sheet and surrounds both the aerogel sheet and the second material.
28. The method of claim 27 wherein the two deposits of spacer sealant both comprise polyisobutylene, and the second material comprises polyisobutylene, the first and second materials being discrete from the spacer sealant.
29. The method of any one of the preceding claims wherein the first material comprises polyethylene terephthalate glycol.
30. The method of any one of the preceding claims wherein the glass sheet and the aerogel sheet thereon are in a horizontal position during said extruding the first material and the second material.
31. The method of any one of the preceding claims wherein, after said extruding the first material and the second material, the method further comprises moving the glass sheet and the aerogel sheet thereon from the horizontal position to a vertical or vertical-offset position and, while the glass sheet and the aerogel sheet thereon are in the vertical or vertical-offset position, the method further comprises adhering a spacer to the glass sheet, the spacer having two opposed sides respectively bearing two deposits of spacer sealant, and wherein said adhering the spacer to the glass sheet comprises pressing a desired one of the two deposits of spacer sealant against the glass sheet.
32. The method of any one of the preceding claims further comprising joining the glass sheet to a second glass sheet with the spacer adhered therebetween.
33. The method of claim 32 further comprising depositing a secondary spacer sealant comprising silicone in a perimeter gap that is bounded collectively by the spacer and interior perimeter surface areas of said two glass sheets.

### Group 4

1. A multiple-pane insulating glazing unit comprising first and second panes, a spacer, spacer sealant, an aerogel sheet, a first material, and a second material, the spacer maintaining the first and second panes in a spaced-apart configuration such that a between-pane space is located between the first and second panes, the aerogel sheet being located in the between-pane space and retained in a mounted position alongside the first pane, the aerogel sheet comprising a first face, a second face and an edge forming an outer perimeter of the aerogel sheet, wherein the first material encapsulates the edge of the aerogel sheet along at least a portion of the outer perimeter, and the second material adheres to the first pane, while the first and second materials adhere together.
2. The multiple-pane insulating glazing unit of claim 1 wherein the first and second materials are discrete from the spacer sealant.
3. The multiple-pane insulating glazing unit of claim 1 or 2 wherein the spacer has two opposed sides respectively bearing two deposits of the spacer sealant, wherein a first of the two deposits of the spacer sealant is located between the spacer and the first pane, and a second of the two deposits of the spacer sealant is located between the spacer and the second pane, such that the first of the two deposits of the spacer sealant is adjacent to a perimeter edge of the first pane and surrounds both the aerogel sheet and the second material.
4. The multiple-pane insulating glazing unit of any one of the preceding claims comprising a secondary spacer sealant in a perimeter gap bounded collectively by the spacer and interior perimeter surface areas of the first and second panes, the secondary spacer sealant comprising silicone.
5. The multiple-pane insulating glazing unit of any one of the preceding claims wherein there is a gas gap between the aerogel sheet and the second pane.
6. The multiple-pane insulating glazing unit of any one of the preceding claims wherein the first and second materials respectively are in the form of an extruded bead of the first material and an extruded bead of the second material.
7. The multiple-pane insulating glazing unit of claim 6 wherein the extruded bead of the first material and the extruded bead of the second material are side-by-side extruded beads that extend along the outer perimeter of the aerogel sheet.
8. The multiple-pane insulating glazing unit of claim 6 or 7 wherein the extruded bead of the first material is on top of the extruded bead of the second material.
9. The multiple-pane insulating glazing unit of any one of the preceding claims wherein the spacer sealant is closer to a perimeter edge of the multiple-pane insulating glazing unit than are the extruded bead of the first material and the extruded bead of the second material.
10. The multiple-pane insulating glazing unit of any one of the preceding claims wherein the first material comprises polyethylene terephthalate glycol, the second material comprises polyisobutylene, and the spacer sealant comprises polyisobutylene.
11. The multiple-pane insulating glazing unit of any one of the preceding claims wherein the multiple-pane insulating glazing unit is a triple-pane insulating glazing unit that further includes a third pane, the first, second, and third panes being glass panes.
12. A multiple-pane insulating glazing unit comprising first and second panes, a spacer, spacer sealant, an aerogel sheet, and an encapsulation material, the spacer maintaining the first and second panes in a spaced-apart configuration such that a between-pane space is located between the first and second panes, wherein a first deposit of the spacer sealant is located between the spacer and the first pane, and a second deposit of the spacer sealant is located between the spacer and the second pane, the aerogel sheet being located in the between-pane space and retained in a mounted position alongside the first pane, the aerogel sheet comprising a first face, a second face and an edge forming an outer perimeter of the aerogel sheet, wherein the encapsulation material encapsulates the edge of the aerogel sheet along at least a portion of the outer perimeter, and the encapsulation material adheres to the first deposit of the spacer sealant, adheres to the spacer, or adheres to both the first deposit of the spacer sealant and the spacer.
13. The multiple-pane insulating glazing unit of claim 12 wherein the spacer sealant does not contact the aerogel sheet.
14. The multiple-pane insulating glazing unit of claim 12 or 13 wherein the spacer sealant is closer to a perimeter edge of the multiple-pane insulating glazing unit than is the encapsulation material.
15. The multiple-pane insulating glazing unit of any one of the preceding claims comprising a secondary spacer sealant in a perimeter gap bounded collectively by the spacer and interior perimeter surface areas of the first and second panes, the secondary spacer sealant comprising silicone.
16. The multiple-pane insulating glazing unit of any one of the preceding claims wherein the spacer has a hollow spacer interior containing a desiccant material, the spacer includes a plurality of openings providing gaseous communication between the between-pane space and the hollow spacer interior containing the desiccant material, and the encapsulation material does not block the plurality of openings.
17. The multiple-pane insulating glazing unit of any one of the preceding claims wherein there is a gas gap between the aerogel sheet and the second pane.
18. The multiple-pane insulating glazing unit of any one of the preceding claims wherein the encapsulation material is in the form of an extruded bead of the encapsulation material.
19. The multiple-pane insulating glazing unit of any one of the preceding claims wherein the encapsulation material comprises polyethylene terephthalate glycol, and the spacer sealant comprises polyisobutylene.
20. The multiple-pane insulating glazing unit of any one of the preceding claims wherein the multiple-pane insulating glazing unit is a triple-pane insulating glazing unit that further includes a third pane, the first, second, and third panes being glass panes.
21. A method of making an article, comprising:
   (a) providing an aerogel sheet on a first glass sheet, the aerogel sheet comprising a first face, a second face, and an edge forming an outer perimeter of the aerogel sheet;
   (b) applying an encapsulation material to encapsulate the edge along at least a portion of the outer perimeter of the aerogel sheet; and
   (c) adhering a spacer onto the first glass sheet, the spacer having opposed first and second sides respectively bearing first and second deposits of spacer sealant, such that said adhering the spacer onto the first glass sheet comprises pressing the first deposit of spacer sealant against the first glass sheet;
   thereby creating a glass-aerogel-spacer subassembly, and thereafter;
   performing a coupling operation comprising assembling together a second glass pane and the glass-aerogel-spacer subassembly, such that the aerogel sheet, the encapsulation material, and the spacer are located between the first and second glass sheets.
22. The method of claim 21 wherein said coupling operation comprises adhering the second glass sheet onto the spacer by pressing the second glass sheet against the second deposit of spacer sealant.
23. The method of claim 21 or 22 wherein said applying the encapsulation material is carried out while the first glass sheet and the aerogel sheet thereon are in a horizontal position, whereas said adhering the spacer onto the first glass sheet is carried out while the first glass sheet and the aerogel sheet thereon are in a vertical or vertical-offset position.
24. The method of any one of the preceding claims wherein, after said applying the encapsulation material and prior to said adhering the spacer onto the first glass sheet, the method comprises moving the first glass sheet and the aerogel sheet thereon from the horizontal position to the vertical or vertical-offset position.
25. The method of any one of the preceding claims wherein said applying the encapsulation material comprises extruding the encapsulation material over the edge, the encapsulation material comprising polyethylene terephthalate glycol.
26. The method of any one of the preceding claims further comprising applying a second material onto the first glass sheet, wherein said applying the encapsulation material and said applying the second material are carried out such that: (i) the encapsulation material adheres to the aerogel sheet, (ii) the second material adheres to the first glass sheet, and (iii) the encapsulation material and the second material adhere together.
27. The method of claim 26 wherein the second material does not contact the aerogel sheet.
28. The method of claim 26 or 27 wherein said applying the second material comprises either extruding the second material onto the first glass sheet or adhering an adhesive tape onto the first glass sheet.
29. The method of any one of the preceding claims wherein said applying the encapsulation material and said applying the second material comprise extruding the encapsulation material while simultaneously extruding the second material.
30. The method of claim 29 wherein said extruding the encapsulation material while simultaneously extruding the second material is carried out using a dual-nozzle dispenser having a first nozzle extruding the encapsulation material while a second nozzle simultaneously extrudes the second material.
31. The method of claim 29 or 30 wherein said extruding the encapsulation material while simultaneously extruding the second material is completed by moving the dual-nozzle dispenser in a single pass about the outer perimeter of the aerogel sheet.
32. The method of any one of the preceding claims wherein said applying the encapsulation material and said applying the second material respectively deposit an extruded bead of the encapsulation material and an extruded bead of the second material, such that the extruded bead of the encapsulation material and the extruded bead of the second material are side-by-side extruded beads that extend along the outer perimeter of the aerogel sheet.
33. The method of claim 32 wherein, in the glass-aerogel-spacer subassembly, the first deposit of spacer sealant surrounds the side-by-side extruded beads.
34. The method of any one of the preceding claims wherein, in the glass-aerogel-spacer subassembly, the encapsulation material and the first deposit of spacer sealant adhere together.

What is claimed is:

1. An article, comprising:
a glass sheet;
an aerogel sheet comprising a first face, a second face, and an edge forming an outer perimeter of the aerogel sheet, wherein the first face of the aerogel sheet is in contact with the glass sheet; and
an encapsulation material encapsulates the edge of the aerogel sheet along at least a portion of the outer perimeter.

2. The article of claim 1 wherein the aerogel sheet is devoid of degradation visible to the naked eye.

3. The article of claim 1 wherein the encapsulation material encapsulates the edge of the aerogel sheet along an entirety of the outer perimeter.

4. The article of claim 1 wherein an entirety of the first face of the aerogel sheet is in contact with the glass sheet.

5. The article of claim 1 wherein the encapsulation material consists essentially of organic material that is chemically and physically compatible with the aerogel sheet.

6. The article of claim 5 wherein the aerogel sheet is a hydrophilic silica aerogel sheet, and the organic material is chemically compatible with hydroxyl functional groups of the hydrophilic silica aerogel sheet.

7. The article of claim 5 wherein the aerogel sheet is a hydrophobic silica aerogel sheet, and the organic material is chemically compatible with methyl functional groups of the hydrophobic silica aerogel sheet.

8. The article of claim 5 wherein the organic material is physically compatible with pores of the aerogel sheet.

9. The article of claim 5 wherein the organic material is in contact with the aerogel sheet.

10. The article of claim 5 wherein the organic material comprises polyethylene terephthalate glycol.

11. The article of claim 10 wherein the polyethylene terephthalate glycol is extruded polyethylene terephthalate glycol.

12. The article of claim 1 wherein the aerogel sheet comprises silica aerogel.

13. The article of claim 12 wherein the silica aerogel comprises silica aerogel synthesized from methyl silicate 51.

14. The article of claim 1 wherein the encapsulation material is bonded to the glass sheet.

15. A multiple-pane insulating glazing unit comprising first and second panes, a spacer, spacer sealant, an aerogel sheet, and an organic material, the spacer maintaining the first and second panes in a spaced-apart configuration such that a between-pane space is located between the first and second panes, the aerogel sheet being located in the between-pane space and retained in a mounted position alongside the first pane, the aerogel sheet comprising a first face, a second face and an edge forming an outer perimeter of the aerogel sheet, such that the organic material encapsulates the edge of the aerogel sheet along at least a portion of the outer perimeter.

16. The multiple-pane insulating glazing unit of claim 15 wherein the aerogel sheet is devoid of degradation visible to the naked eye.

17. The multiple-pane insulating glazing unit of claim 15 wherein the organic material encapsulates the edge of the aerogel sheet along an entirety of the outer perimeter.

18. The multiple-pane insulating glazing unit of claim 15 wherein an entirety of the first face of the aerogel sheet is in contact with the first pane.

19. The multiple-pane insulating glazing unit of claim 15 wherein a gas gap exists between the second face of the aerogel sheet and the second pane.

20. The multiple-pane insulating glazing unit of claim 15 wherein the organic material is bonded to the first pane.

21. The multiple-pane insulating glazing unit of claim 15 wherein the organic material is in contact with a portion of the aerogel sheet.

22. The multiple-pane insulating glazing unit of claim 21 wherein the organic material is bonded to the portion of the aerogel sheet.

23. The multiple-pane insulating glazing unit of claim 15 wherein the organic material is spaced apart from the spacer sealant.

24. The multiple-pane insulating glazing unit of claim 23 wherein the spacer sealant comprises polyisobutylene.

25. The multiple-pane insulating glazing unit of claim 15 wherein the aerogel sheet is a hydrophilic silica aerogel sheet and the organic material is chemically compatible with hydroxyl functional groups of the hydrophilic silica aerogel sheet.

26. The multiple-pane insulating glazing unit of claim 15 wherein the aerogel sheet is a hydrophobic silica aerogel sheet and the organic material is chemically compatible with methyl functional groups of the hydrophobic silica aerogel sheet.

27. The multiple-pane insulating glazing unit of claim 15 wherein the organic material is physically compatible with pores of the aerogel sheet.

28. The multiple-pane insulating glazing unit of claim 15 wherein the organic material is chemically compatible with the spacer sealant.

29. The multiple-pane insulating glazing unit of claim 28 wherein the spacer sealant comprises polyisobutylene.

30. The multiple-pane insulating glazing unit of claim 15 wherein the organic material does not outgas.

31. The multiple-pane insulating glazing unit of claim 15 further comprising a low-emissivity coating, the low-emissivity coating including at least one film comprising silver, wherein the organic material does not release moisture to the between-pane space in an amount that corrodes the low-emissivity coating.

32. The multiple-pane insulating glazing unit of claim 15 wherein the organic material does not release moisture to the between-pane space in an amount that degrades the spacer sealant.

33. The multiple-pane insulating glazing unit of claim 32 wherein the spacer sealant comprises polyisobutylene.

34. The multiple-pane insulating glazing unit of claim 15 wherein the organic material does not degrade upon exposure to ultraviolet radiation within the between-pane space.

35. The multiple-pane insulating glazing unit of claim 15 wherein the organic material comprises polyethylene terephthalate glycol.

36. The multiple-pane insulating glazing unit of claim 35 wherein the polyethylene terephthalate glycol is extruded polyethylene terephthalate glycol.

37. The multiple-pane insulating glazing unit of claim 15 wherein the organic material defines a bead.

38. The multiple-pane insulating glazing unit of claim 37 wherein the bead contacts a wall of the spacer and a portion of the second face of the aerogel sheet.

39. The multiple-pane insulating glazing unit of claim 38 wherein the bead is bonded to the wall of the spacer and the portion of the second face of the aerogel sheet.

40. The multiple-pane insulating glazing unit of claim 37 wherein the bead engages a wall of the spacer, a portion of the first pane, and a portion of the second face of the aerogel sheet.

41. The multiple-pane insulating glazing unit of claim 40 wherein the bead is bonded to the wall of the spacer, the portion of the first pane, and the portion of the second face of the aerogel sheet.

42. The multiple-pane insulating glazing unit of claim 15 wherein the aerogel sheet comprises silica aerogel.

43. The multiple-pane insulating glazing unit of claim 42 wherein the silica aerogel is silica aerogel synthesized from methyl silicate 51.
